(19) United States
(12) Patent Application Publication
(10) Pub. No.: US 2026/0250447 A1
(43) Pub. Date: Aug. 27, 2026

(54) CURABLE COMPOSITION WITH URETHANE (METH)ACRYLATE MONOMER AND ACIDIC COMONOMER

(71) Applicant: THE REGENTS OF THE UNIVERSITY OF COLORADO, A BODY CORPORATE, Denver, CO (US)

(72) Inventors: Jeffrey W. STANSBURY, Centennial, CO (US); Austyn SALAZAR, Denver, CO (US)

(21) Appl. No.: 19/164,321

(22) PCT Filed: Mar. 7, 2024
(86) PCT No.: PCT/US2024/018865

§ 371 Date: Sep. 11, 2025

Related U.S. Application Data
(60) Provisional application No. 63/452,270, filed on Mar. 15, 2023.
(60) Provisional application No. 63/463,406, filed on May 2, 2023.

(51) Int. Cl. C08F 222/22

(52) U.S. Cl. CPC C08F 222/22

(57) ABSTRACT

A curable composition includes a urethane (meth)acrylate monomer and an acidic or latent acidic comonomer. The urethane (meth)acrylate monomer includes 2 to 12 urethane groups and, independently, 2 to 12 (meth)acrylate groups, wherein each of at least two urethane groups is separated from at least one other urethane group or at least one urea group by at most three carbon atoms. The urethane (meth)acrylate monomer has a molecular weight less than or equal to 5,000 grams/mole. In the curable composition, the molar ratio of urethane groups in the urethane (meth)acrylate monomer to carboxylic acid and carboxylic acid anhydride groups in the acidic or latent acidic comonomer is 1:3 to 3:1.

### CROSS-REFERENCE TO RELATED APPLICATIONS

This application claims the benefit of priority of U.S. Provisional Patent Application No. 63/452,270, filed Mar. 15, 2023, and U.S. Provisional Patent Application No. 63/463,406, filed May 2, 2023, the contents of which are incorporated herein by reference in their entirety for all purposes.

### STATEMENT REGARDING FEDERALLY SPONSORED RESEARCH & DEVELOPMENT

This invention was made with government support under Grant No. R21DE028444 awarded by the National Institutes of Health, National Institute of Dental and Craniofacial Research. The government has certain rights in the invention.

### BACKGROUND OF THE INVENTION

In the field of adhesives, including dental adhesives, there is a need for curable compositions that exhibit improved flexural strength on curing.

### BRIEF SUMMARY OF EMBODIMENTS OF THE INVENTION

One embodiment is a curable composition, comprising: a urethane (meth)acrylate monomer comprising 2 to 12 urethane groups and 2 to 12 (meth)acrylate groups, wherein each of at least two urethane groups is separated from at least one other urethane group or at least one urea group by at most three carbon atoms; and wherein the urethane (meth)acrylate monomer has a molecular weight less than or equal to 5,000 grams/mole; provided that the urethane (meth)acrylate monomer does not have structure (A), (B), or (C)

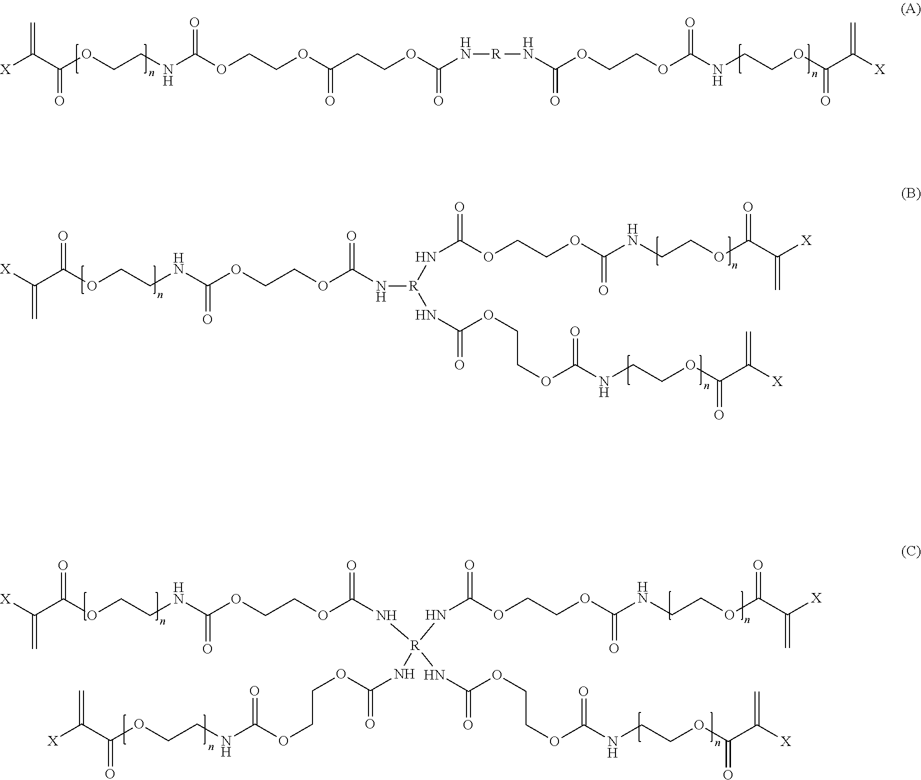

wherein X is —H or —CH₃; n is 1, 2, 3, or 4; and R is an aliphatic, alkoxyalkyl, or alkylarylalkyl core group; and an acidic or latent acidic comonomer selected from the group consisting of (meth)acrylic acid, 2-carboxyethyl (meth)acrylate, (meth)acrylic anhydride, itaconic anhydride, maleic anhydride, 4-methacryloxyethyl methacrylate, 1,3-glycerol dimethacrylate/succinate adduct, 4-methacryloxyethyl trimellitic acid, and combinations thereof; wherein a molar ratio of urethane groups in the urethane (meth)acrylate monomer to carboxylic acid and carboxylic acid anhydride groups in the acidic or latent acidic comonomer is 1:3 to 3:1.

Another embodiment is a urethane (meth)acrylate monomer comprising 2 to 12 urethane groups and 2 to 12 (meth)acrylate groups, wherein each of at least two urethane groups is separated from at least one other urethane group or at least one urea group by at most three carbon atoms; and wherein the urethane (meth)acrylate monomer has a molecular weight less than or equal to 5,000 grams/mole.

These and other embodiments are described in detail below.

### BRIEF DESCRIPTION OF THE DRAWINGS

FIG. 1 is a synthetic scheme for the production of octaurethane tetramethacrylate (“OUTMA”; structure (80) wherein each occurrence of X is methyl).

FIG. 2 is a synthetic scheme for the reaction of hydroxyethyl (meth)acrylate with isophorone diisocyanate.

FIG. 3 is synthetic scheme for the production of pentaurethane dimethacrylate (“PUDMA”; structure (79) wherein each occurrence of X is methyl).

FIG. 4 is a synthetic scheme for the production of triurethane dimethacrylate (“TriUDMA”; structure (4) wherein each occurrence of X is methyl).

FIG. 5 is a synthetic scheme for the production of pentaurethane trimethacrylate (“PUTriMA”; structure (11) wherein each occurrence of X is methyl).

FIG. 6 is a stress versus strain plot for copolymers of (1) TriUDMA (structure (4) wherein each occurrence of X is methyl) and acrylic acid, two acid groups per urethane group; (2) PUTriMA (structure (11) wherein each occurrence of X is methyl) and a 1:1 molar mixture of methacrylic acid and acrylic acid, two acid groups per urethane group; (3) PUTriMA (structure (11) wherein each occurrence of X is methyl) and acrylic acid, three acid groups per urethane group; (4) TetUTriA-2 (structure (82) wherein each occurrence of X is hydrogen) and acrylic acid, one acid groups per urethane group; (5) TetUTriMA-2 (structure (82) wherein each occurrence of X is methyl) and acrylic acid, one acid group per urethane group; (6) HUHMA (structure (47) wherein each occurrence of X is methyl) and acrylic acid, two acid groups per urethane group; (7) UDMA (urethane dimethacrylate, CAS Reg. No. 72869-86-4; UDMA is a non-clustered urethane (meth)acrylate) and methacrylic acid, one acid group per urethane group; (8) UDMA (urethane dimethacrylate, CAS Reg. No. 72869-86-4; UDMA is a non-clustered urethane (meth)acrylate) without an acidic comonomer.

FIG. 7 shows hysteresis loops of stress/strain and recovery for a copolymer of structure (83) wherein each occurrence of X is methyl, and methacrylic acid, one acid group per urethane group. The plot includes first through sixth load/unload cycles for copolymer taken to 5 percent strain (curves labeled “1-6”), followed by first through third load/unload cycles for copolymer taken to 10 percent strain (curves labeled “7” and “8-9”), all on a universal mechanical testing apparatus in three-point bending mode operating at 1 millimeter/minute with a 2 minute hold between the loading and unloading.

### DETAILED DESCRIPTION OF THE INVENTION

The present inventors have determined that a curable composition comprising a specific urethane (meth)acrylate monomer and an acidic or latent acidic copolymer in a specific molar ratio is capable of producing a cured composition with exceptionally high flexural strength in combination with excellent toughness.

As used herein, the term “(meth)acrylate” means “acrylate” or “methacrylate.”

One embodiment is a curable composition, comprising: a urethane (meth)acrylate monomer comprising 2 to 12 urethane groups and, independently, 2 to 12 (meth)acrylate groups, wherein each of at least two urethane groups is separated from at least one other urethane group or at least one urea group by at most three carbon atoms; and wherein the urethane (meth)acrylate monomer has a molecular weight less than or equal to 5,000 grams/mole; provided that the urethane (meth)acrylate monomer does not have structure (A), (B), or (C)

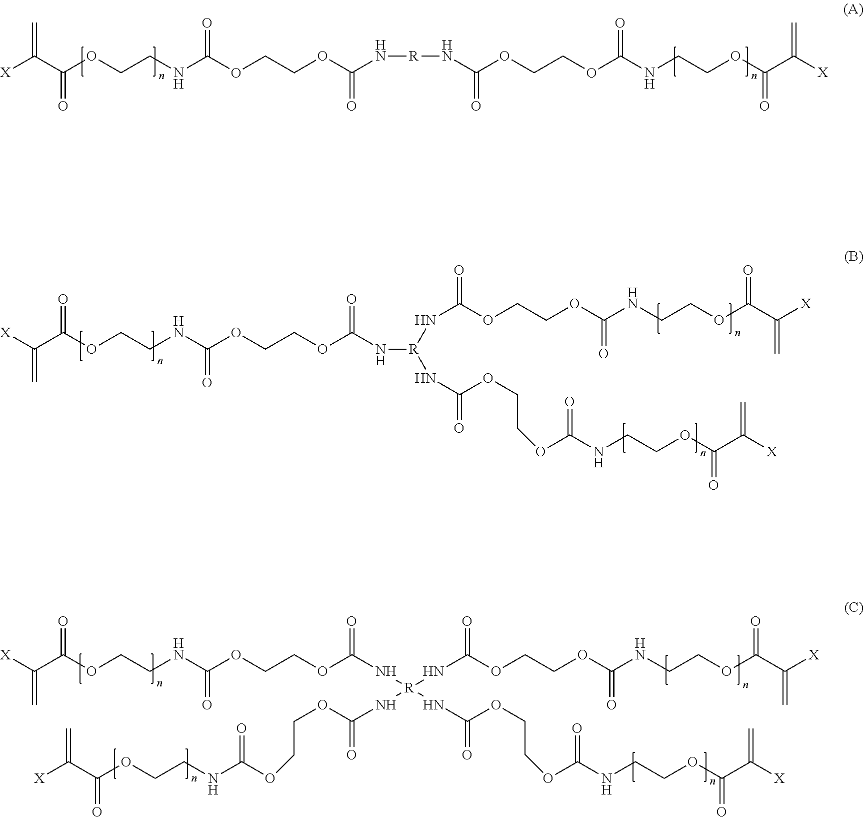

wherein X is —H or —CH₃; n is 1, 2, 3, or 4; and R is an aliphatic, alkoxyalkyl, or alkylarylalkyl core group; and an acidic or latent acidic comonomer selected from the group consisting of (meth)acrylic acid, 2-carboxyethyl (meth)acrylate, (meth)acrylic anhydride, itaconic anhydride, maleic anhydride, 4-methacryloxyethyl methacrylate, 1,3-glycerol dimethacrylate/succinate adduct, 4-methacryloxyethyl trimellitic acid, and combinations thereof; wherein a molar ratio of urethane groups in the urethane (meth)acrylate monomer to carboxylic acid and carboxylic acid anhydride groups in the acidic or latent acidic comonomer is 1:3 to 3:1.

Within the range of 2 to 12, the number of urethane groups in the urethane (meth)acrylate monomer can be 2, 2-10, 3, 3-10, 4, 4-10, 5, 5-10, 6, 6-10, 7, 7-10, 8, 8-10, 9, 9-10, or 10. Within the range of 2 to 12, the number of (meth)acrylate groups in the urethane (meth)acrylate monomer can be 2, 2-10, 3, 3-10, 4, 4-10, 5, 5-10, 6, 6-10, 7, 7-10, 8, 8-10, 9, 9-10, or 10.

In the urethane (meth)acrylate monomer, each of at least two urethane groups is separated from at least one other urethane group or at least one urea group by at most three carbon atoms. Urethane groups separated from each other by at most three carbon atoms can be referred to as “clustered” urethane groups. For any pair of clustered urethane groups, the nitrogen atom of the first urethane group can be facing the nitrogen atom of the second urethane group. Alternatively, the nitrogen atom of the first urethane group can be facing the oxygen atom of the second urethane group. Alternatively, the oxygen atom of the first urethane group can be facing the oxygen atom of the second urethane group. In some embodiments, the number of urethane groups separated from at least one other urethane group or at least one urea group by at most three carbon atoms is 2, 2-10, 3, 3-10, 4, 4-10, 5, 5-10, 6, 6-10, 7, 7-10, 8, 8-10, 9, 9-10, or 10. In some embodiments, the number of carbon atoms separating the at least two urethane groups from a urea group or at least one other urethane group is two, or three. In some embodiments, each of two urethane groups is separated from a urea group by one carbon atom. In some embodiments, each urethane group in the urethane (meth)acrylate monomer is separated from at least one other urethane group by two carbon atoms.

In some embodiments, the urethane (meth)acrylate monomer comprises 4 to 12 urethane groups, or 4 to 10 urethane groups. In some embodiments, the urethane (meth)acrylate monomer comprises 5 to 12 urethane groups, or 5 to 10 urethane groups. In some embodiments, the urethane (meth)acrylate monomer comprises 6 to 12 urethane groups, or 6 to 10 urethane groups.

In some embodiments, the urethane (meth)acrylate monomer comprises 3 to 12 (meth)acrylate groups, or 3 to 10 (meth)acrylate groups. In some embodiments, the urethane (meth)acrylate monomer comprises 4 to 12 (meth)acrylate groups, or 4 to 10 (meth)acrylate groups. In some embodiments, the urethane (meth)acrylate monomer comprises 5 to 12 (meth)acrylate groups, or 5 to 10 (meth)acrylate groups. In some embodiments, the urethane (meth)acrylate monomer comprises 6 to 12 (meth)acrylate groups, or 6 to 10 (meth)acrylate groups.

The urethane (meth)acrylate monomer has a molecular weight less than or equal to 5,000 grams/mole. Within this limit, the maximum molecular weight of the urethane (meth)acrylate monomer can be 4,000 grams/mole, or 3,000 grams/mole, or 2,000 grams/mole, or 1,000 grams/mole.

The urethane (meth)acrylate monomer does not have structure (A), (B), or (C)

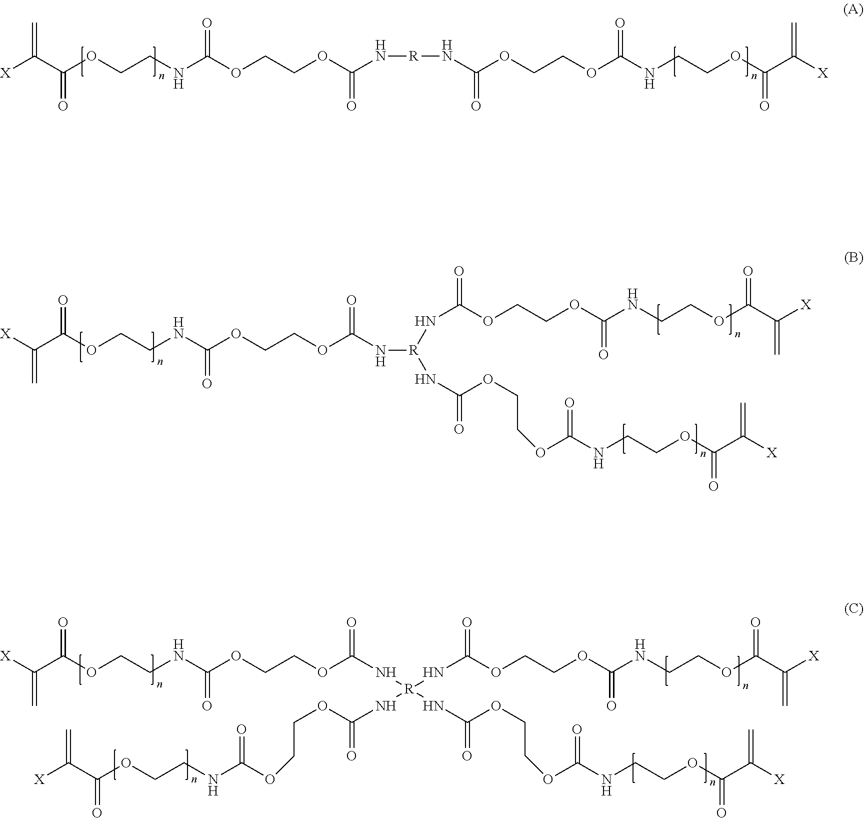

wherein X is —H or —CH₃; n is 1, 2, 3, or 4; and R is an aliphatic, alkoxyalkyl, or alkylarylalkyl core group.

Many examples of specific urethane (meth)acrylate monomer are presented in the present claims.

In addition to the urethane (meth)acrylate monomer, the curable composition comprises an acidic or latent acidic comonomer. Suitable acidic or latent acidic comonomers include (meth)acrylic acid, 2-carboxyethyl (meth)acrylate, (meth)acrylic anhydride, itaconic anhydride, maleic anhydride, 4-methacryloxyethyl methacrylate, 1,3-glycerol dimethacrylate/succinate adduct (CAS Reg. No. 107665-59-8), 4-methacryloxyethyl trimellitic acid, and combinations thereof. In some embodiments, the acidic or latent acidic comonomer comprises acrylic acid.

The curable composition comprises the urethane (meth)acrylate monomer and the acidic or latent acidic comonomer in amounts such that a molar ratio of urethane groups in the urethane (meth)acrylate monomer to carboxylic acid and carboxylic acid anhydride groups in the acidic or latent acidic comonomer is 1:3 to 3:1, or 1:3 to 1:1, or 1:1.5 to 1:2.5.

Another embodiment is a urethane (meth)acrylate monomer comprising 2 to 12 urethane groups and 2 to 12 (meth)acrylate groups, wherein each of at least two urethane groups is separated from at least one other urethane group or at least one urea group by at most three carbon atoms; and wherein the urethane (meth)acrylate monomer has a molecular weight less than or equal to 5,000 grams/mole. The same features of the urethane (meth)acrylate monomer described above in the context of the curable composition apply as well to the urethane (meth)acrylate monomer itself. In general, reactant amounts are at least approximately stoichiometric (i.e., ±10 mole percent of stoichiometric), and preferably stoichiometric. A skilled chemist understands the stoichiometries of the reactions described herein.

The urethane (meth)acrylate monomer can be prepared by a variety of methods.

In a first method of preparing the urethane (meth)acrylate monomer, a starting material comprising at least two hydroxyl groups is reacted with isocyanatoethyl (meth)acrylate. Urethane (meth)acrylate monomers prepared by this method include structures (1)-(3), (8)-(10), (19), (28)-(33), presented below. The reactant stoichiometry is approximately one hydroxyl group per isocyanate group.

In a second method of preparing the urethane (meth)acrylate monomer, a starting material comprising at least two primary or secondary amino groups is reacted with an optionally substituted alkylene carbonate, followed by reaction with isocyanatoethyl (meth)acrylate. Urethane (meth)acrylate monomers prepared by this method include structures (6), (7), (17), (18), and (36)-(43), presented below. The reactant stoichiometry of the first step is approximately one amino group per alkylene carbonate. The reactant stoichiometry of the first step is approximately one hydroxyl group per isocyanate group.

In a third method of preparing the urethane (meth)acrylate monomer, a starting material comprising at least one hydroxyl group and at least one amino group is reacted with an optionally substituted alkylene carbonate, followed by reaction with isocyanatoethyl (meth)acrylate. Urethane (meth)acrylate monomers prepared by this method include structures (4), (5), (11)-(16), and (20)-(27), presented below. The reactant stoichiometry of the first step is approximately one amino group per alkylene carbonate. The reactant stoichiometry of the first step is approximately one hydroxyl group per isocyanate group.

In a fourth method of preparing the urethane (meth)acrylate monomer, a starting material comprising at least two isocyanate groups is reacted with hydroxyethyl (meth)acrylate. Urethane (meth)acrylate monomers prepared by this method include structures (34) and (35), presented below. The reactant stoichiometry of the first step is approximately one isocyanate group per hydroxyl group.

In a fifth method of preparing the urethane (meth)acrylate monomer, a starting material comprising at least two amino groups is reacted with a (meth)acryloyl-substituted alkylene carbonate, followed by reaction with isocyanatoethyl (meth)acrylate. Urethane (meth)acrylate monomers prepared by this method include structure (44), presented below. The reaction stoichiometry of the first step is approximately one amino group per (meth)acryloyl-substituted alkylene carbonate. The reaction stoichiometry of the second step is approximately one hydroxyl group per isocyanate group.

In a sixth method of preparing the urethane (meth)acrylate monomer, a starting material comprising at least two amino groups is reacted with a (meth)acryloylurethane-substituted alkylene carbonate, followed by reaction with isocyanatoethyl (meth)acrylate. Urethane (meth)acrylate monomers prepared by this method include structure (45), presented below. The reaction stoichiometry of the first step is approximately one amino group per (meth)acryloylurethane-substituted alkylene carbonate. The reaction stoichiometry of the second step is approximately one hydroxyl group per isocyanate group.

In a seventh method of preparing the urethane (meth)acrylate monomer, a starting material comprising at least two amino groups is reacted with a (meth)acryloylurethane-substituted alkylene carbonate, followed by reaction with trimellitic anhydride chloride. Urethane (meth)acrylate monomers prepared by this method include structure (46), presented below. The reaction stoichiometry of the first step is approximately one amino group per (meth)acryloylurethane-substituted alkylene carbonate. The reaction stoichiometry of the second step is approximately one hydroxyl group per trimellitic anhydride chloride molecule.

In an eighth method of preparing the urethane (meth)acrylate monomer, 1,3,5-triallyl-1,3,5-triazine-2,4,6(1H,3H,5H)-trione (TTT) is reacted with thioglycerol, followed by reaction with isocyanatoethyl (meth)acrylate. Urethane (meth)acrylate monomers prepared by this method include structure (47), presented below. The reaction stoichiometry of the first step is approximately one allyl group per thiol group. The reaction stoichiometry of the second step is approximately one hydroxyl group per isocyanate group.

In a ninth method of preparing the urethane (meth)acrylate monomer, 2,4,6-triallyloxy-1,3,5-triazine is reacted with thioglycerol, followed by reaction with isocyanatoethyl (meth)acrylate. Urethane (meth)acrylate monomers prepared by this method include structure (48), presented below. The reaction stoichiometry of the first step is approximately one allyl group per thiol group. The reaction stoichiometry of the second step is approximately one hydroxyl group per isocyanate group.

In a tenth method of preparing the urethane (meth)acrylate monomer, glyoxal bis(diallylacetal) is reacted with thioglycerol, followed by reaction with isocyanatoethyl (meth)acrylate. Urethane (meth)acrylate monomers prepared by this method include structure (49), presented below. The reaction stoichiometry of the first step is approximately one allyl group per thiol group. The reaction stoichiometry of the second step is approximately one hydroxyl group per isocyanate group.

In an eleventh method of preparing the urethane (meth)acrylate monomer, a starting material comprising at least two isocyanate groups is reacted with propargyl alcohol, followed by reaction with thioglycerol, followed by reaction with isocyanatoethyl (meth)acrylate. Urethane (meth)acrylate monomers prepared by this method include structures (50)-(58), presented below. The reaction stoichiometry of the first step is approximately one isocyanate group per hydroxyl group. The reaction stoichiometry of the second step is approximately one propargyl group per thiol group in the thioglycerol. The reaction stoichiometry of the second step is approximately one hydroxyl group per isocyanate group.

In a twelfth method of preparing the urethane (meth)acrylate monomer, 1,3,5-triallyl-1,3,5-triazine-2,4,6(1H,3H,5H)-trione (TTT) is reacted with cysteamine, followed by reaction with an alkylene carbonate, followed by reaction with isocyanatoethyl (meth)acrylate. Urethane (meth)acrylate monomers prepared by this method include structure (59), presented below. The reaction stoichiometry of the first step is approximately one allyl group per thiol group in the cysteamine. The reaction stoichiometry of the second step is approximately one amino group per alkylene carbonate molecule. The reaction stoichiometry of the second step is approximately one hydroxyl group per isocyanate group.

In a thirteenth method of preparing the urethane (meth)acrylate monomer, 1,3,5-triallyl-1,3,5-triazine-2,4,6(1H,3H,5H)-trione (TTT) is reacted with cysteamine, followed by reaction with hydroxymethyl ethylene carbonate, followed by reaction with isocyanatoethyl (meth)acrylate. Urethane (meth)acrylate monomers prepared by this method include structure (60), presented below. The reaction stoichiometry of the first step is approximately one allyl group per thiol group in the cysteamine. The reaction stoichiometry of the second step is approximately one amino group per alkylene carbonate molecule. The reaction stoichiometry of the second step is approximately one hydroxyl group per isocyanate group.

In a fourteenth method of preparing the urethane (meth)acrylate monomer, a starting material comprising at least two isocyanate groups is reacted with hydroxymethyl ethylene carbonate, followed by reaction with 2-aminoalcohol, followed by reaction with isocyanatoethyl (meth)acrylate. Urethane (meth)acrylate monomers prepared by this method include structures (61)-(69), presented below. The reaction stoichiometry of the first step is approximately one isocyanate group per hydroxymethyl ethylene carbonate molecule. The reaction stoichiometry of the second step is approximately one ethylene carbonate group per amino group in the 2-aminoalcohol. The reaction stoichiometry of the third step is approximately one hydroxyl group per isocyanate group.

In a fifteenth method of preparing the urethane (meth)acrylate monomer, a starting material comprising at least two isocyanate groups is reacted with hydroxymethyl ethylene carbonate, followed by reaction with 2-aminoalcohol, followed by reaction with (meth)acrylic acid or (meth)acrylic anhydride or (meth)acryloyl chloride. Urethane (meth)acrylate monomers prepared by this method include structures (70)-(78), presented below. The reaction stoichiometry of the first step is approximately one isocyanate group per hydroxymethyl ethylene carbonate molecule. The reaction stoichiometry of the second step is approximately one ethylene carbonate group per amino group in the 2-aminoalcohol. The reaction stoichiometry of the third step is approximately one hydroxyl group per molecule of (meth)acrylic acid or (meth)acrylic anhydride or (meth)acryloyl chloride.

In a sixteenth method of preparing the urethane (meth)acrylate monomer, a starting material comprising at least one hydroxyl group and at least one amino group is reacted with an optionally substituted alkylene carbonate, followed by reaction with IPDI/HE (M) A (i.e., followed by reaction with the reaction product of isophorone diisocyanate and hydroxyethyl (meth)acrylate). Urethane (meth)acrylate monomers prepared by this method include structure (79), presented below. The reaction stoichiometry of the first step is approximately one amino group per optionally substituted alkylene carbonate molecule. The reaction stoichiometry of the second step is approximately one hydroxyl group per molecule of IPDI/HE (M) A.

In a seventeenth method of preparing the urethane (meth)acrylate monomer, a starting material comprising at least two isocyanate groups is reacted with glycerol carbonate, followed by reaction with ethanolamine, followed by reaction with isocyanatoethyl (meth)acrylate. Urethane (meth)acrylate monomers prepared by this method include structure (80), presented below. The reaction stoichiometry of the first step is approximately one isocyanate group per glycerol carbonate molecule. The reaction stoichiometry of the second step is approximately one ethylene carbonate group per amino group in the ethanolamine. The reaction stoichiometry of the third step is approximately one hydroxyl group per isocyanate group.

In an eighteenth method of preparing the urethane (meth)acrylate monomer, ethanolamine is reacted with one equivalent of glycerol carbonate to form an intermediate with three hydroxyl groups, followed by reaction with three equivalents of isocyanatoethyl (meth)acrylate. Urethane (meth)acrylate monomers prepared by this method include structure (82), presented below.

In a nineteenth method of preparing the urethane (meth)acrylate monomer, a trihydroxyalkane is reacted with three equivalents of isocyanato (2-ethoxyethyl) (meth)acrylate. Urethane (meth)acrylate monomers prepared by this method include structure (83), presented below.

Many of the synthetic methods described above utilize ethylene carbonate. It will be understood that alternative alkylene carbonates can be used. Such alternative alkylene carbonates include, for example, those having structures (2a) or (2b)

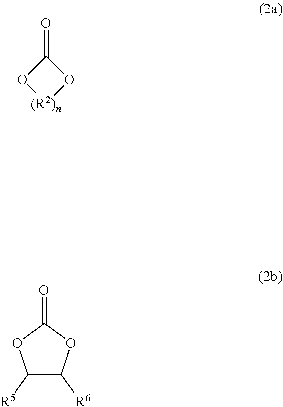

wherein R² is independently at each occurrence
—CH₂—, —CH(CH₃)—, —CH(CH₂OH)—, —CH(CH₂Cl)—, —CH(C(H)═CH₂)—, —C(CH₃)₂—, —C(CH₂CH₃)₂—, —C(CH₂CH₂CH₃)(CH₃)—,

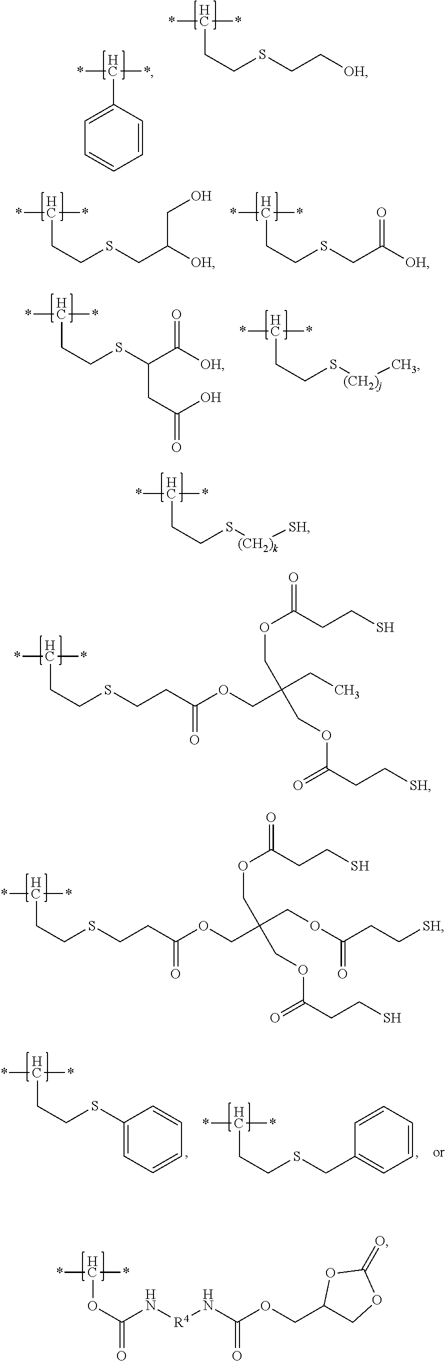

wherein j is an integer from 1 to 16, k is an integer from 1 to 12, and R⁴ is C₂-C₁₂ alkylene; provided that zero or 1 occurrence of R² is not —CH₂—, and that if one occurrence of R² is not —CH₂—, then the other occurrences of R² are —CH₂—; n is 3 or 4; and R⁵ and R⁶ are each independently C₁-C₆ alkyl, or R⁵ and R⁶ and the carbon atoms to which they are attached collectively form a 5- to 7-membered aliphatic ring (e.g., R⁵ and R⁶ collectively form a —(CH₂)_{y}— group, wherein y is 3, 4, or 5).

In some embodiments, the curable composition further comprises a filler. Suitable fillers include silicate glass, barium glass, ytterbium glass, ytterbium fluoride, and combinations thereof, as well as any of the above fillers surface treated with (meth)acrylate-treated silanes. The curable composition can comprise 5 to 900 parts by weight of the filler per 100 parts by weight total of the urethane (meth)acrylate monomer and acidic comonomer.

Another embodiment is a cured composition comprising the product of curing the curable composition as described herein. Methods of curing (meth)acrylate resins, including thermal, photochemical, and electron beam curing methods are known in the art, as are catalysts for such methods. Illustrative curing methods are including in the experimental examples below.

Another embodiment is an article comprising the cured composition, including, for example, a tooth comprising a dental adhesive, a tooth comprising a dental filling, and a dental prosthetic device.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Each range disclosed herein constitutes a disclosure of any point or sub-range lying within the disclosed range.

The invention is further illustrated by the following non-limiting examples.

### EXAMPLES

Material used in these examples are summarized in Table 1.

TABLE 1

| Material | Description |
|---|---|
| EA | Ethanolamine, CAS Reg. No. 141-43-5; obtained as E9508-500 ML from |
| | Sigma-Aldrich. |
| 13DA2P | 1,3-Diamino-2-propanol, CAS Reg. No. 616-29-5. |
| 2A13PD | 2-Amino-1,3-propanediol, CAS Reg. No. 534-03-2. |
| EC | Ethylene carbonate, CAS Reg. No. 96-49-1; obtained as A15735 from Alfa |
| | Aesar. |
| GC | 4-Hydroxymethyl-1,3-dioxolan-2-one (glycerol carbonate), CAS Reg. No. |
| | 931-40-8; obtained as G1488 from Spectrum Chemical. |
| VEC | 4-Vinyl-1,3-dioxolan-2-one (vinyl ethylene carbonate), CAS Reg. No. 4427- |
| | 96-7; obtained as 496820-1 KG from Sigma-Aldrich. |
| TMDI | 1,6-Diisocyanato-2,4,4-trimethylhexane, CAS Reg. No. 15646-96-5; obtained |
| | as 410950-250 ML from Sigma-Aldrich. |
| IPDI | Isophorone diisocyanate, CAS Reg. No. 4098-71-9; obtained as D37-4 from |
| | Fisher Chemicals. |
| XDI | Xylylene diisocyanate, CAS Reg. No. 3634-83-1; obtained as X0022 from TCI |
| | America |
| IEM | 2-Isocyanatoethyl methacrylate, CAS Reg. No. 30647-80-7; obtained as |
| | Karenz MOI from Showa Denko. |
| IEA | 2-Isocyanatoethyl acrylate, CAS Reg. No. 13641-96-8; obtained as Karenz |
| | AOI from Showa Denko |
| IAN | Itaconic anhydride, CAS Reg. No. 2170-03-8; obtained as B25216.22 from |
| | Afla Aesar |
| TMA-HCl | Trimellitic anhydride chloride, CAS Reg. No. 1204-28-0; obtained as T1079 |
| | from TCI America |
| Thioglycerol | Thioglycerol, CAS Reg. No. 96-27-5; obtained as 637-146 from Evans |
| | Chemetics LP |
| Cysteamine | Cysteamine hydrochloride, CAS Reg. No. CAS Number:156-57-0; obtained as |
| | 02839 from Chem-Impex Int'l Inc. |
| DCM | Methylene chloride (dichloromethane), CAS Reg. No. 75-09-2; obtained as |
| | D37-4 from Fisher Chemicals. |

### Example 1

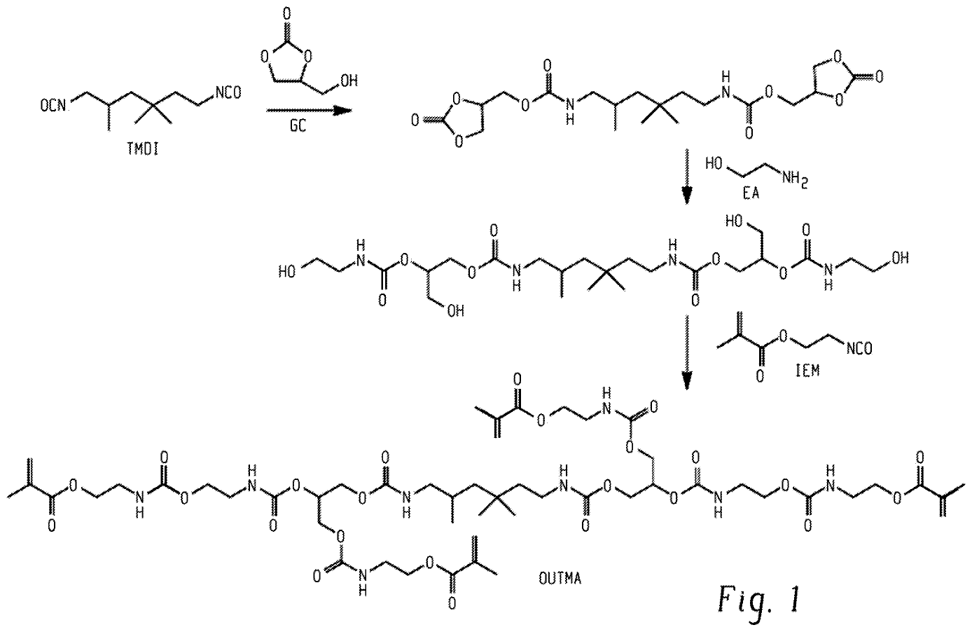

Two equivalents of glycerol carbonate (GC) were reacted with trimethylhexane diisocyanate (TMDI) in methylene chloride at 0-25° C. for 24-48 hours (or until the disappearance of the isocyanate peak at 2270 cm⁻¹ as determined by Fourier transform infrared spectroscopy (FTIR)) to form a di (ethylene carbonate)-terminated diurethane intermediate (FIG. 1). Two equivalents of ethanolamine (EA) were then added to the reaction mixture and reacted with the di (ethylene carbonate)-terminated diurethane intermediate at 25-30° C. for 24-48 hours (or until the disappearance of the ethylene carbonate peak at 1800 cm⁻¹ as determined by FTIR) to yield a tetraurethane tetraol (FIG. 1). Four equivalents of isocyanatoethyl methacrylate (IEM) were then added to the reaction mixture, which was then stirred for 6-12 hours (or until the disappearance of the isocyanate peak at 2270 cm⁻¹) at 0-25° C. to yield an octaurethane tetramethacrylate (OUTMA; structure (80) wherein each occurrence of X is methyl; FIG. 1), which was isolated by removing methylene chloride via rotary evaporator.

The OUTMA was combined with acrylic acid (2 equivalents per urethane group) as well as 2,2-dimethoxy-2-phenylacetophenone as initiator (0.1 wt %) and photocured at a thickness of 2 millimeters for 480 seconds using light source operating at 365 nanometers and 100 milliwatts/centimeter². The resulting photopolymer was then post-cured at 80° C. for 1 hour while simultaneously irradiating with a 365/405 nanometer light source at 36 milliwatts/centimeter². The resulting copolymer exhibited a flexural strength of 235.2±5.6 megapascals (MPa) and a flexural modulus of 5.34±0.23 gigapascals (GPa) determined at 23° C. according to ISO 4049, and a toughness of 10.28±3.64 MPa determined at 23° C. and calculated based on the area under the flexural stress-strain plot.

### Example 2

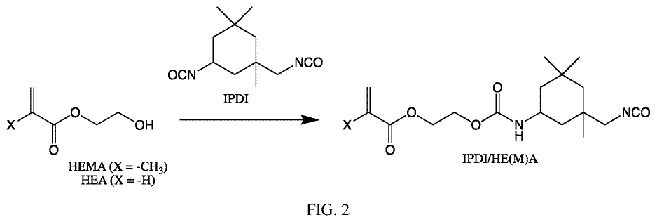

2-Hydroxyethyl methacrylate (HEMA) was reacted with one equivalent of isophorone diisocyanate (IPDI) in methylene chloride at 0-25° C. for 3-6 hours (or until half of the isocyanate peak at 2270 cm⁻¹ disappeared) to form an IPDI/HEMA adduct (FIG. 2). Solvent was removed from IPDI/HE (M) A adduct via rotary evaporator and the isolated product was used with no further purification.

### Example 3

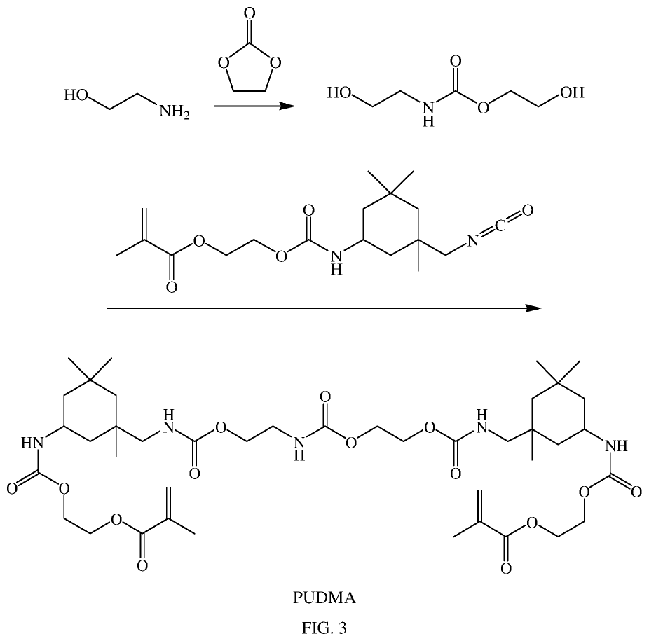

Ethanolamine was reacted with one equivalent of neat ethylene carbonate at 25° C. for 24 to 48 hours until the cyclic carbonate peak at 1750-1760 centimeter⁻¹ had disappeared and a monourethane diol intermediate was formed (FIG. 3). Isolation of the monourethane diol intermediate was not necessary. The monourethane diol intermediate was then reacted with two equivalents of IPDI/HEMA to yield a pentaurethane dimethacrylate (PUDMA; FIG. 3).

The PUDMA was combined with acrylic acid (two equivalents of per urethane group), and photocured then post-cured using the conditions of Example 2. The resulting copolymer exhibited a flexural strength of 195±15 MPa and flexural modulus of 5.80±0.14 GPa, with a toughness of 3.85±0.75 MPa.

### Example 4

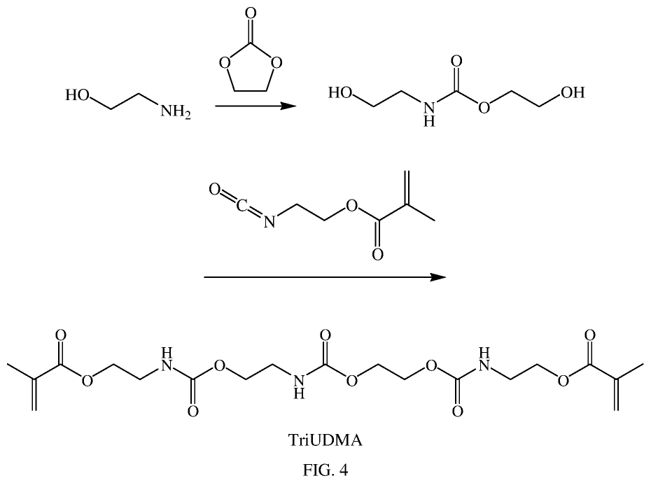

The procedure of Example 3 was followed, except that the (meth)acrylating agent was 2-isocyanatoethyl methacrylate (IEM) instead of IPDI/HEMA, and the product was a triurethane dimethacrylate (TriUDMA; FIG. 4). The product of curing TriUDMA with acrylic acid (two equivalents of per urethane group) exhibited a room temperature viscosity of 20.5±4.7 millipascal-seconds (mPa-s).

### Example 5

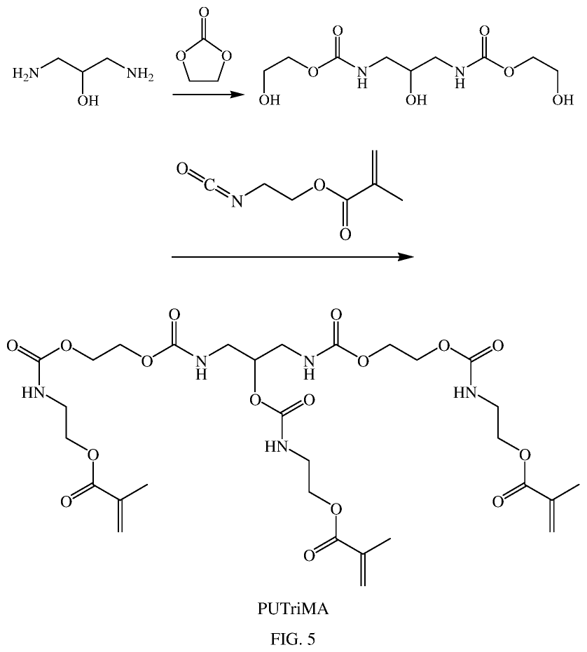

1,3-Diamino-2-propanol was reacted with two equivalents of neat ethylene carbonate at 25° C. for 24 to 48 hours until the cyclic carbonate peak at 1750-1760 centimeter⁻¹ had disappeared and a monourethane diol intermediate was formed (FIG. 3). Isolation of the monourethane diol intermediate was not necessary. The monourethane diol intermediate was then reacted with three equivalents of 2-isocyanatoethyl methacrylate (IEM) to yield a pentaurethane trimethacrylate (PUTriMA; FIG. 5; structure (11) wherein each occurrence of X is methyl).

The PUTriMA was combined with acidic comonomers as detailed in Table 2, and the resulting curable compositions were photocured then post-cured using the conditions of Example 2.

### Example 6

Table 2 presents properties for cured compositions as a function of urethane (meth)acrylate monomer identity (structure number and identity of “X”), acidic monomer identity (“AA”=acrylic acid; “MAA”=methacrylic acid), molar ratio of acid groups in the acidic monomer to urethane groups in the (meth)acrylate monomer, and curing type (photochemical versus thermal). Properties are percent conversion of double bonds (determined by near infrared spectroscopy), flexural strength (in units of megapascals, determined at 23° C. according to ISO 4049:2019), flexural modulus (in units of gigapascals, determined at 23° C. according to ISO 4049:2019), and toughness (in units of megapascals, determined at 23° C. according to ISO 4049:2019 based on the area under the flexural stress-strain curve). Also included in Table 2 are values for room temperature viscosity of the curable composition.

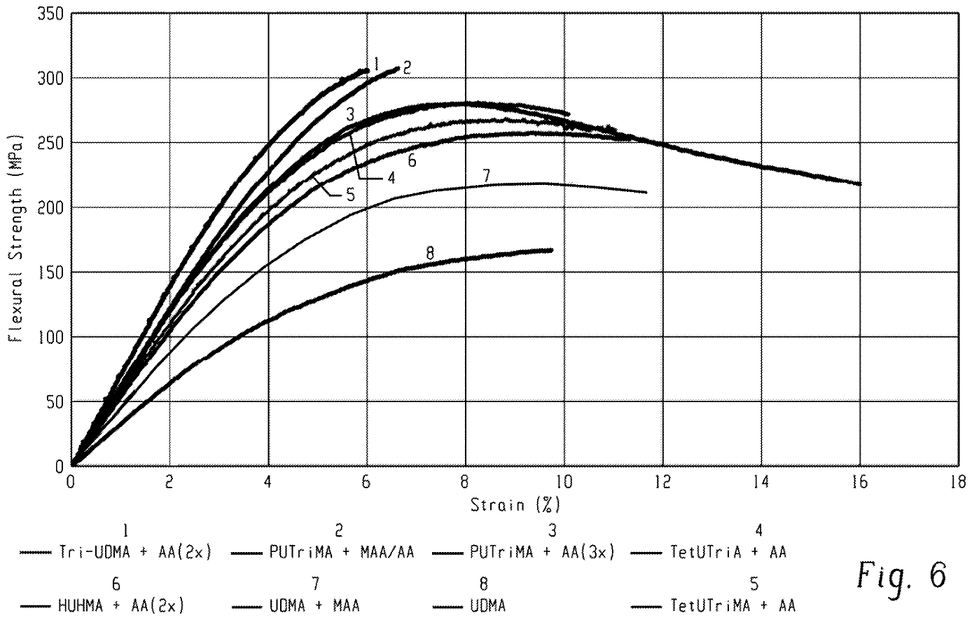

FIG. 6 is a stress versus strain plot for copolymers of (1) TriUDMA (structure (4) wherein each occurrence of X is methyl) and acrylic acid, two acid groups per urethane group; (2) PUTriMA (structure (11) wherein each occurrence of X is methyl) and a 1:1 molar mixture of methacrylic acid and acrylic acid, two acid groups per urethane group; (3) PUTriMA (structure (11) wherein each occurrence of X is methyl) and acrylic acid, three acid groups per urethane group; (4) TetUTriA-2 (structure (82) wherein each occurrence of X is hydrogen) and acrylic acid, one acid groups per urethane group; (5) TetUTriMA-2 (structure (82) wherein each occurrence of X is methyl) and acrylic acid, one acid group per urethane group; (6) HUHMA (structure (49) wherein each occurrence of X is methyl) and acrylic acid, two acid groups per urethane group; (7) UDMA (urethane dimethacrylate, CAS Reg. No. 72869-86-4; UDMA is a non-clustered urethane (meth)acrylate) and methacrylic acid, one acid group per urethane group; (8) UDMA (urethane dimethacrylate, CAS Reg. No. 72869-86-4; UDMA is a non-clustered urethane (meth)acrylate) without an acidic comonomer.

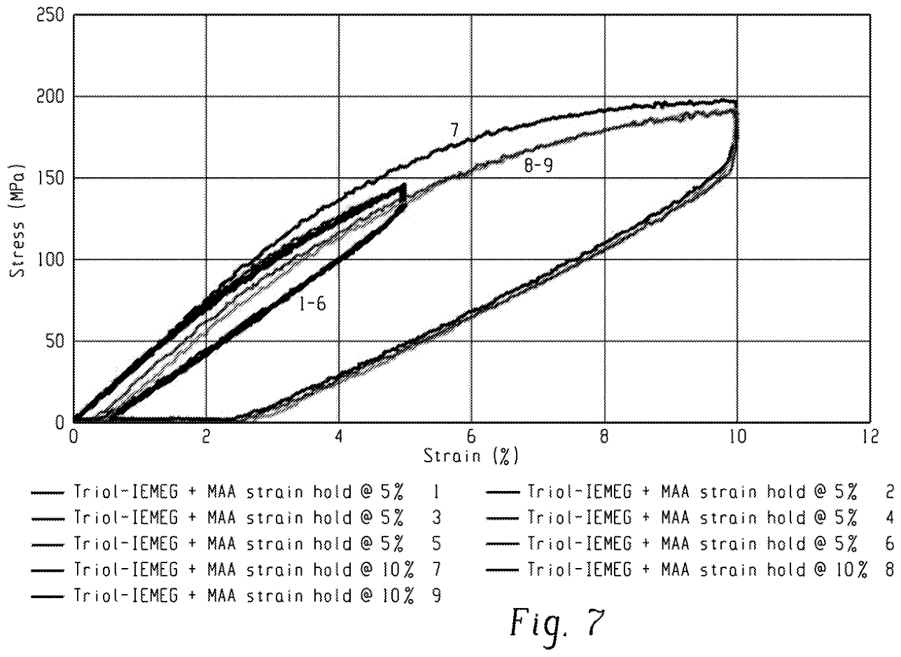

FIG. 7 shows hysteresis loops of stress/strain and recovery for a copolymer of structure (85) wherein each occurrence of X is methyl, and methacrylic acid, one acid group per urethane group. The plot includes first through sixth load/unload cycles for copolymer taken to 5 percent strain (curves labeled “1-6”), followed by first through third load/unload cycles for copolymer taken to 10 percent strain (curves labeled “7” and “8-9”), all on a universal mechanical testing apparatus in three-point bending mode operating at 1 millimeter/minute with a 2 minute hold between the loading and unloading. The 5% strain loops (cycles 1-6) were given 10 minutes before reloading which allowed for essentially complete recovery to the initial shape and the six cycles overlap each other. Starting with cycle 7, the flexure was extended to 10% strain under the same conditions except that a 30 minute delay was imposed before initiating the following cycles. In the case of cycles 8 and 9, the dimensional recovery over the 30 minute delay was not sufficient to fully recover the initial specimen shape as evidenced by the stress rise beginning at a small positive offset. However, the modulus values for each cycle are effectively equivalent as evidenced by the slopes in the linear range of the stress/strain profiles.

TABLE 2

| | Ex. A | Ex. B | Ex. C | Ex. D |
|---|---|---|---|---|
| Urethane (meth)acrylate | (11), X═Me | (11), X═Me | (11), X═Me | (11), X═Me |
| monomer structure | | | | |
| Acidic comonomer | AA | AA | AA | AA |
| Mole ratio of acid groups to | 2:1 | 2:1 | 3:1 | 3:1 |
| urethane groups | | | | |
| Viscosity (mPa*s) | — | — | — | — |
| Curing type | Photo | Thermal | Photo | Thermal |
| Conversion of double bonds | 89.1 ± 1.0 | 93.6 ± 1.0 | 93.0 ± 1.1 | 95.2 ± 0.8 |
| (%) | | | | |
| Flexural strength (MPa) | 247.86 ± 12.08 | 276.98 ± 20.07 | — | 269.34 ± 11.46 |
| Flexural modulus (GPa) | 5.49 ± 0.17 | 5.96 ± 0.46 | — | 5.92 ± 0.24 |
| Toughness (MPa) | 19.31 ± 5.28 | 13.97 ± 5.07 | — | 17.97 ± 9.62 |
| | Ex. E | Ex. F | Ex. G | Ex. H |
| Urethane (meth)acrylate | (11), X═Me | (11), X═Me | (11), X═Me | (11), X═Me |
| monomer structure | | | | |
| Acidic comonomer | AA/MAA | AA/MAA | MAA | MAA |
| Mole ratio of acid groups to | 2:1 | 2:1 | 2:1 | 2:1 |
| urethane groups | (1AA/1MAA) | (1AA/1MAA) | | |
| Viscosity (mPa*s) | — | — | — | — |
| Curing type | Photo | Thermal | Photo | Thermal |
| Conversion of double bonds | — | — | 61.7 ± 1.5 | 79.4 ± 0.6 |
| (%) | | | | |
| Flexural strength (MPa) | — | 267.77 ± 33.63 | — | 123.82 ± 45.04 |
| Flexural modulus (GPa) | — | 6.36 ± 0.25 | — | 5.80 ± 0.24 |
| Toughness (MPa) | — | 8.18 ± 3.04 | — | 1.61 ± 1.25 |

| | Ex. I | Ex. J | Ex. K | Ex. L |
|---|---|---|---|---|
| Urethane (meth)acrylate | (82), X═Me | (82), X═Me | (82), X═Me | (82), X═Me |
| monomer structure | | | | |
| Acidic comonomer | AA | AA | MAA | MAA |
| Mole ratio of acid groups to | 1:1 | 1:1 | 1:1 | 1:1 |
| urethane groups | | | | |
| Viscosity (mPa*s) | — | — | — | — |
| Curing type | Photo | Thermal | Photo | Thermal |
| Conversion of double bonds | — | — | 62.1 ± 1.5 | 85.6 ± 0.7 |
| (%) | | | | |
| Flexural strength (MPa) | — | 254.67 ± 8.69 | — | 196.09 ± 39.65 |
| Flexural modulus (GPa) | — | 5.20 ± 0.35 | — | 5.32 ± 0.13 |
| Toughness (MPa) | — | 13.8 ± 4.33 | — | 5.24 ± 2.77 |

| | Ex. M | Ex. N | Ex. O | Ex. P |
|---|---|---|---|---|
| Urethane (meth)acrylate | (4), X═Me | (4), X═Me | (4), X═Me | (4), X═Me |
| monomer structure | | | | |
| Acidic comonomer | AA | AA | MAA | MAA |
| Mole ratio of acid groups to | 1:1 | 1:1 | 1:1 | 1:1 |
| urethane groups | | | | |
| Viscosity (mPa*s) | — | — | — | — |
| Curing type | Photo | Thermal | Photo | Thermal |
| Conversion of double bonds | 91.8 ± 0.8 | 95.6 ± 0.9 | 65.6 ± 1.2 | 85.5 ± 0.7 |
| (%) | | | | |
| Flexural strength (MPa) | — | 253.56 ± 22.88 | — | — |
| Flexural modulus (GPa) | — | 5.68 ± 0.19 | — | 6.09 ± 0.36 |
| Toughness (MPa) | — | 9.89 ± 4.48 | — | — |

| | Ex. Q | Ex. R | Ex. S | Ex. T |
|---|---|---|---|---|
| Urethane (meth)acrylate | (4), X═Me | (4), X═Me | (4), X═H | (4), X═H |
| monomer structure | | | | |
| Acidic comonomer | AA | AA | AA | AA |
| Mole ratio of acid groups to | 2:1 | 2:1 | 2:1 | 2:1 |
| urethane groups | | | | |
| Viscosity (mPa*s) | 11.4 ± 1.4 | 11.4 ± 1.4 | — | — |
| Curing type | Photo | Thermal | Photo | Thermal |
| Conversion of double bonds | 93.2 ± 1.4 | 95.3 ± 0.9 | — | — |
| (%) | | | | |
| Flexural strength (MPa) | — | 271.48 ± 11.97 | — | — |
| Flexural modulus (GPa) | — | 5.03 ± 0.5 | — | 5.35 ± 0.31 |
| Toughness (MPa) | — | 11.2 ± 2.5 | — | 13.07 ± 8.13 |

| | Ex. U | Ex. V | Ex. W | Ex. X |
|---|---|---|---|---|
| Urethane (meth)acrylate | (79), X═Me | (79), X═Me | (80), X═Me | (80), X═Me |
| monomer structure | | | | |
| Acidic comonomer | AA | AA | AA | AA |
| Mole ratio of acid groups to | 2:1 | 2:1 | 2:1 | 2:1 |
| urethane groups | | | | |
| Viscosity (mPa*s) | — | — | 58.5 ± 14.8 | 58.5 ± 14.8 |
| Curing type | Photo | Thermal | Photo | Thermal |
| Conversion of double bonds | — | — | 90.9 ± 2.0 | 95.3 ± 1.2 |
| (%) | | | | |
| Flexural strength (MPa) | — | 195.35 ± 14.97 | 223.68 ± 8.73 | 235.24 ± 5.55 |
| Flexural modulus (GPa) | — | 5.81 ± 0.14 | 4.9 ± 0.13 | 5.34 ± 0.23 |
| Toughness (MPa) | — | 3.84 ± 0.75 | 18.45 ± 11.58 | 10.38 ± 3.64 |

1. A curable composition, comprising:
a urethane (meth)acrylate monomer comprising 2 to 12 urethane groups and 2 to 12 (meth)acrylate groups, wherein each of at least two urethane groups is separated from at least one other urethane group or at least one urea group by at most three carbon atoms; and wherein the urethane (meth)acrylate monomer has a molecular weight less than or equal to 5,000 grams/mole; provided that the urethane (meth)acrylate monomer does not have structure (A), (B), or (C) 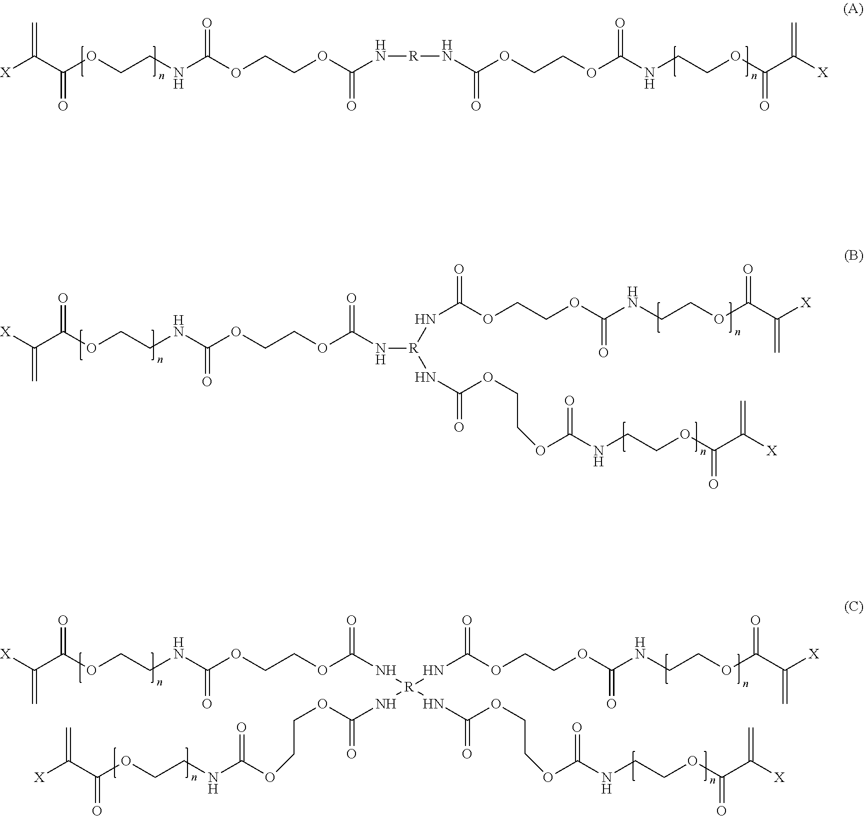
wherein X is —H or —CH₃; n is 1, 2, 3, or 4; and R is an aliphatic, alkoxyalkyl, or alkylarylalkyl core group;
an acidic or latent acidic comonomer selected from the group consisting of (meth)acrylic acid, 2-carboxyethyl (meth)acrylate, (meth)acrylic anhydride, itaconic anhydride, maleic anhydride, 4-methacryloxyethyl methacrylate, 1,3-glycerol dimethacrylate/succinate adduct, 4-methacryloxyethyl trimellitic acid, and combinations thereof;
wherein a molar ratio of urethane groups in the urethane (meth)acrylate monomer to carboxylic acid and carboxylic acid anhydride groups in the acidic or latent acidic comonomer is 1:3 to 3:1.

2. The curable composition of claim 1, wherein, in the urethane (meth)acrylate monomer, each of two urethane groups is separated from a urea group by one carbon atom.

3. The curable composition of claim 1, wherein, in the urethane (meth)acrylate monomer, each of the at least two urethane groups is separated from at least one other urethane group by two carbon atoms.

4. The curable composition of claim 1, wherein, in the urethane (meth)acrylate monomer, each urethane group is separated from at least one other urethane group by two carbon atoms.

5. The curable composition of claim 1, wherein the urethane (meth)acrylate monomer comprises 4 to 12 urethane groups.

6. The curable composition of claim 1, wherein the urethane (meth)acrylate monomer comprises 5 to 12 urethane groups.

7. (canceled)

8. The curable composition of claim 1, wherein the urethane (meth)acrylate monomer comprises 3 to 12 (meth)acrylate groups.

9. (canceled)

10. The curable composition of claim 1, wherein the urethane (meth)acrylate monomer is selected from the group consisting of 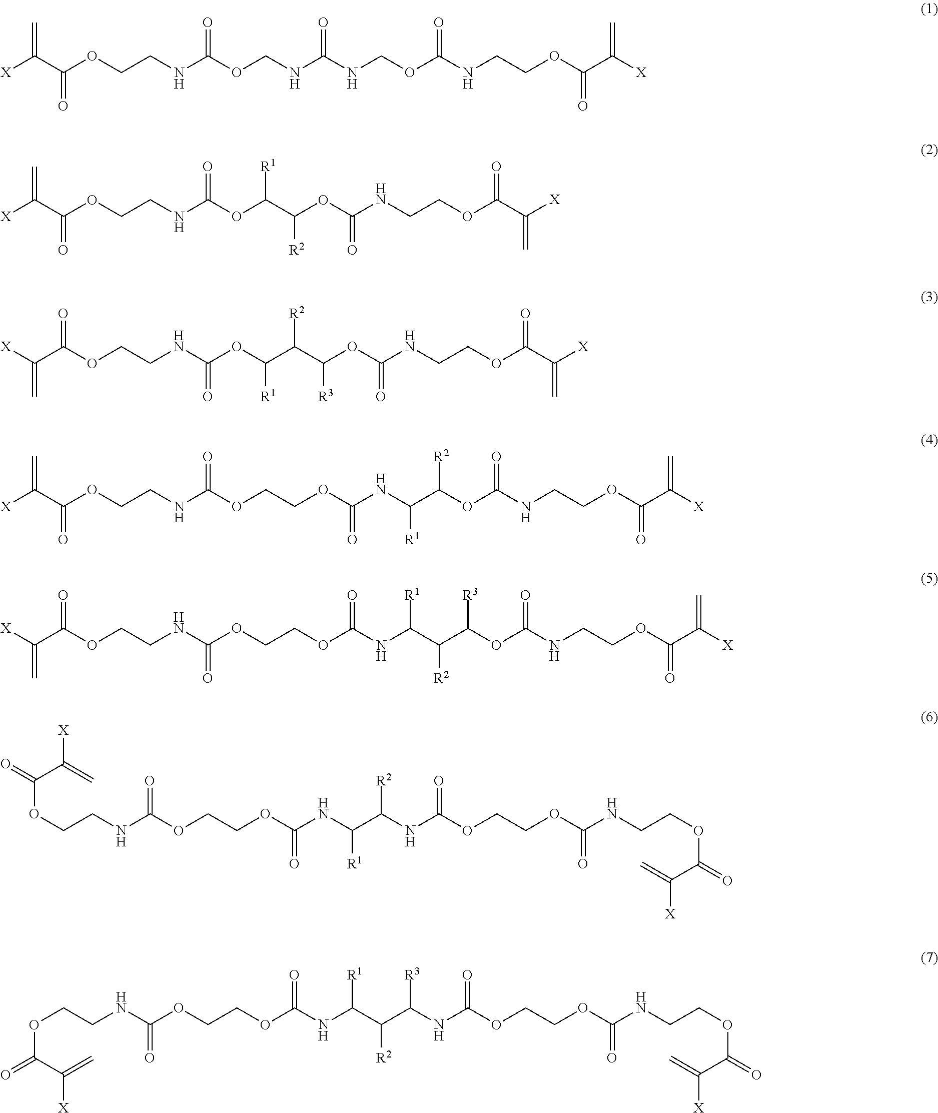 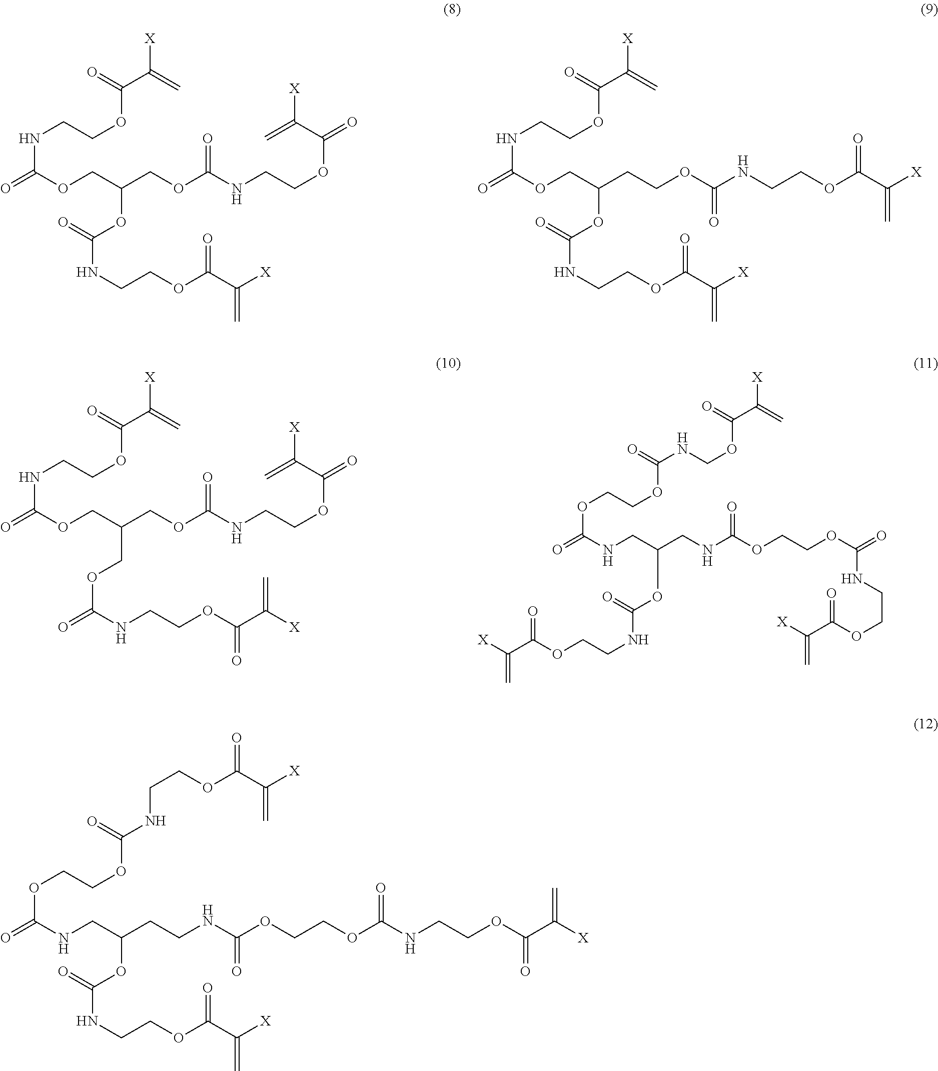 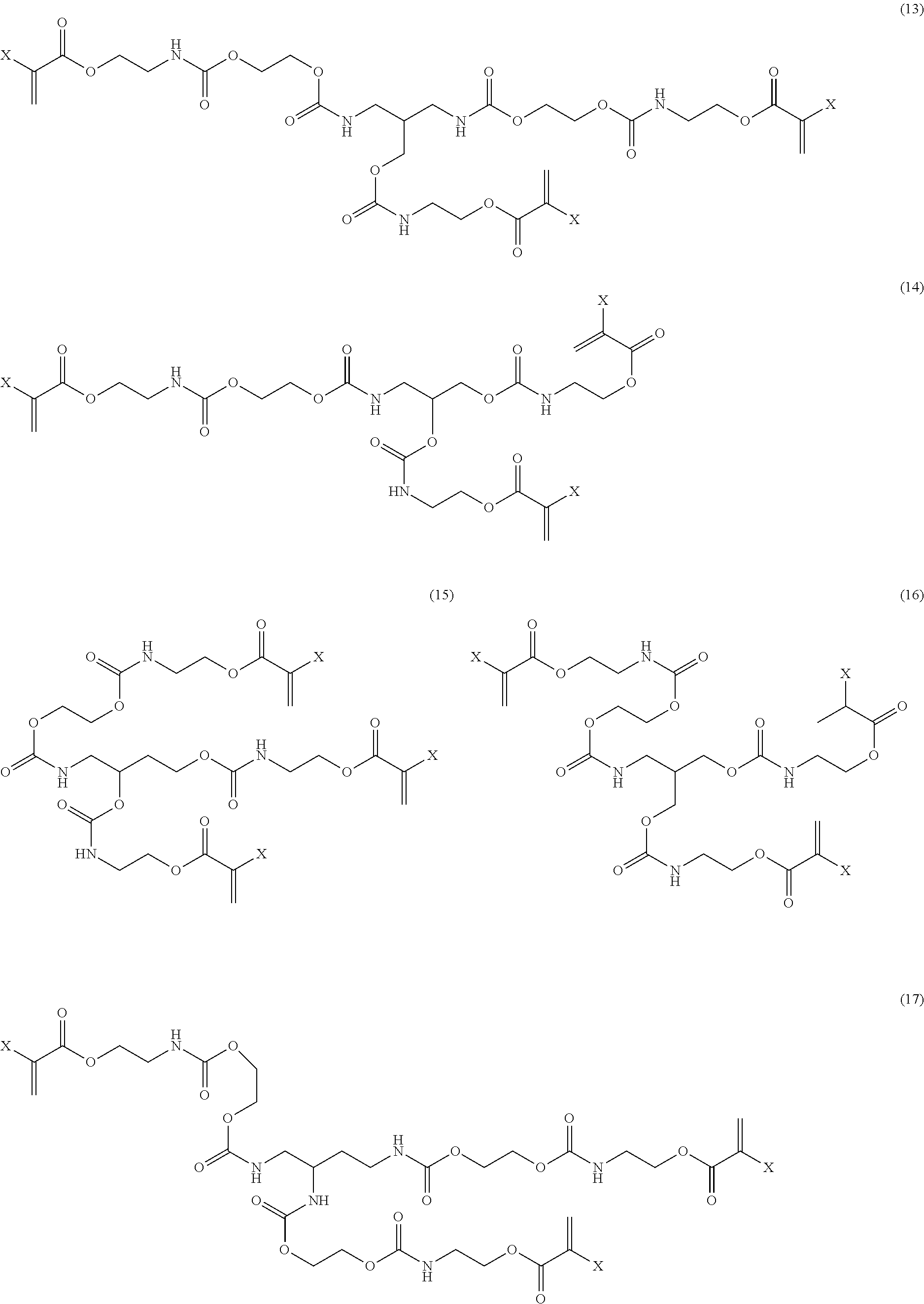 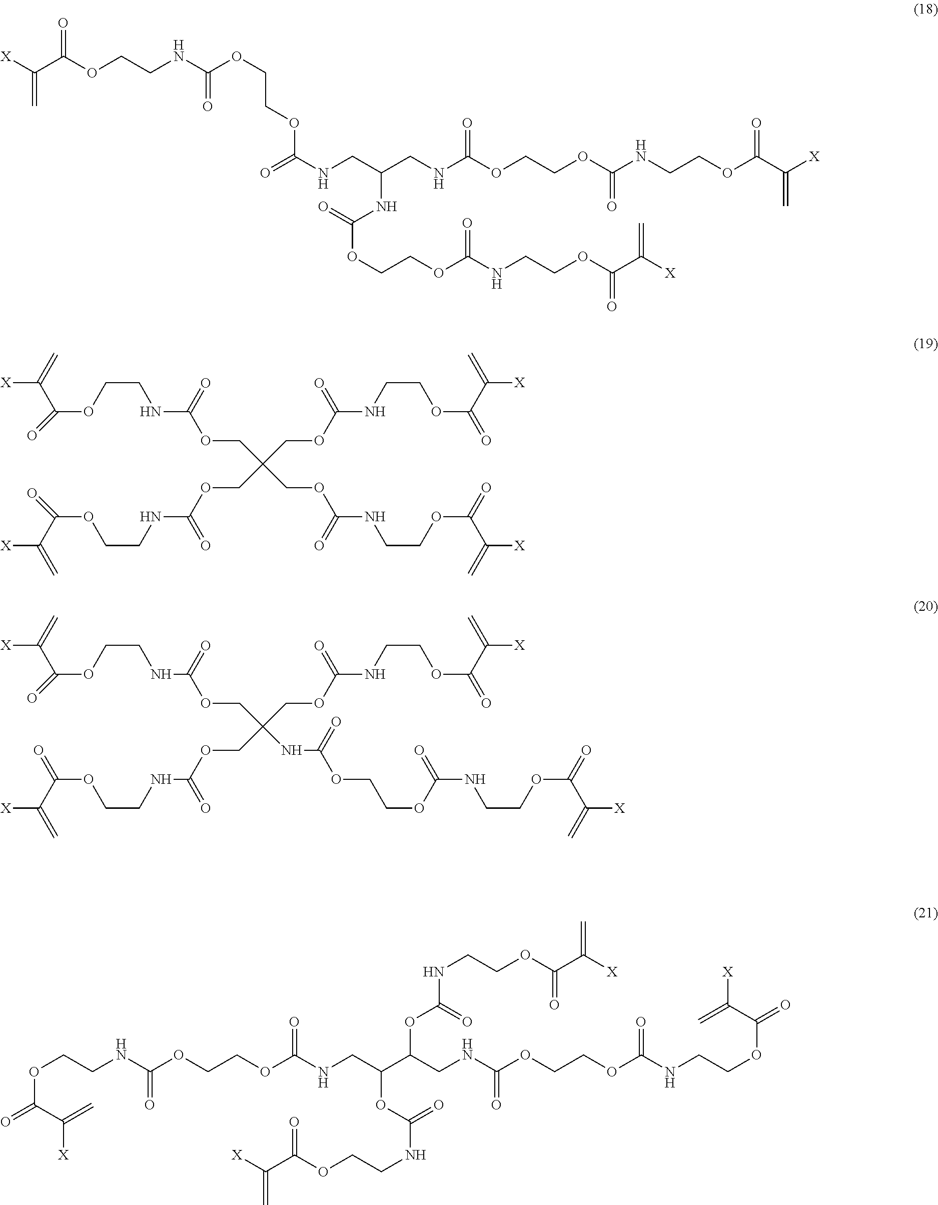 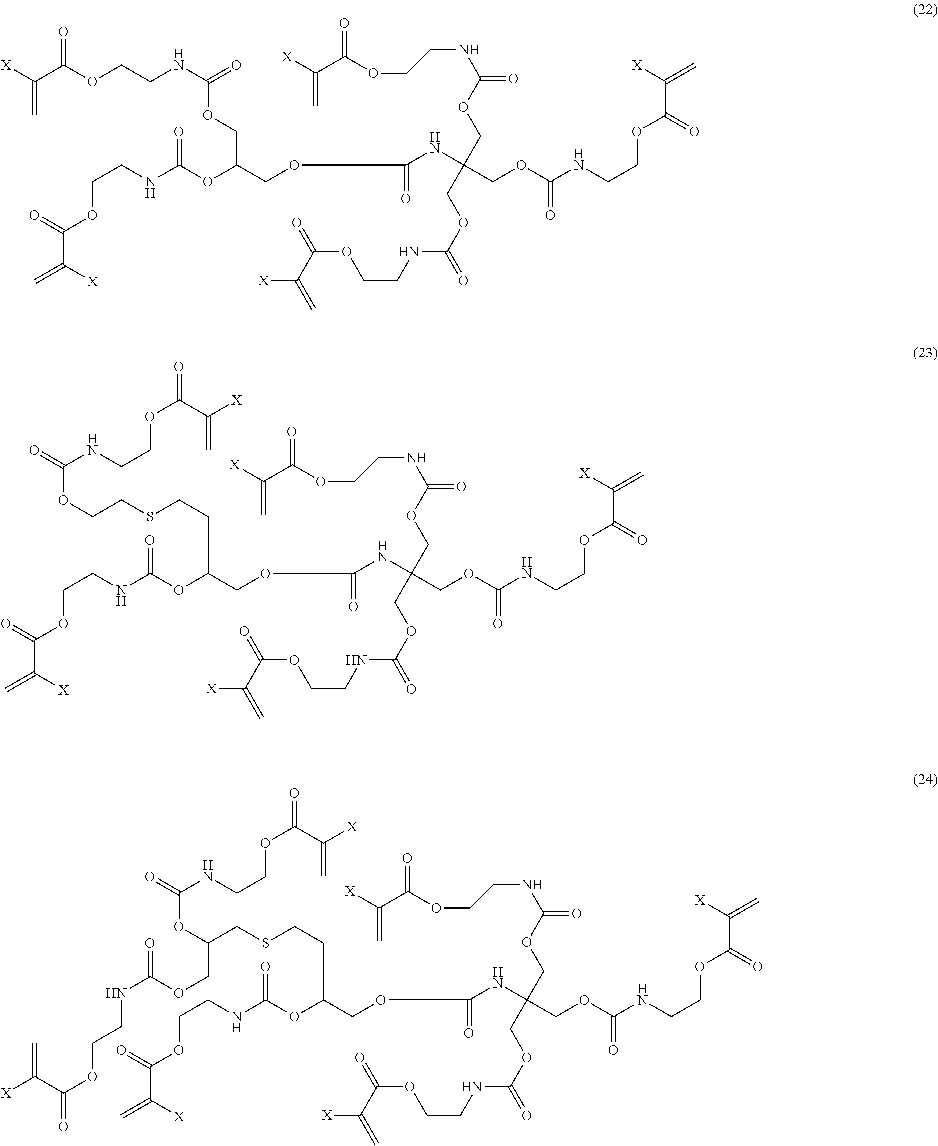 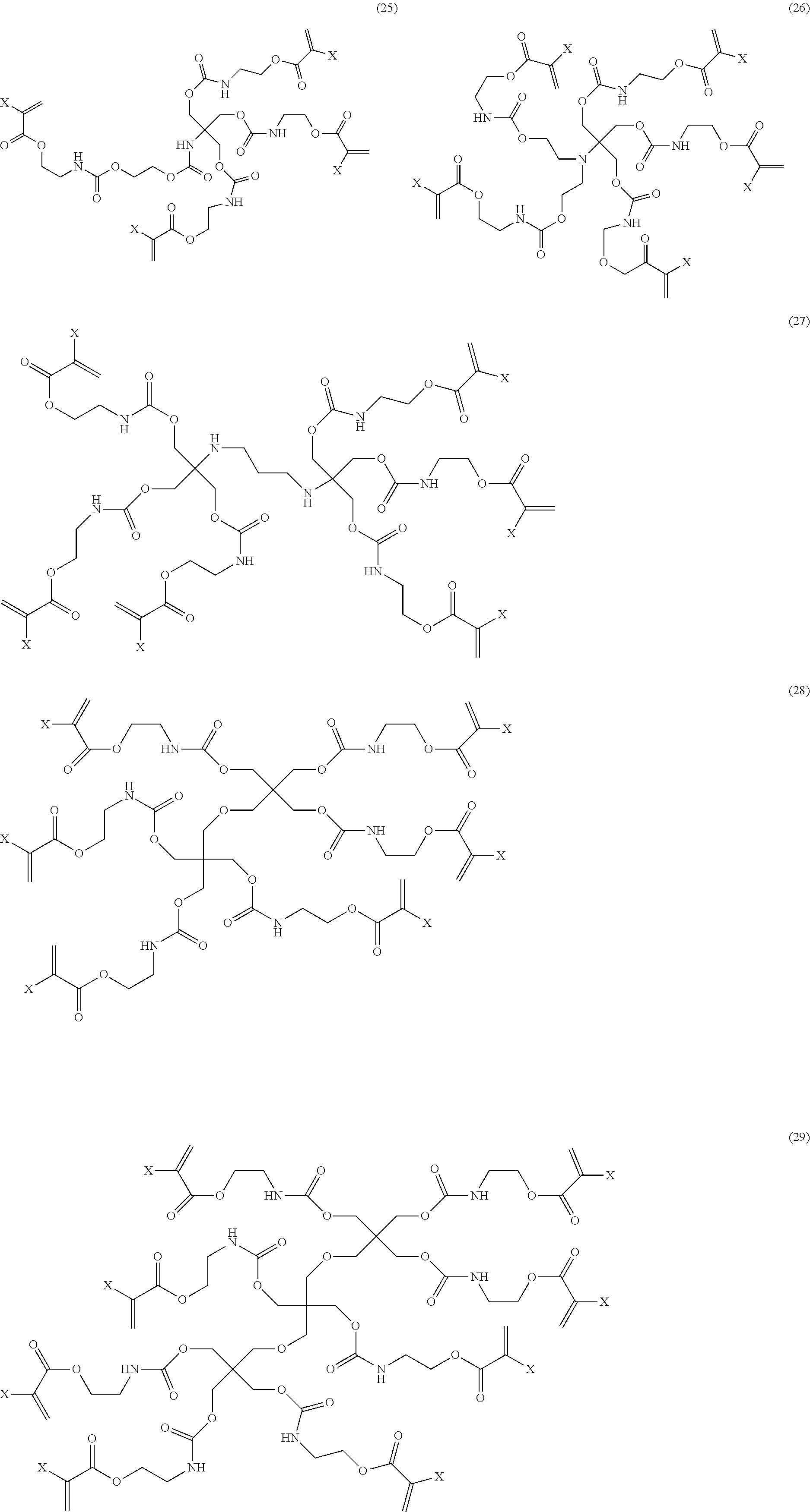 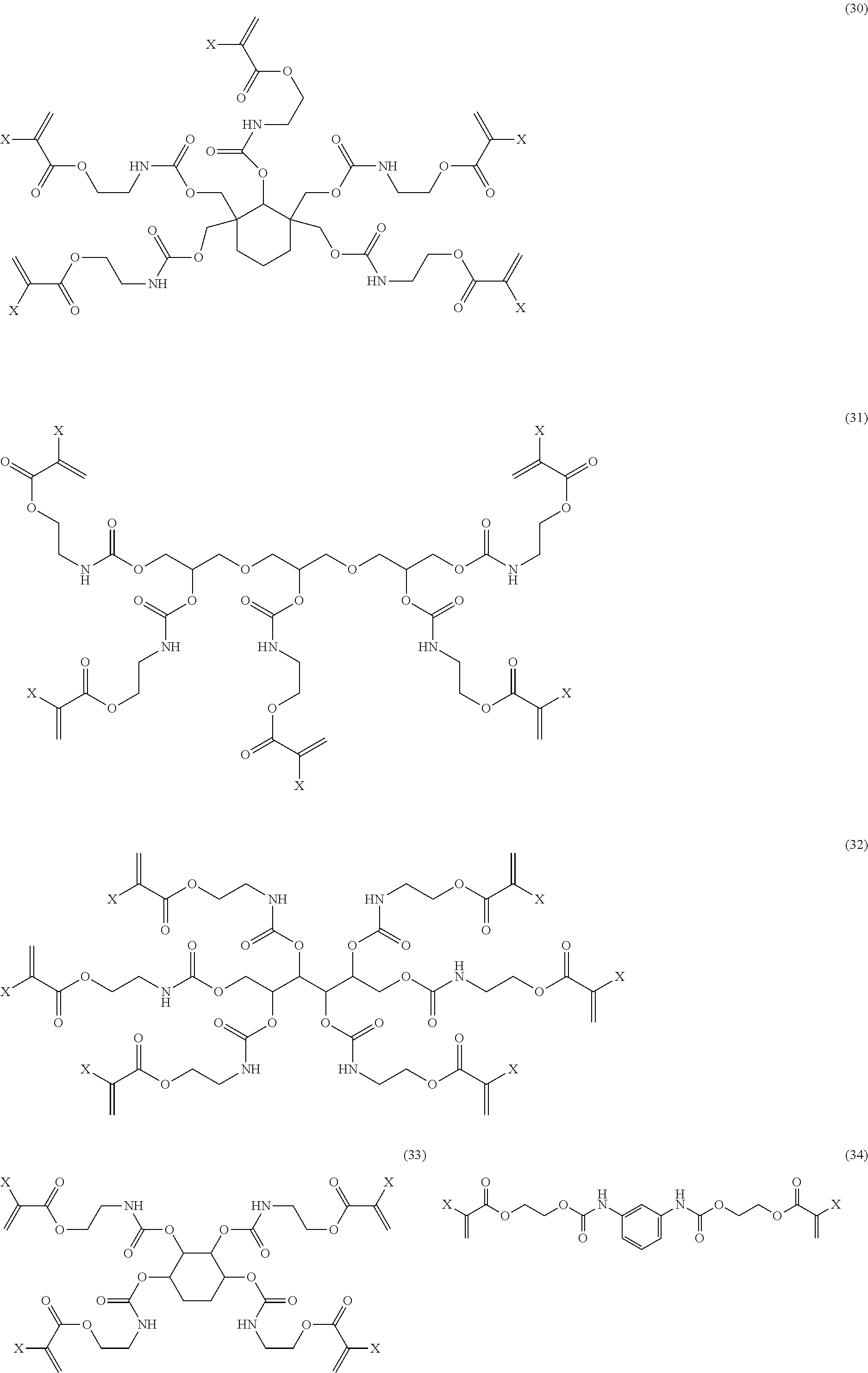 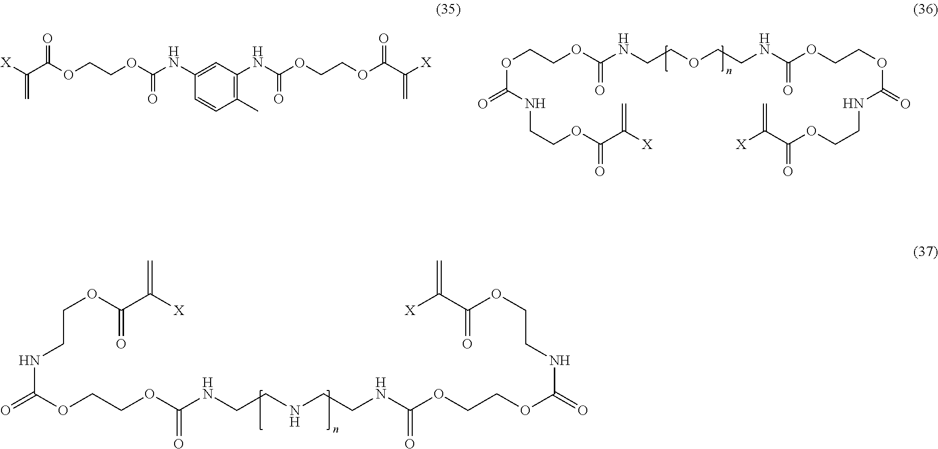 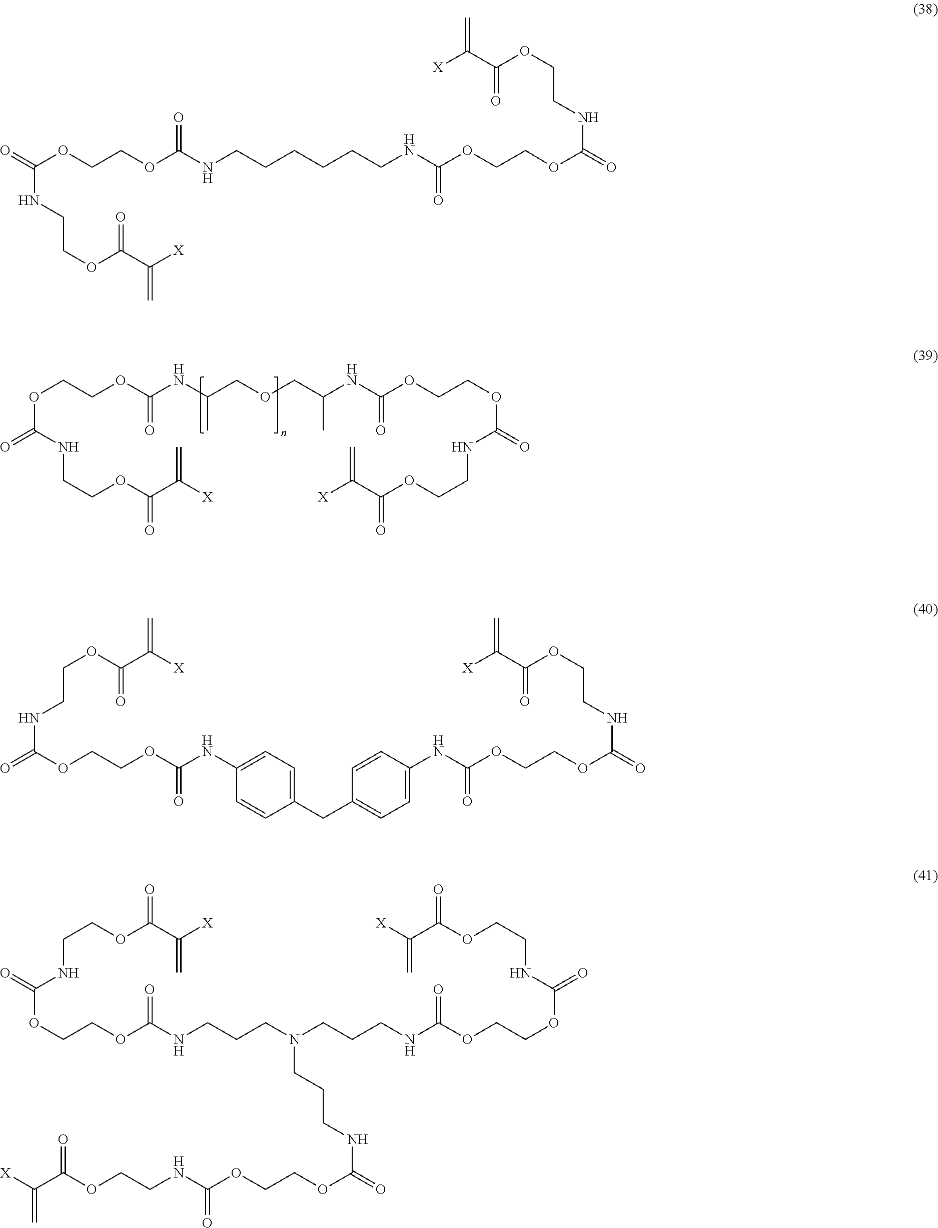 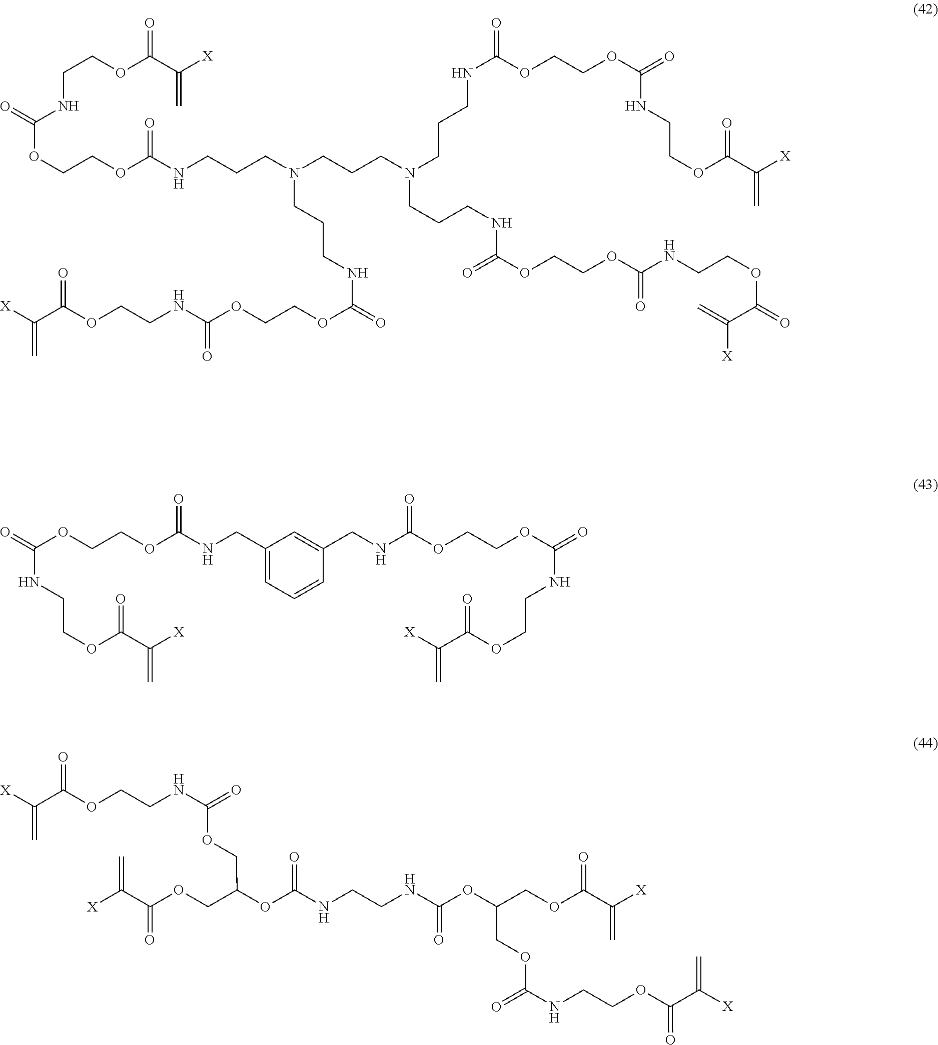 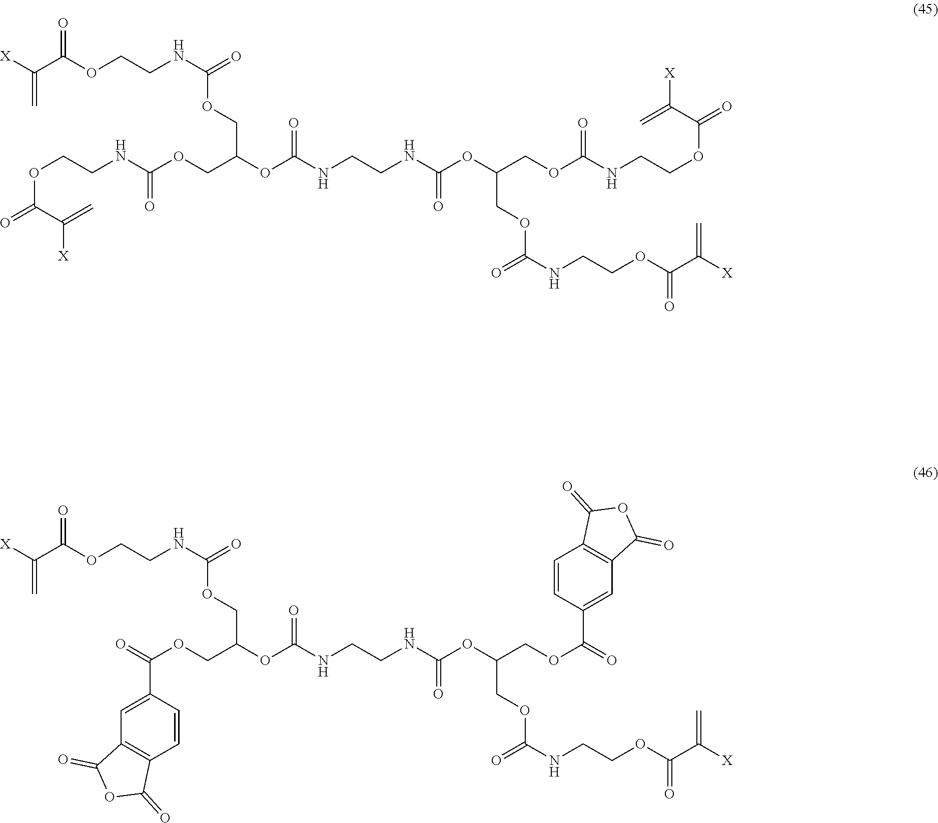 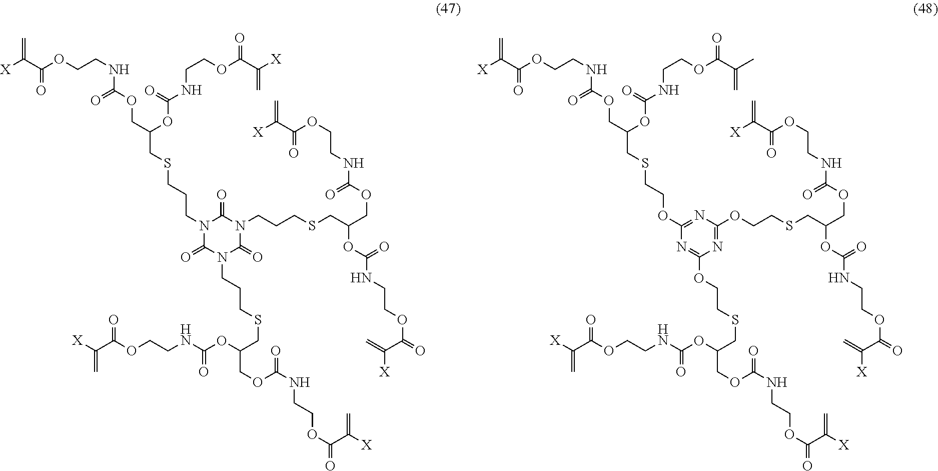 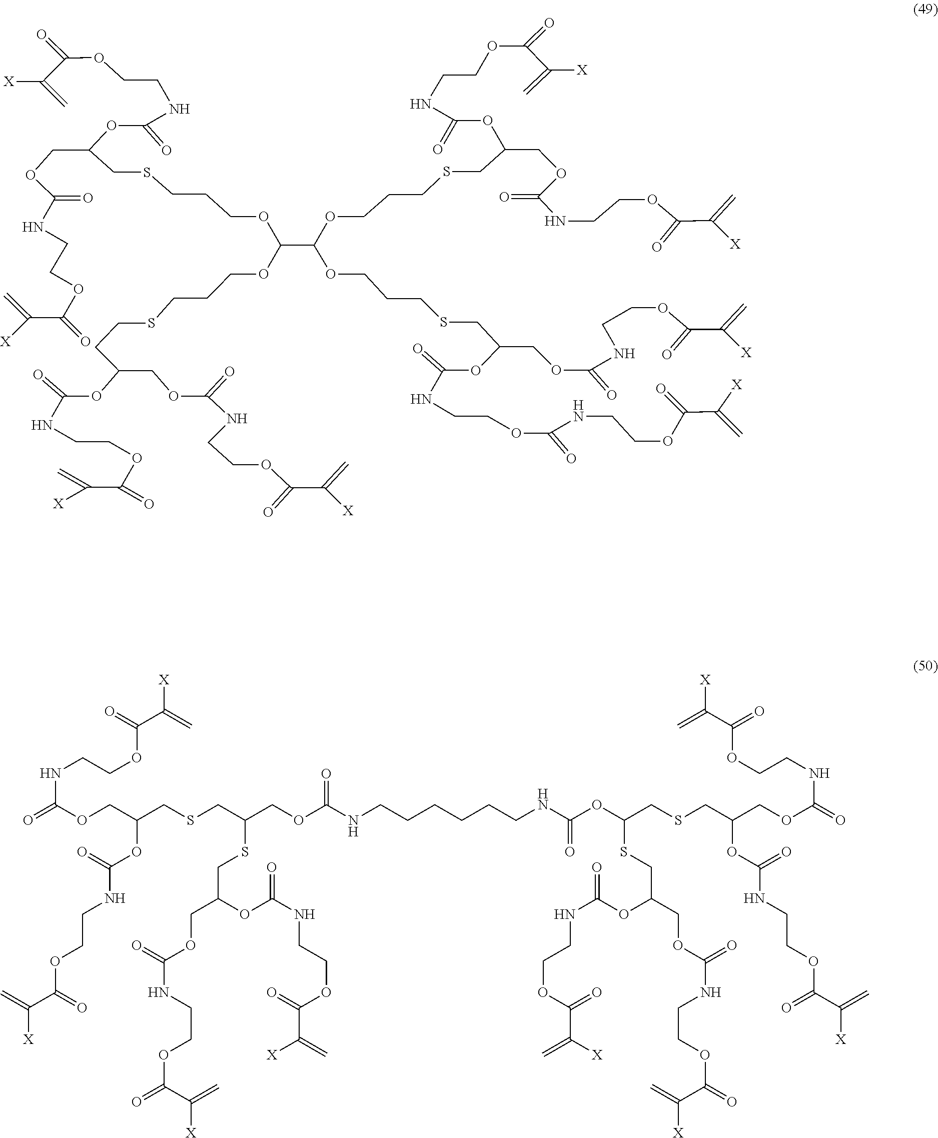 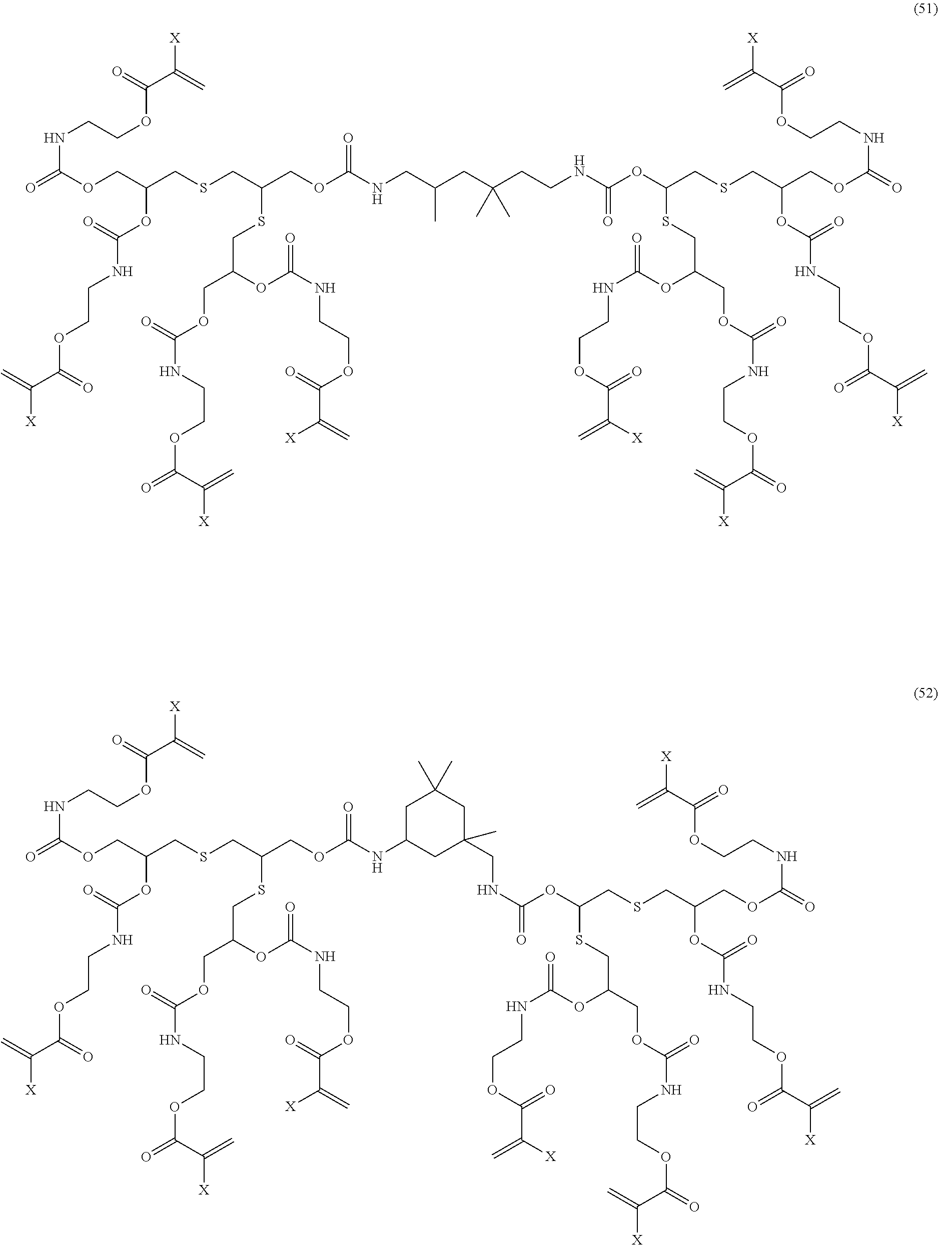 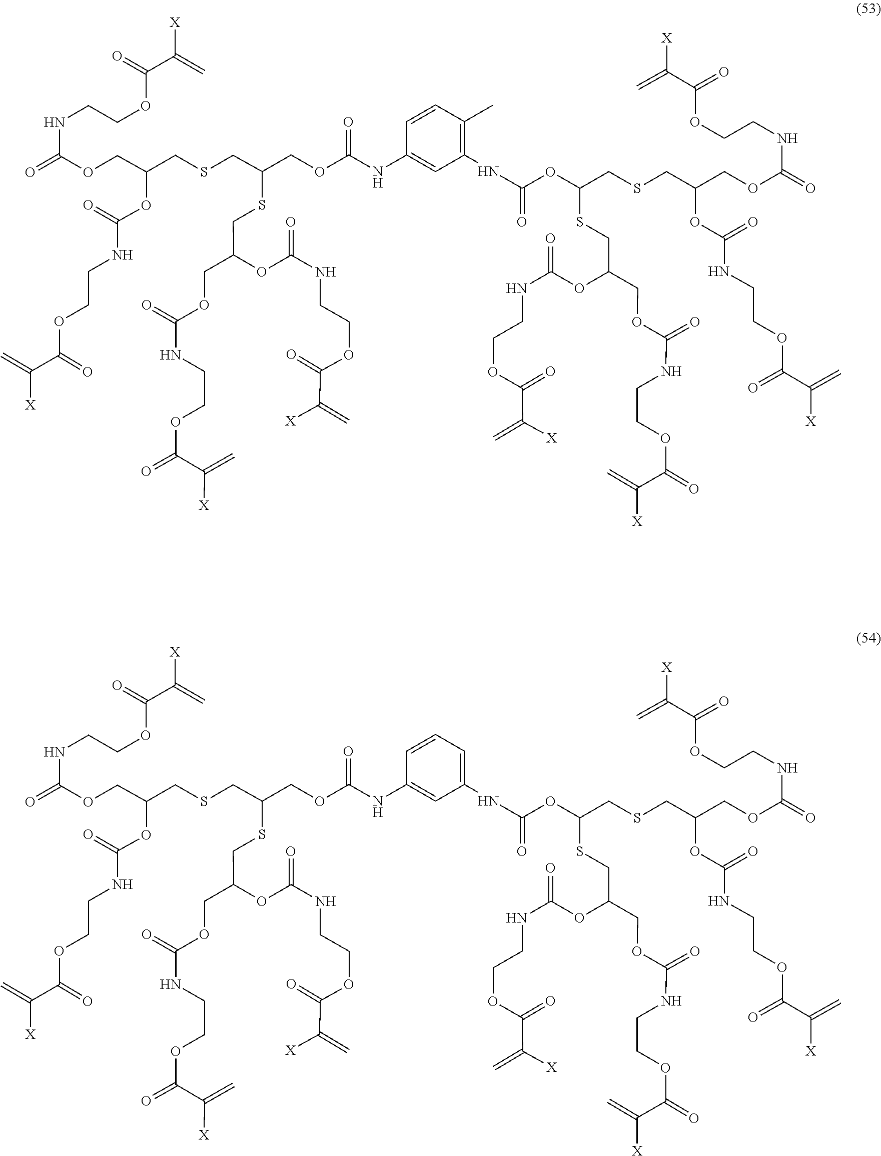 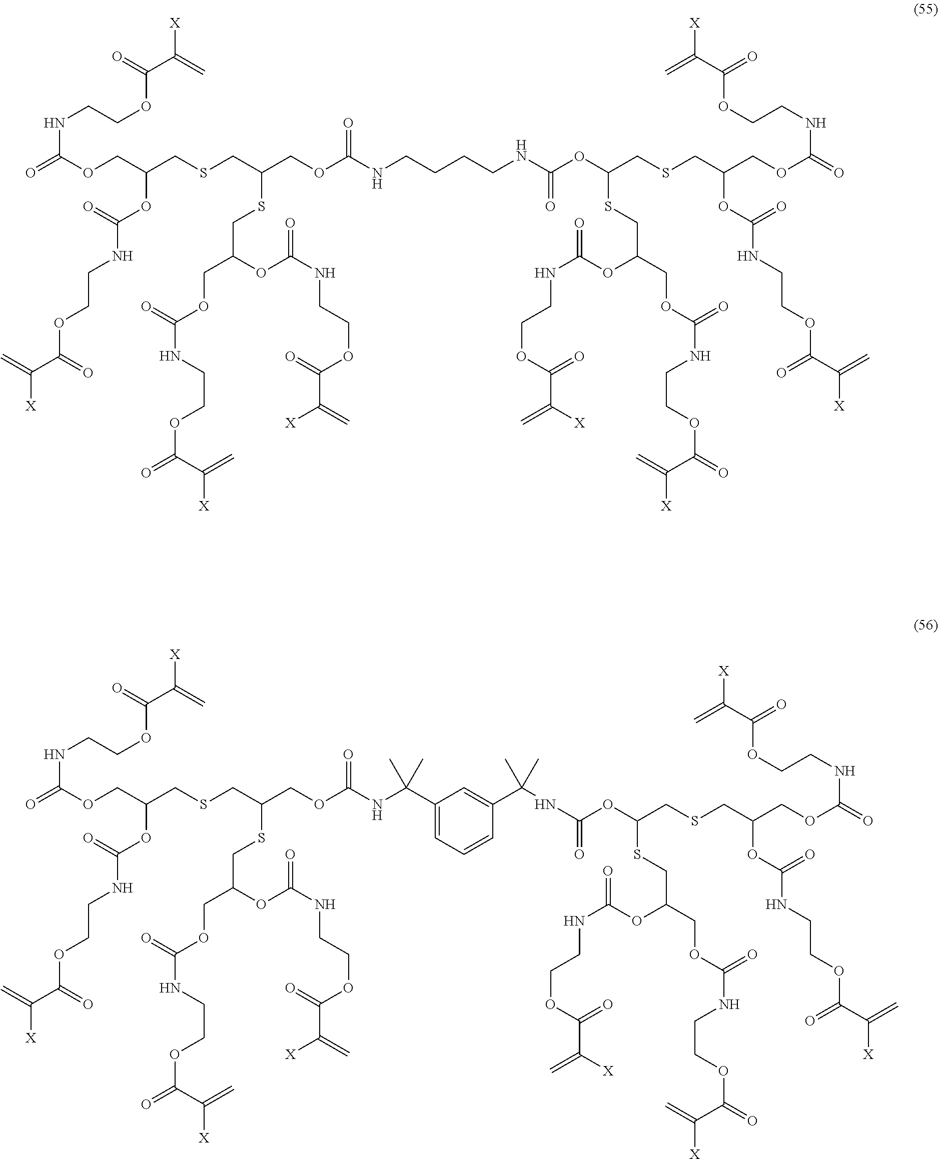 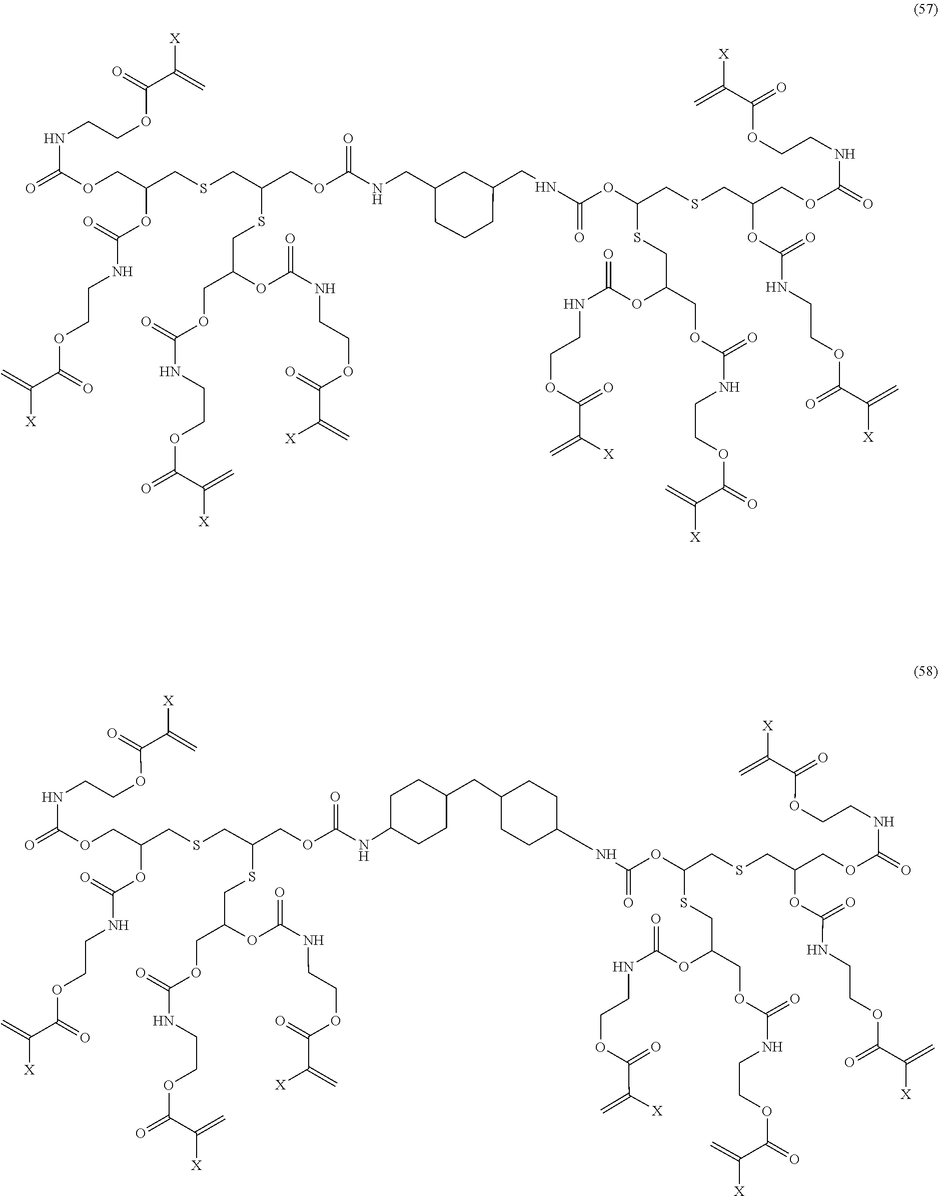 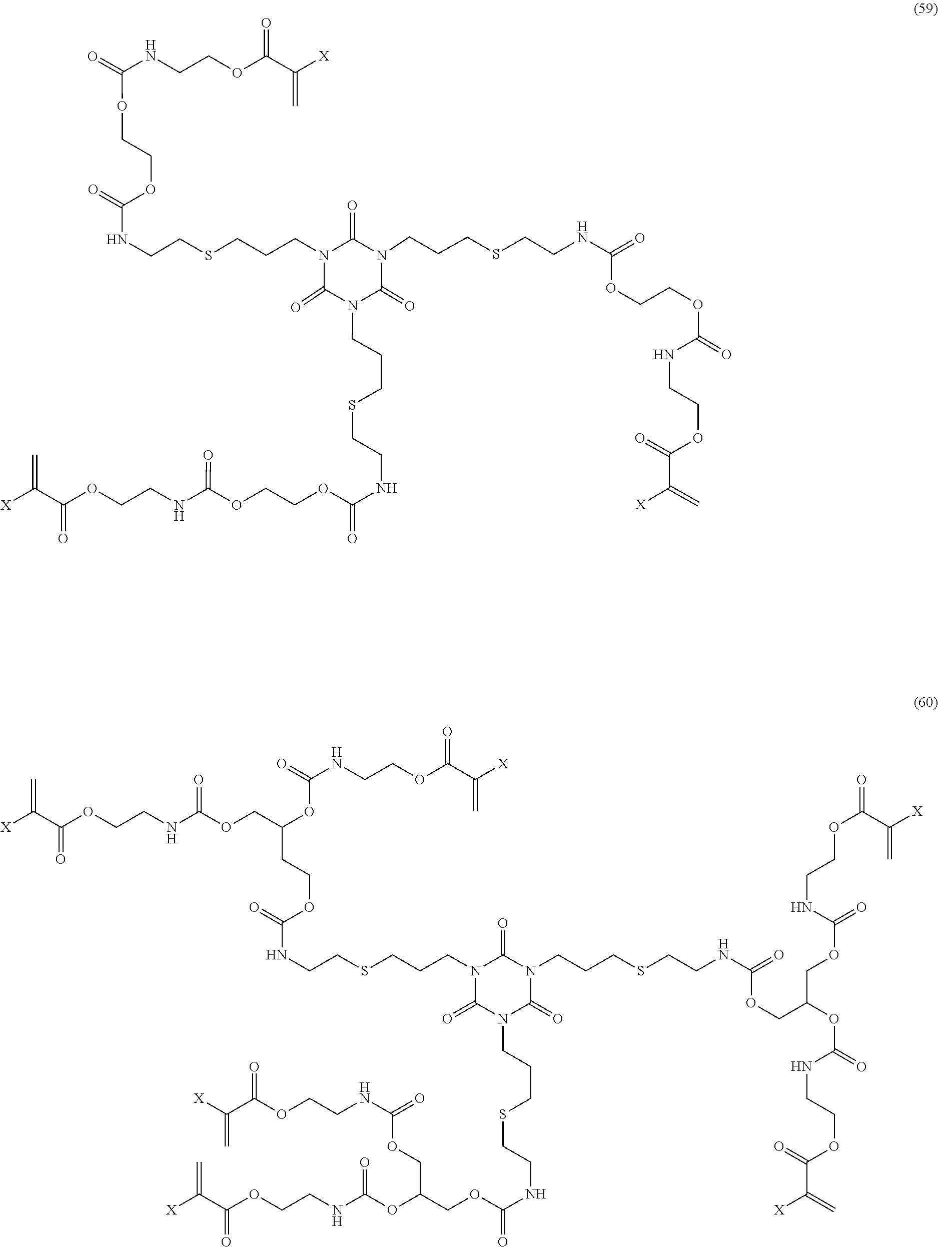 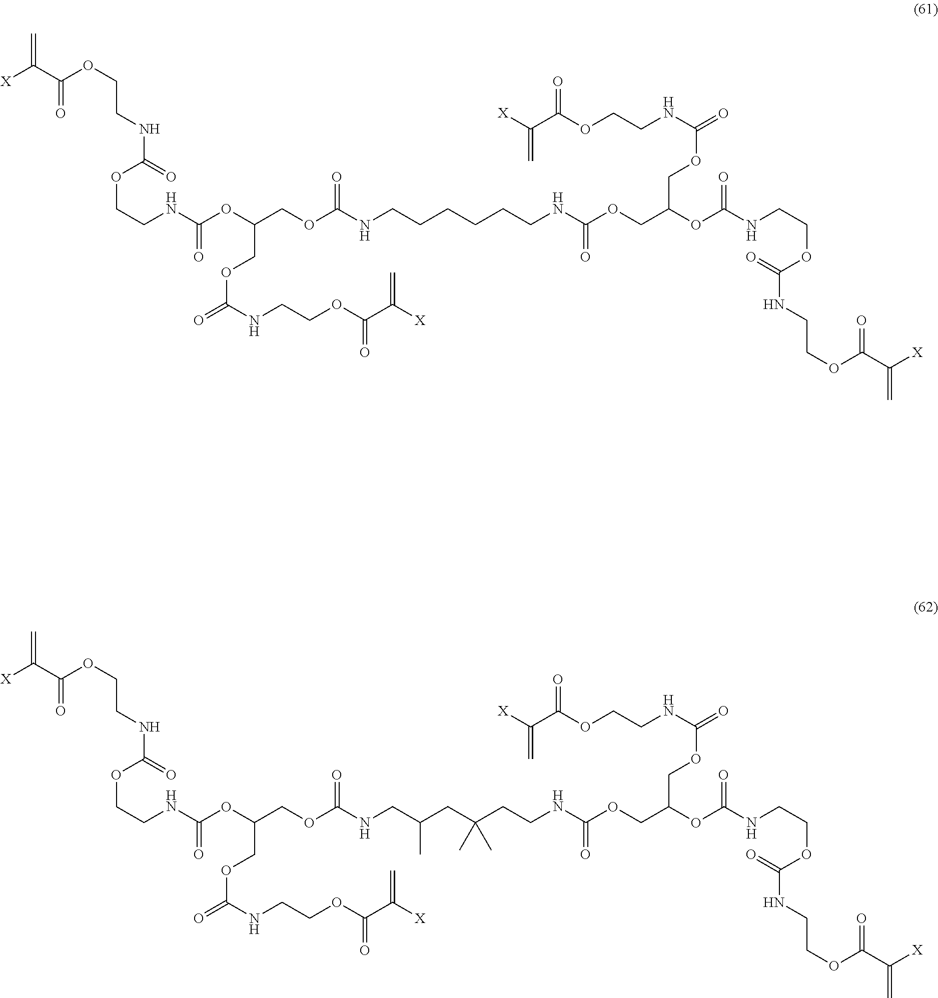 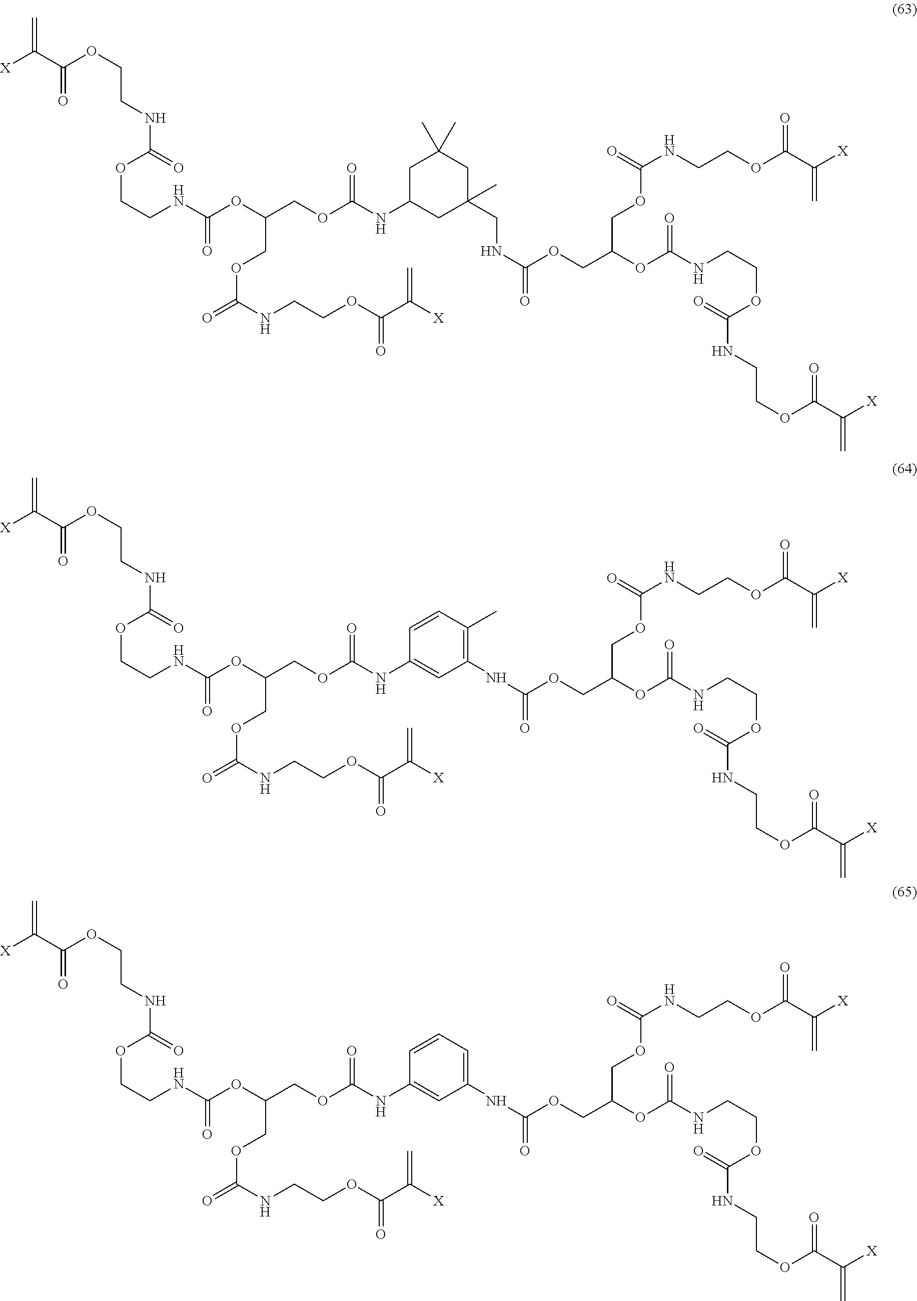 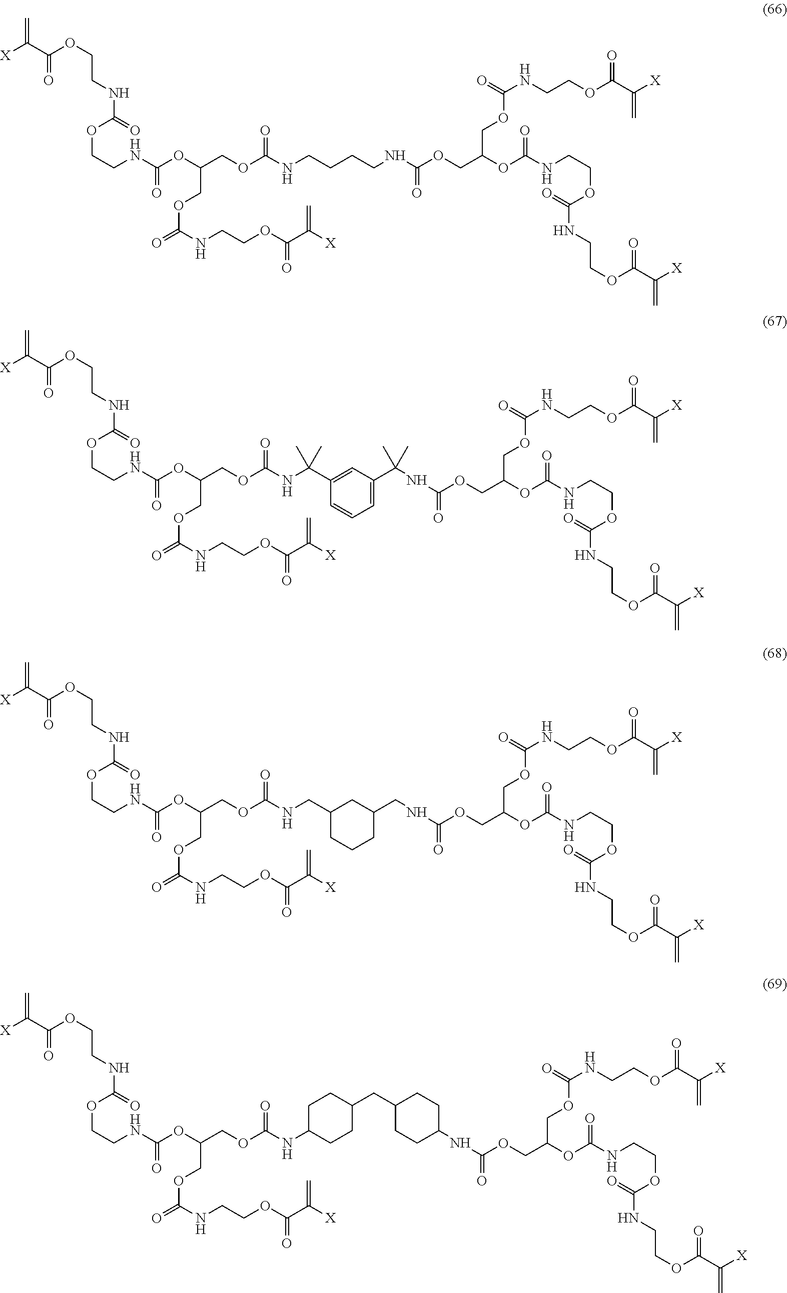 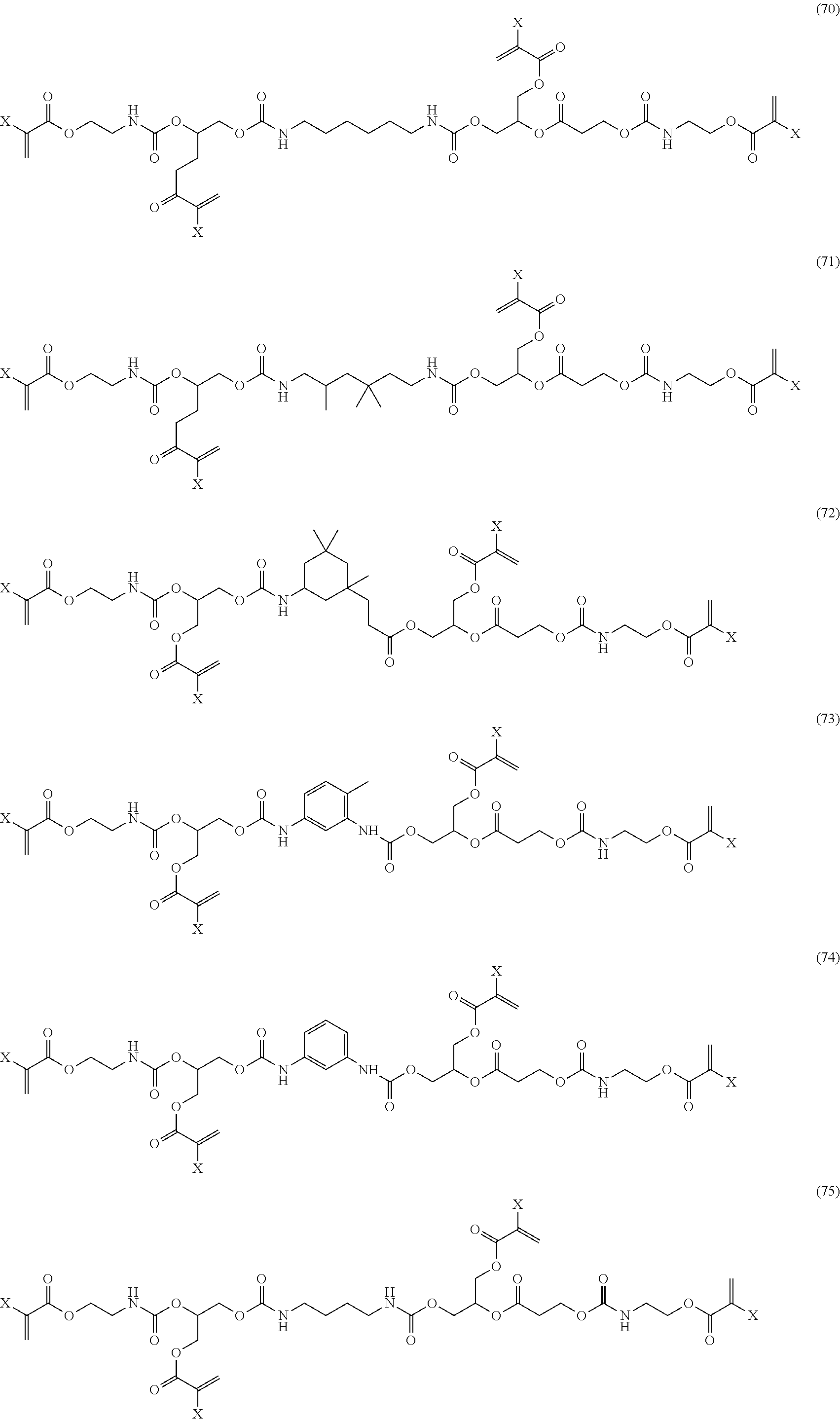 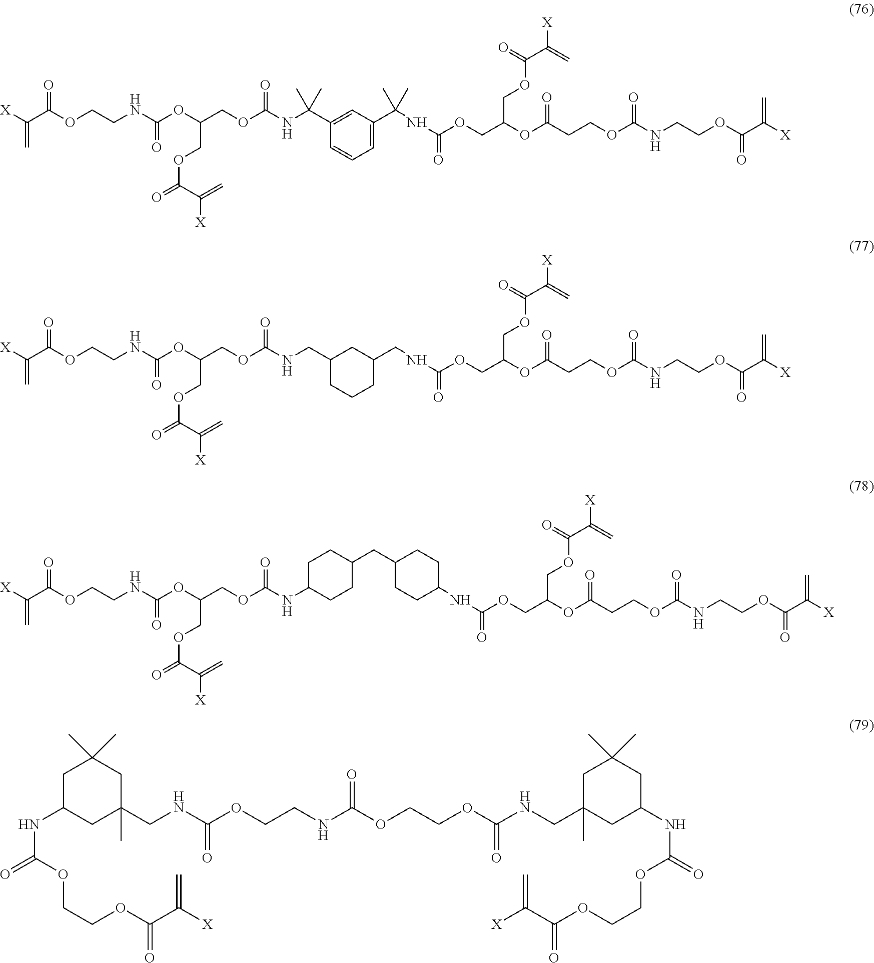 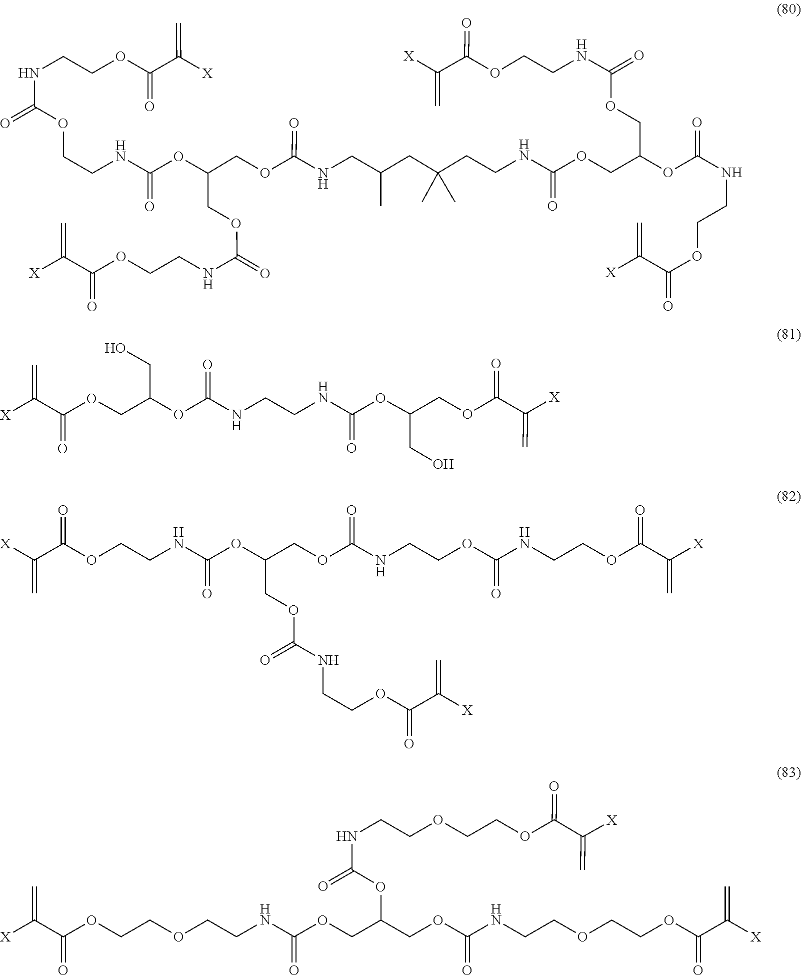
and combinations thereof; wherein each occurrence of X is independently hydrogen or methyl; each occurrence of R¹ and R² and R³ is independently hydrogen or C₁-C₆ alkyl, or R¹ and R² and the carbon atoms to which they are attached collectively form a C₅-C₈ cycloalkylene group, or R² and R³ and the carbon atoms to which they are attached collectively form a C₅-C₈ cycloalkylene group, or R¹ and R³ and the three carbon atoms that separate them collectively form a C₅-C₈ cycloalkylene group; and n is 1, 2, 3, 4, 5, 6, 7, 8, 9, 10, 11, or 12.

11. The curable composition of claim 1, wherein the acidic or latent acidic comonomer is (meth)acrylic acid.

12. A urethane (meth)acrylate monomer comprising 2 to 12 urethane groups and 2 to 12 (meth)acrylate groups, wherein each of at least two urethane groups is separated from at least one other urethane group or at least one urea group by at most three carbon atoms; and wherein the urethane (meth)acrylate monomer has a molecular weight less than or equal to 5,000 grams/mole.

13. The urethane (meth)acrylate monomer of claim 12, selected from the group consisting of 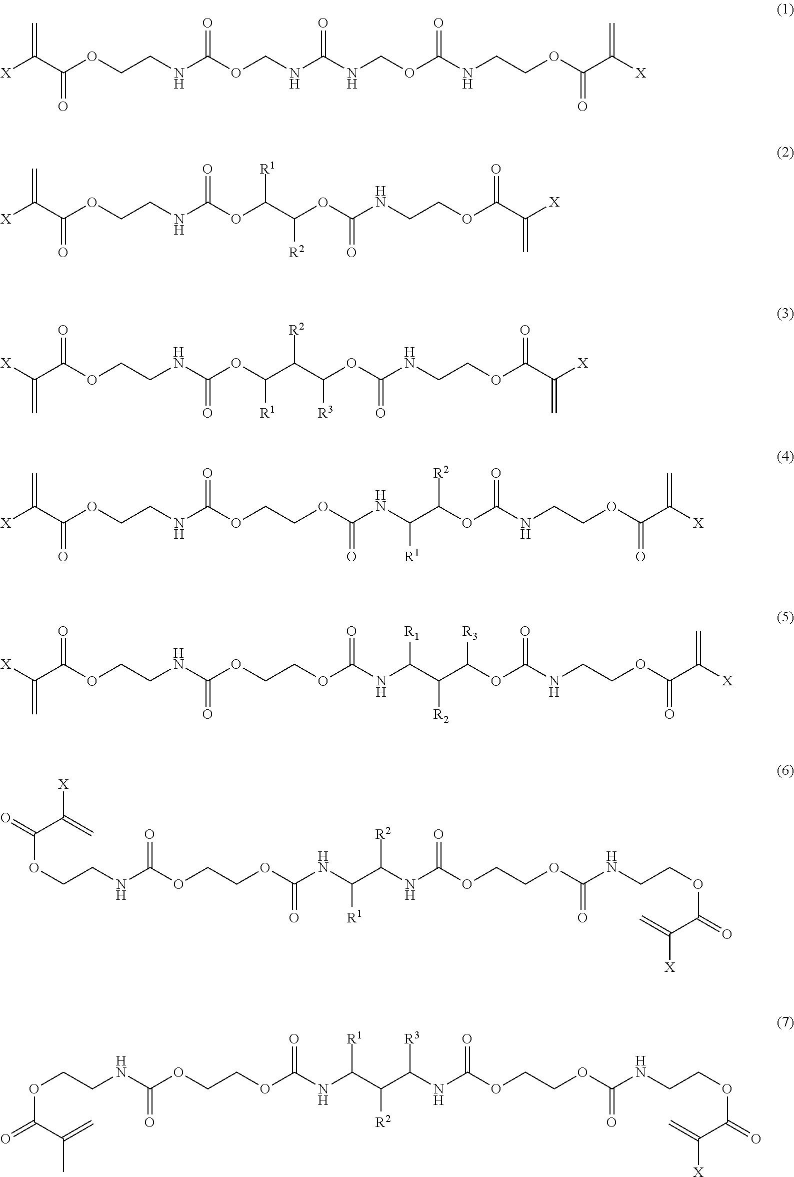 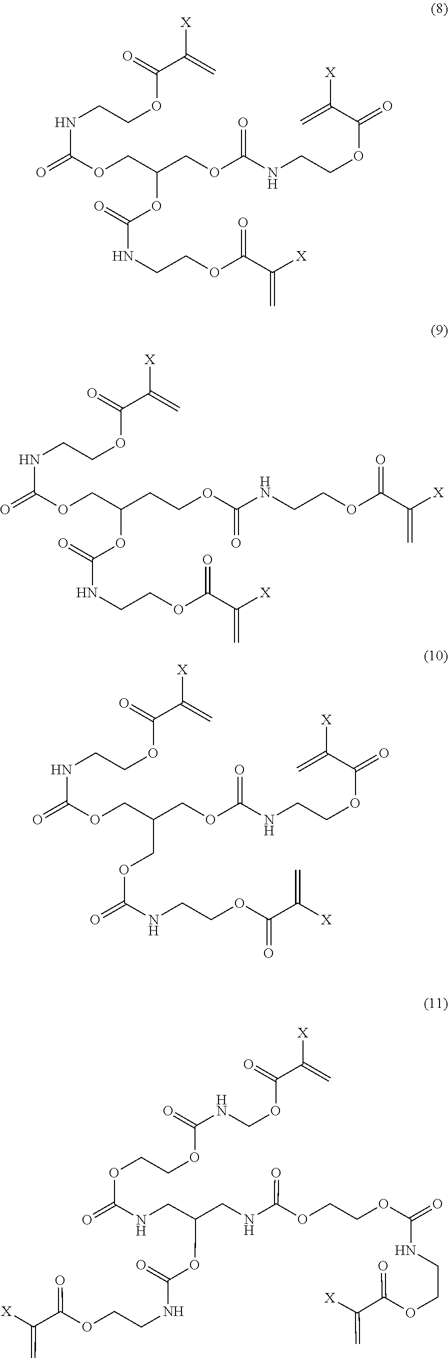 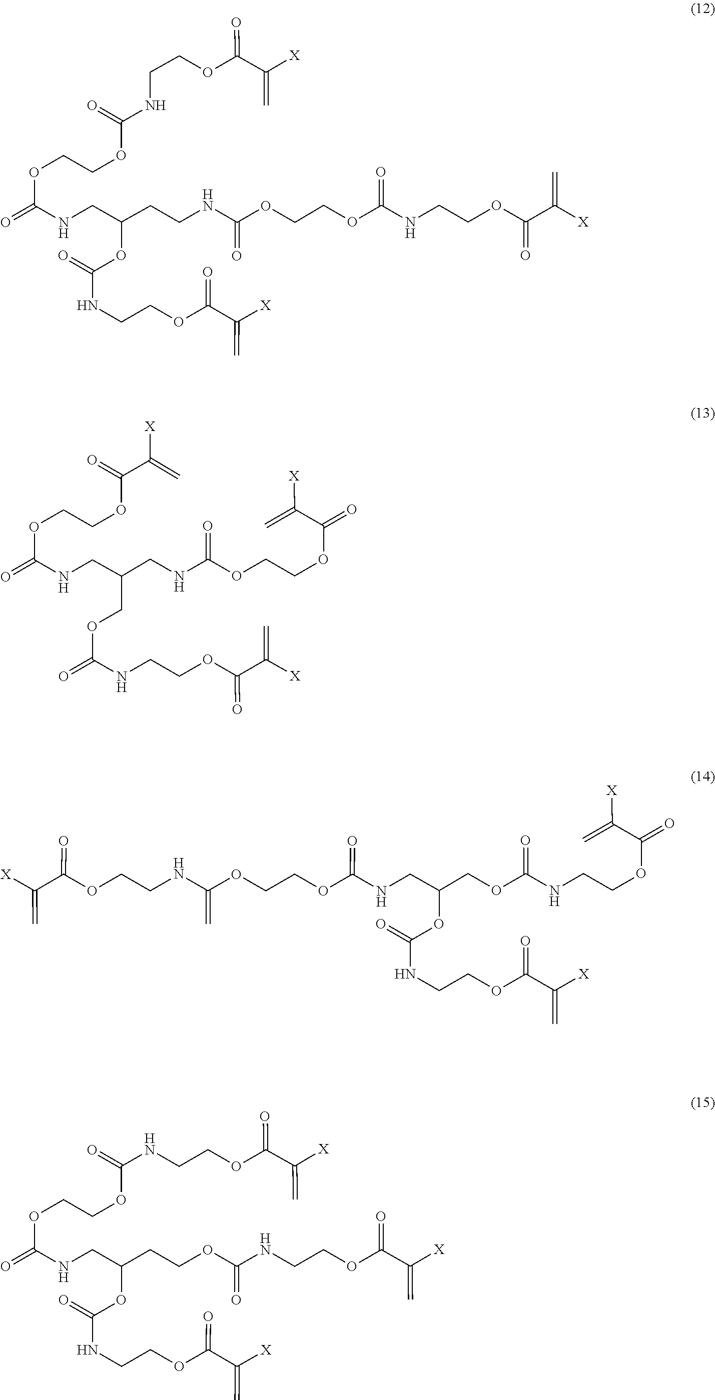 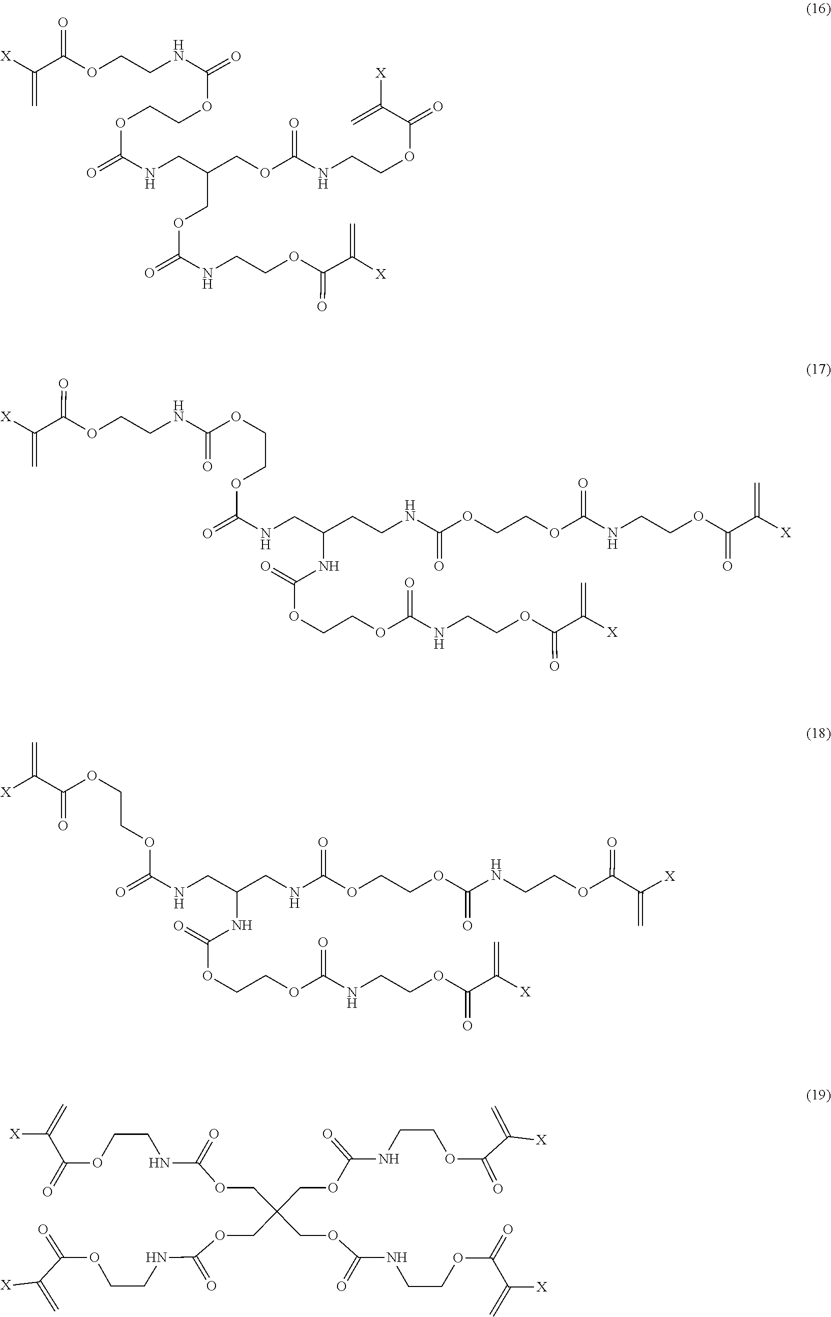 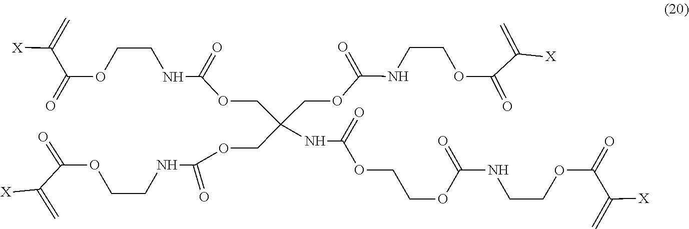 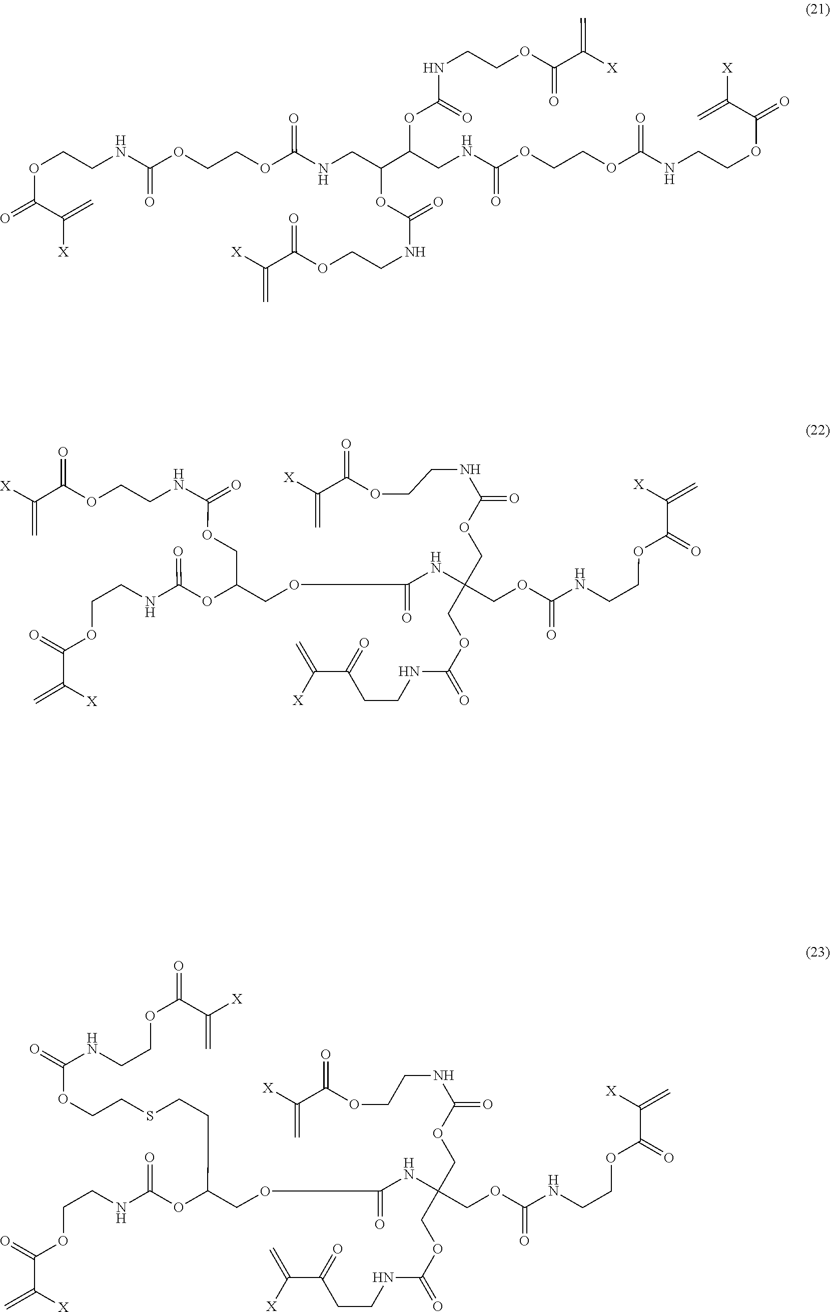 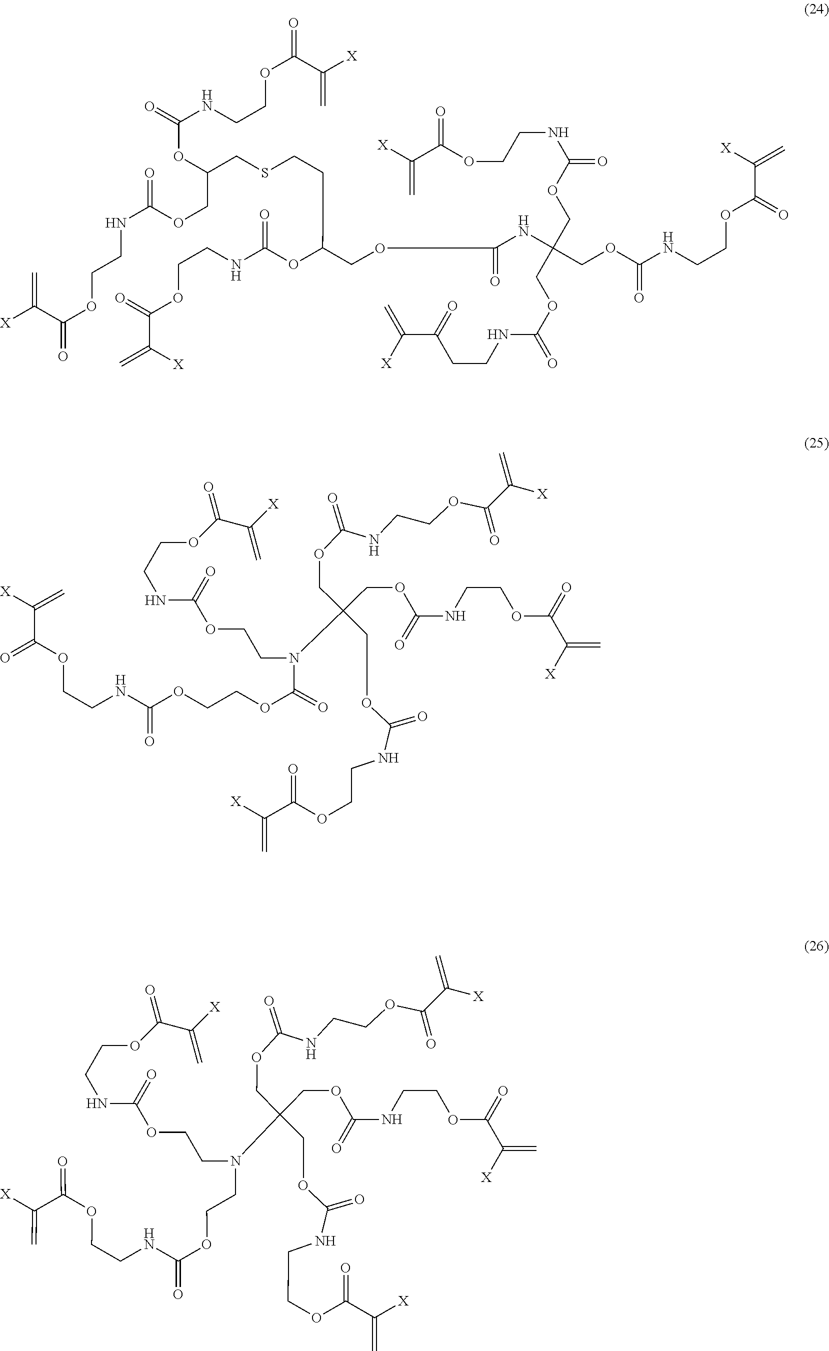 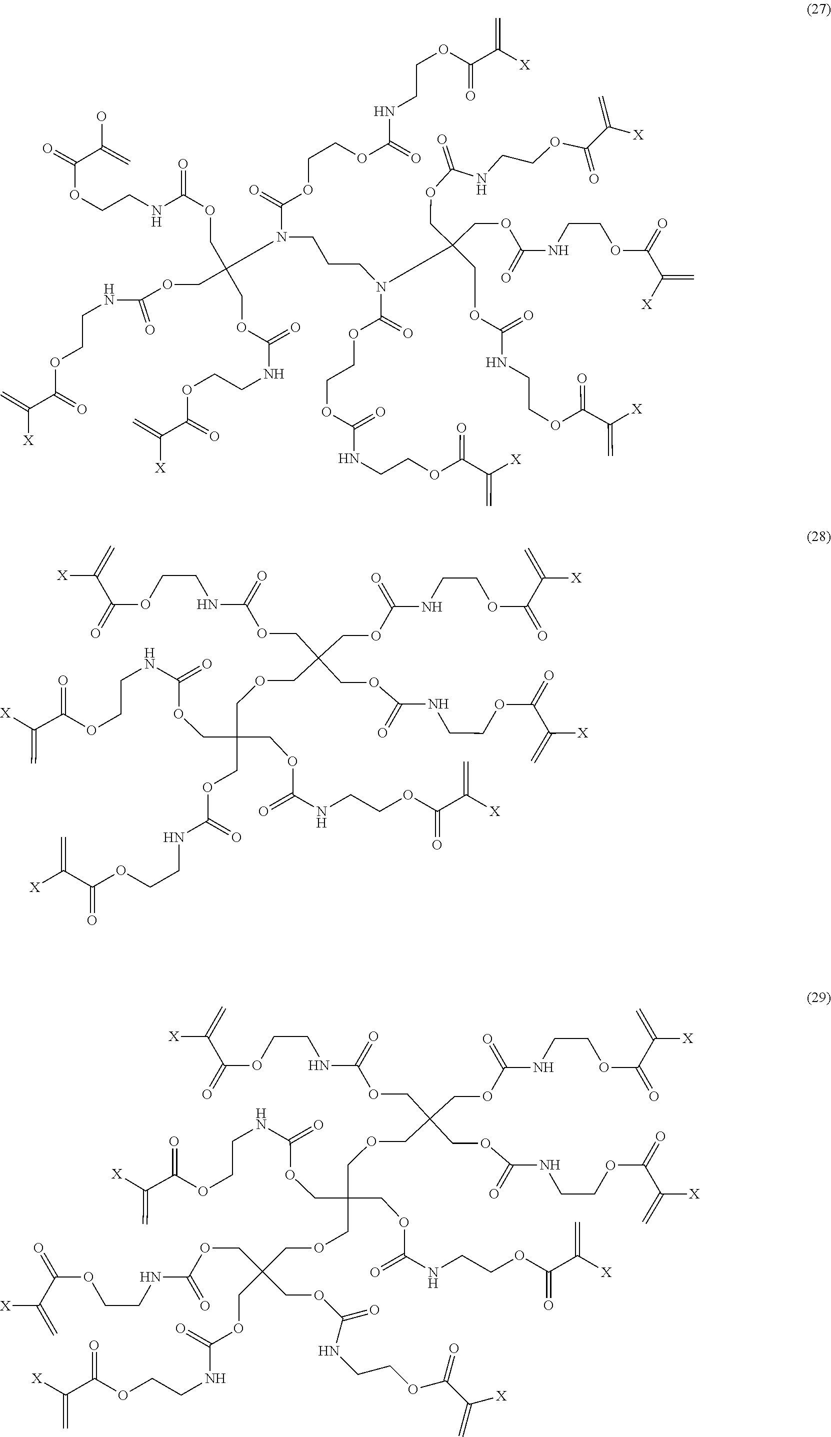 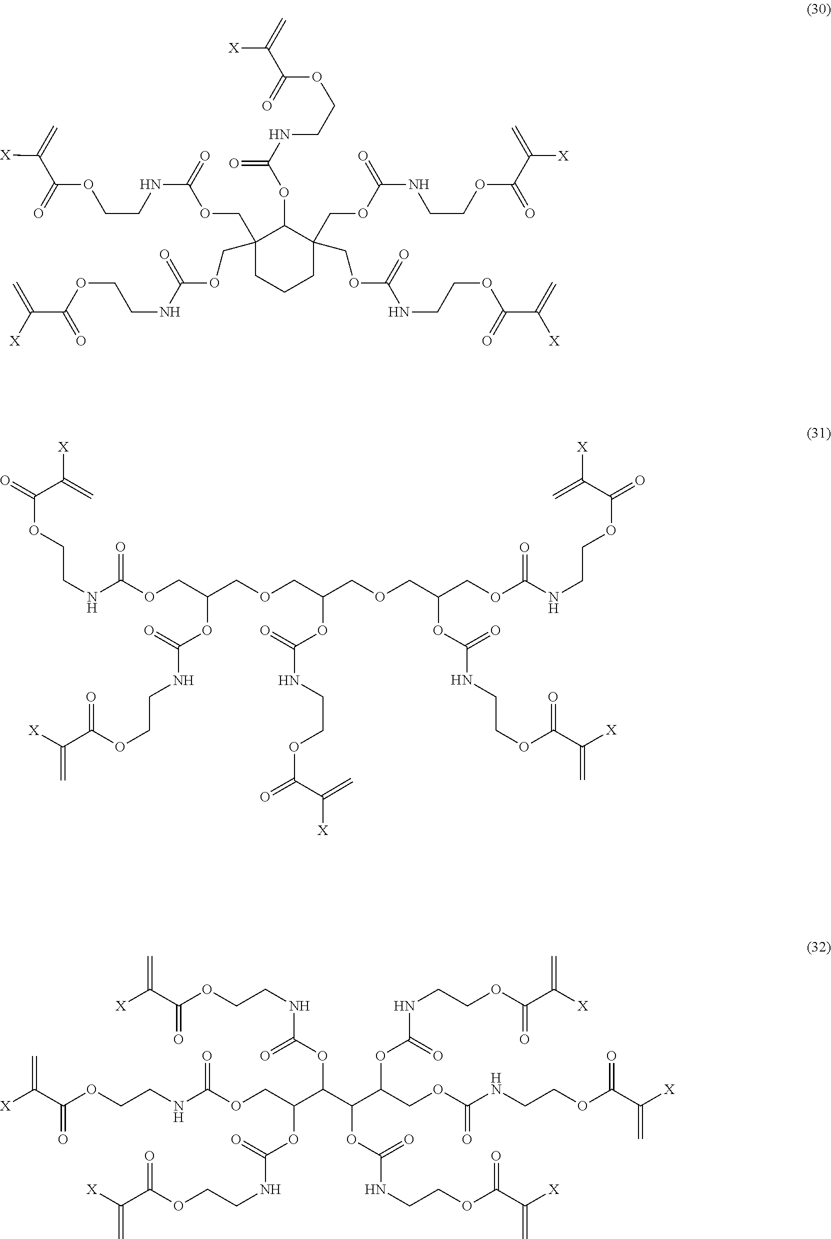 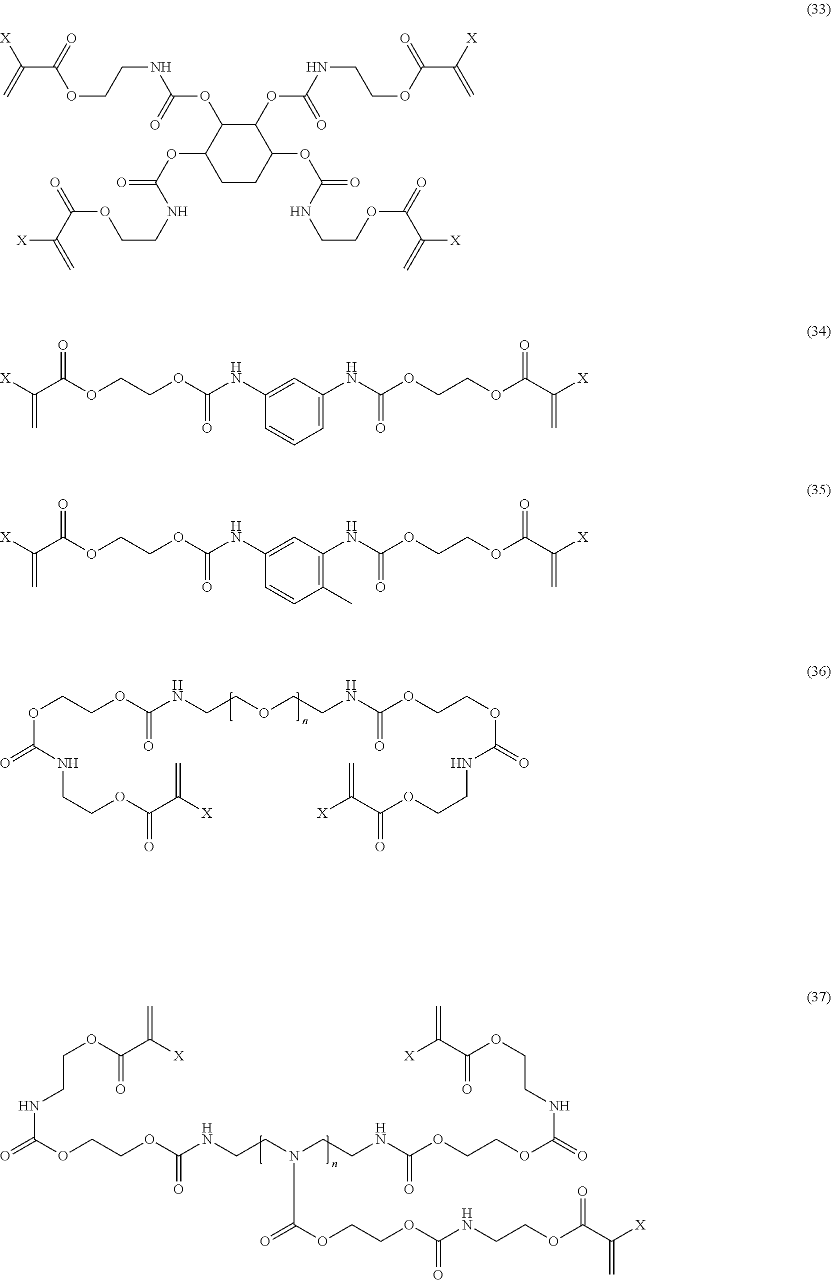 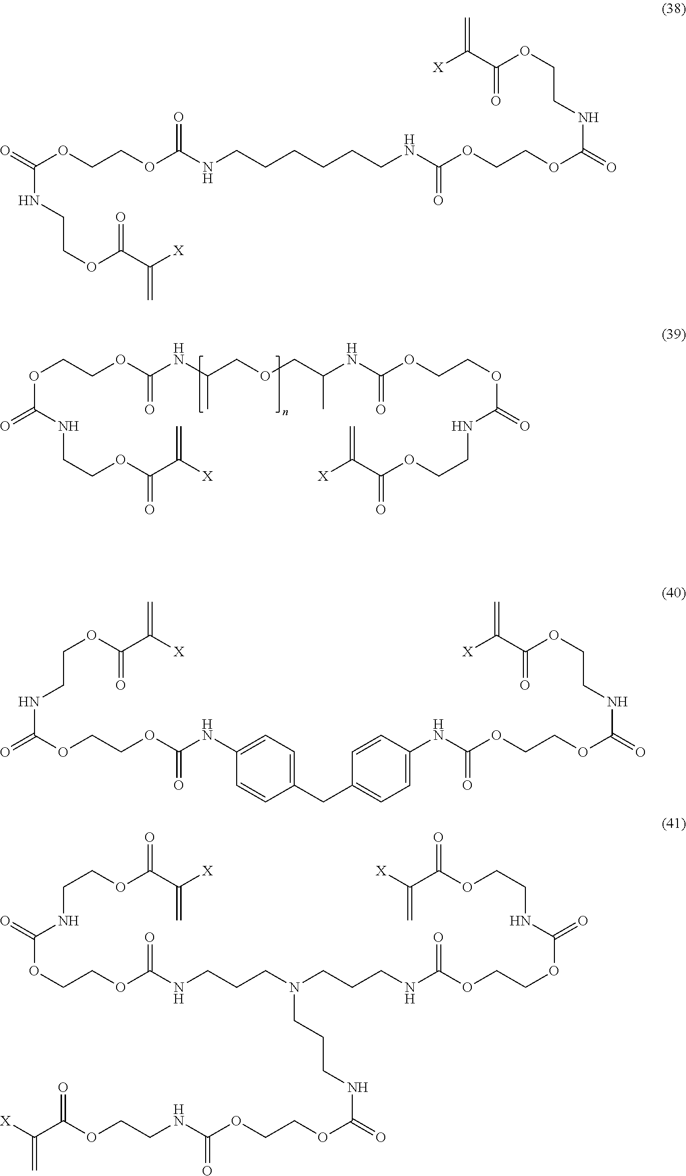 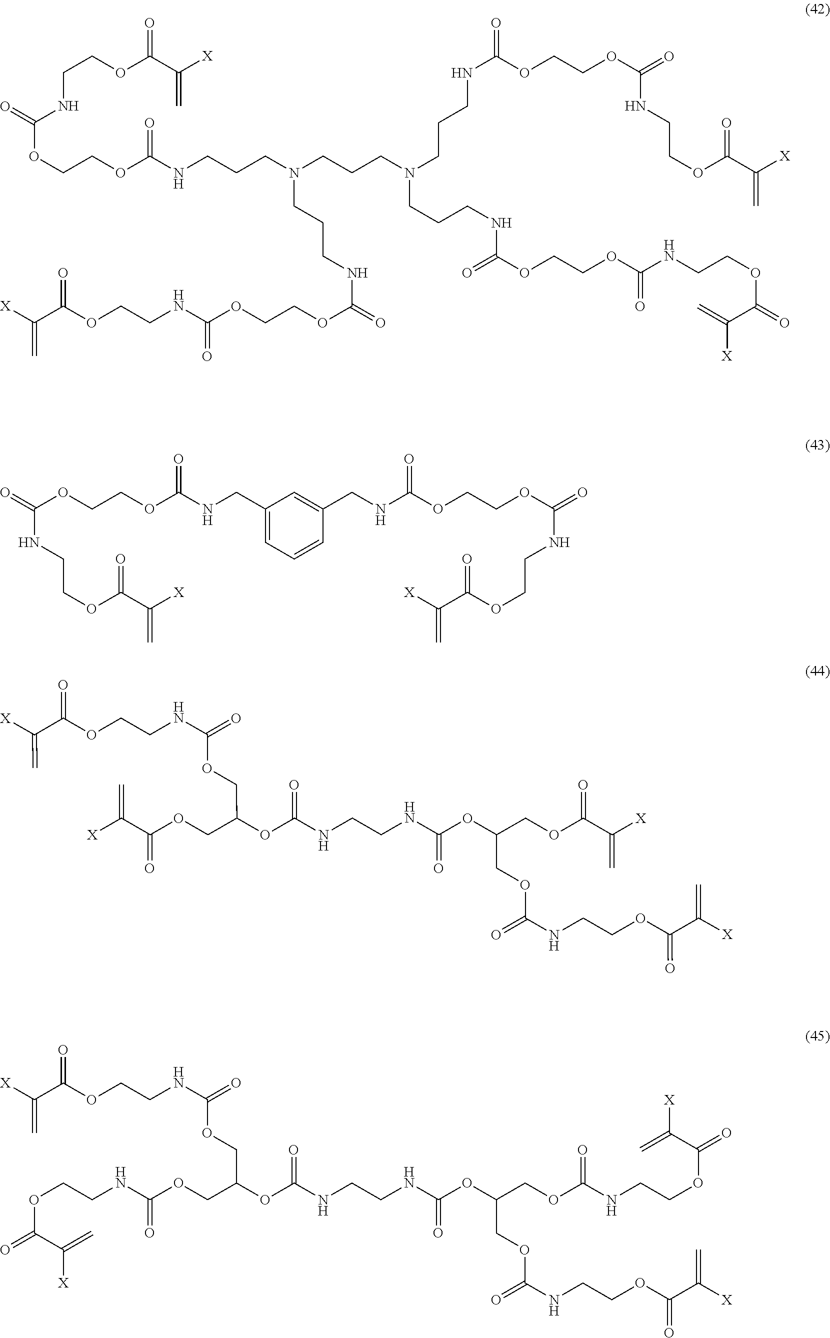 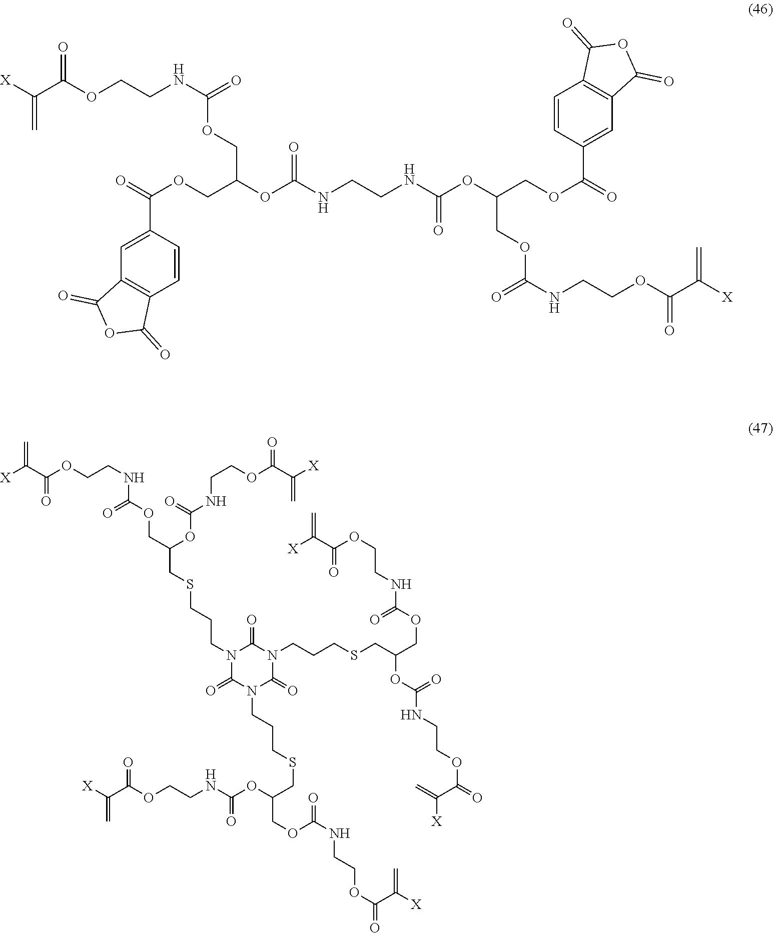 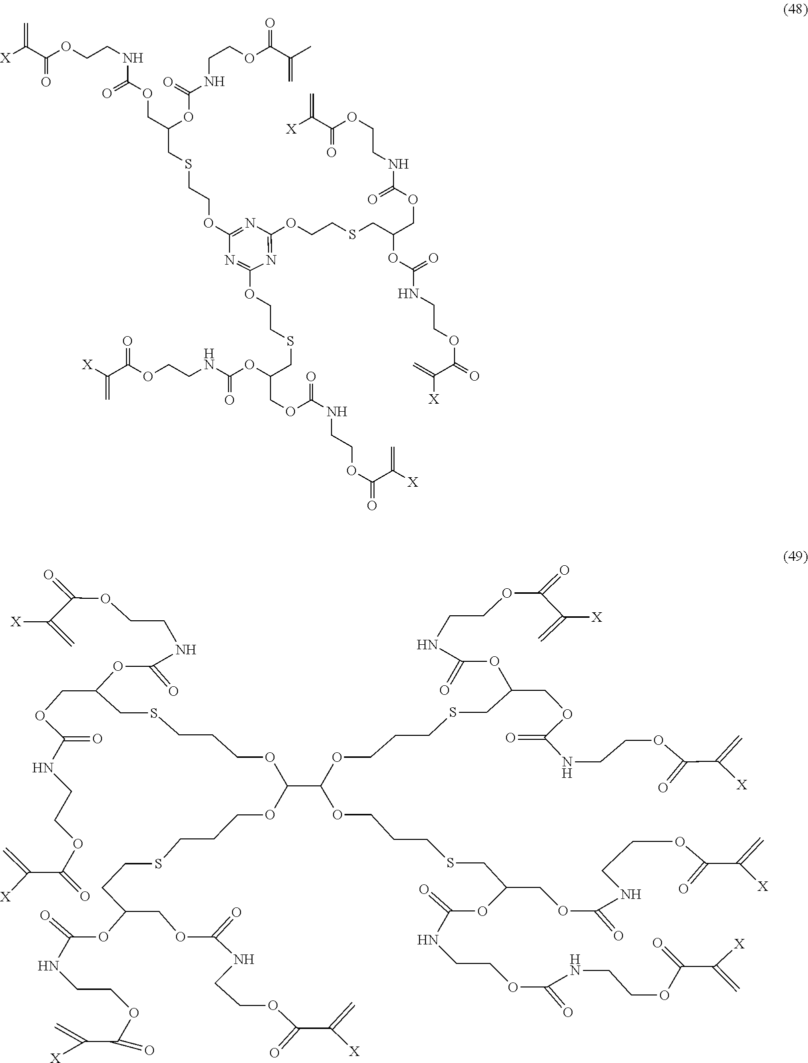 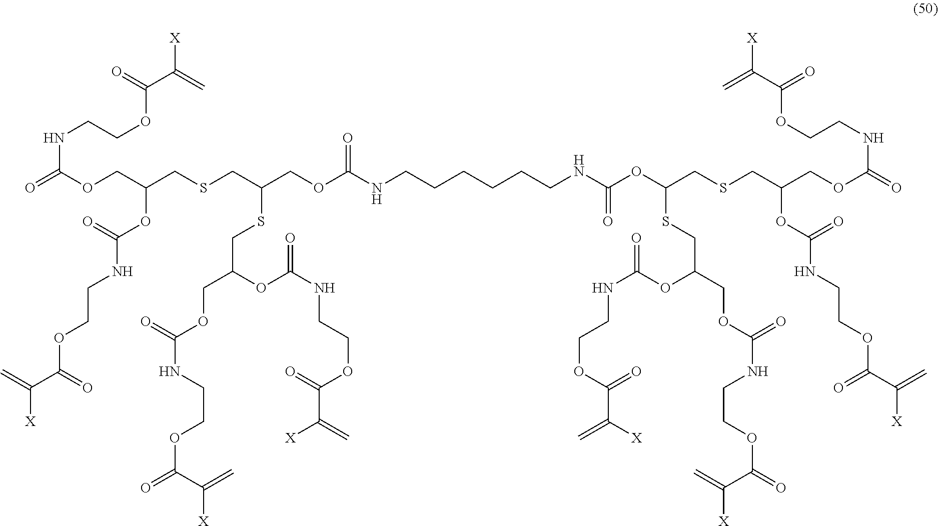 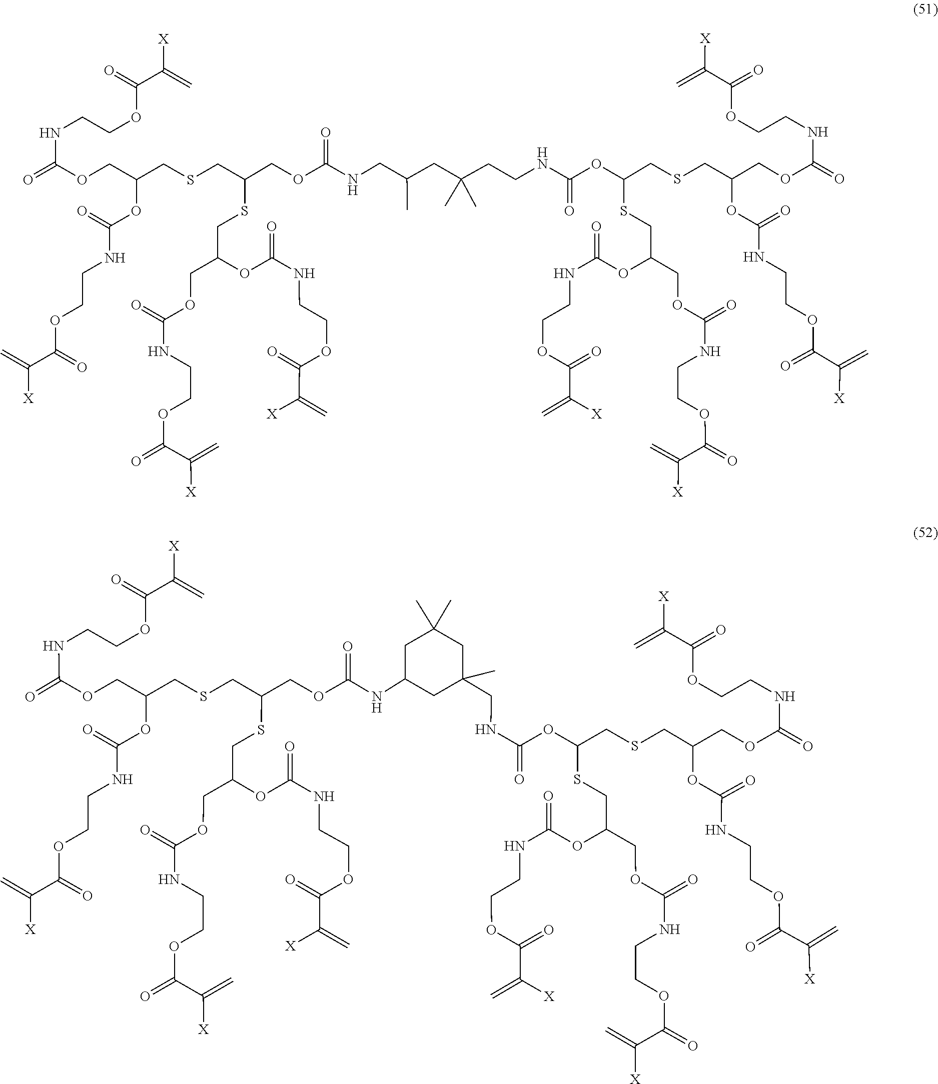 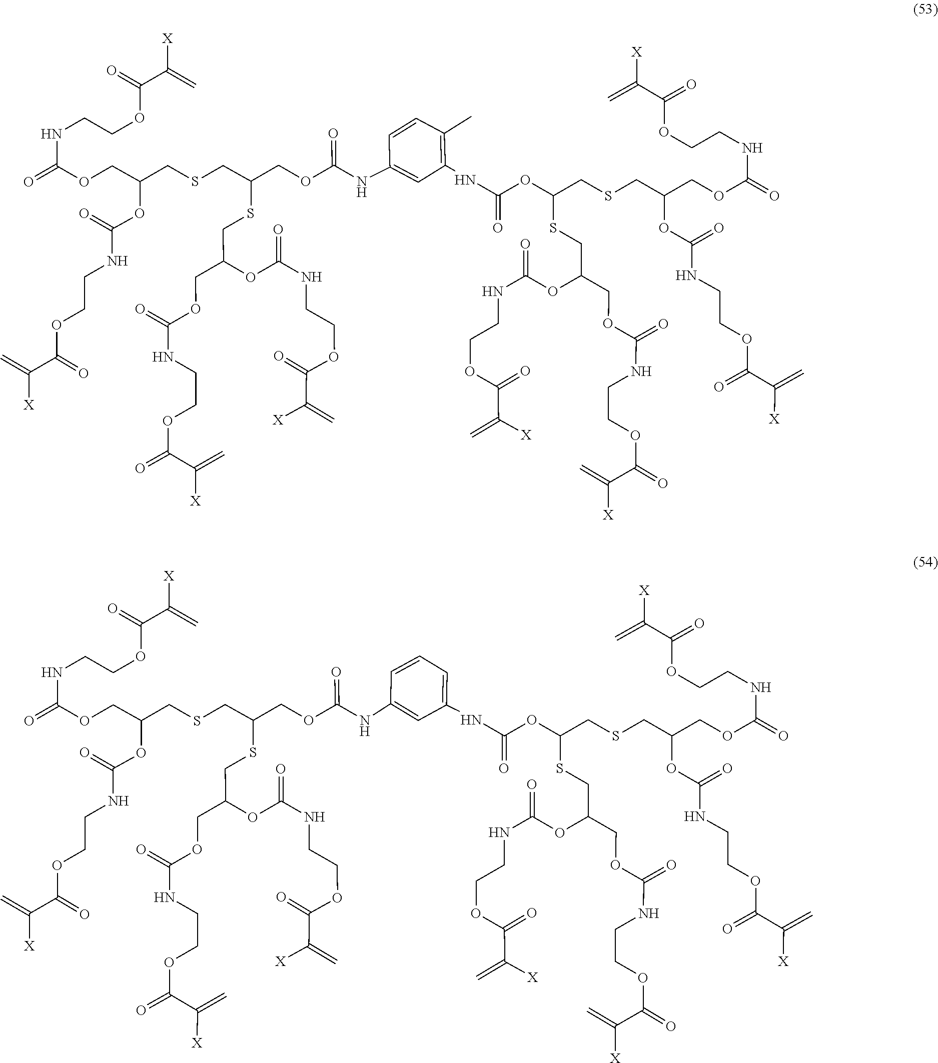 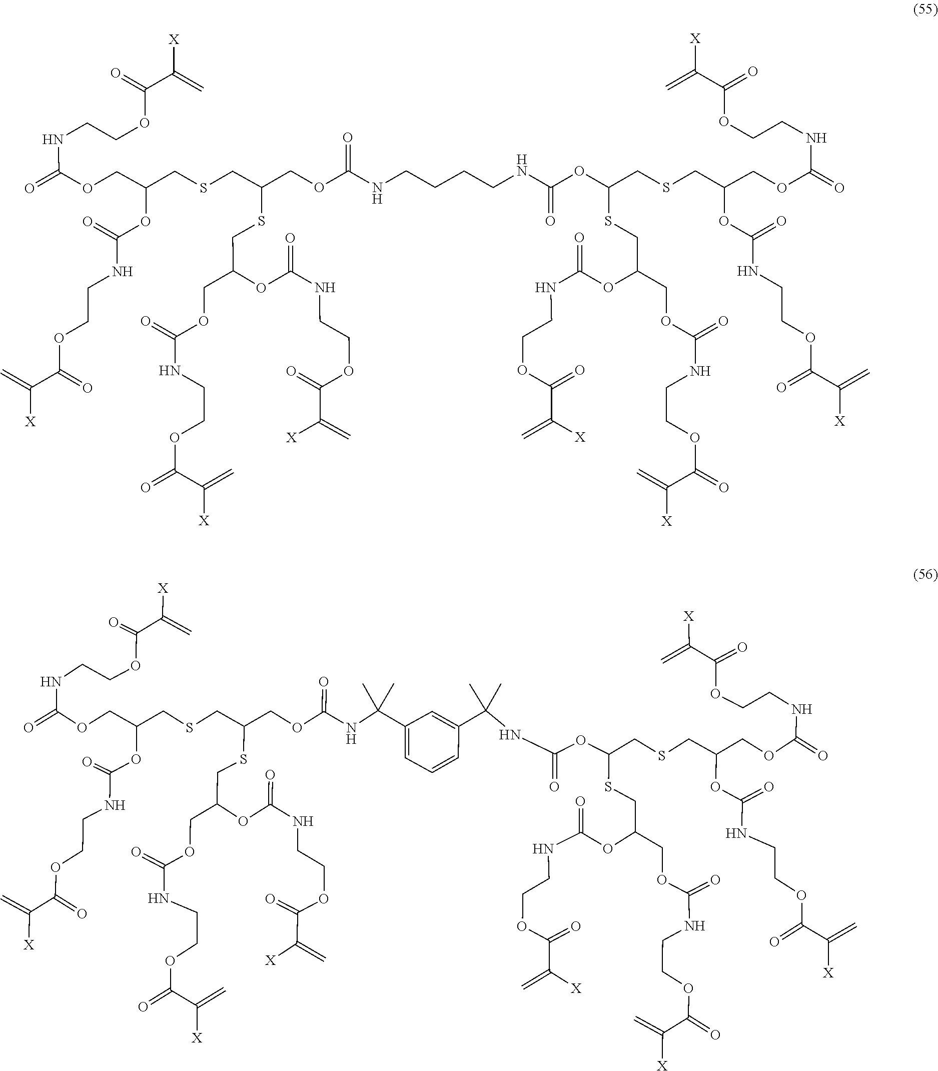 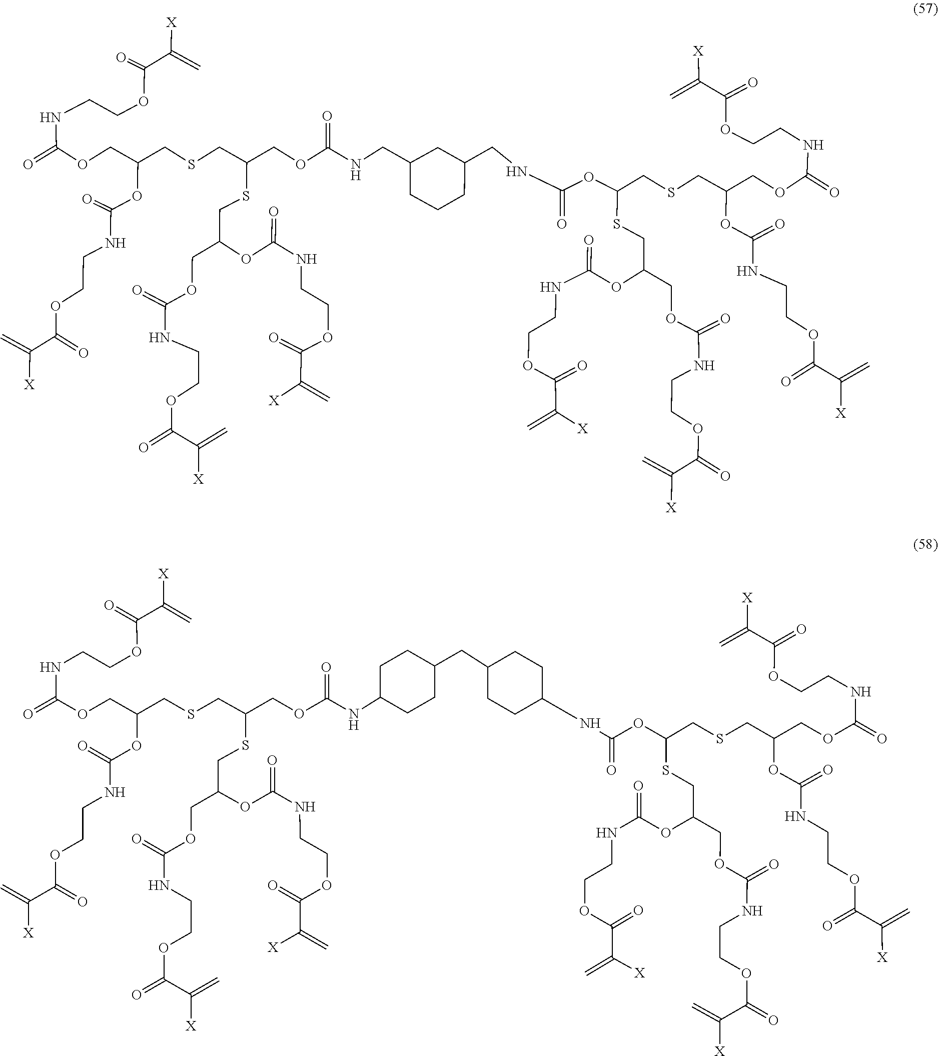 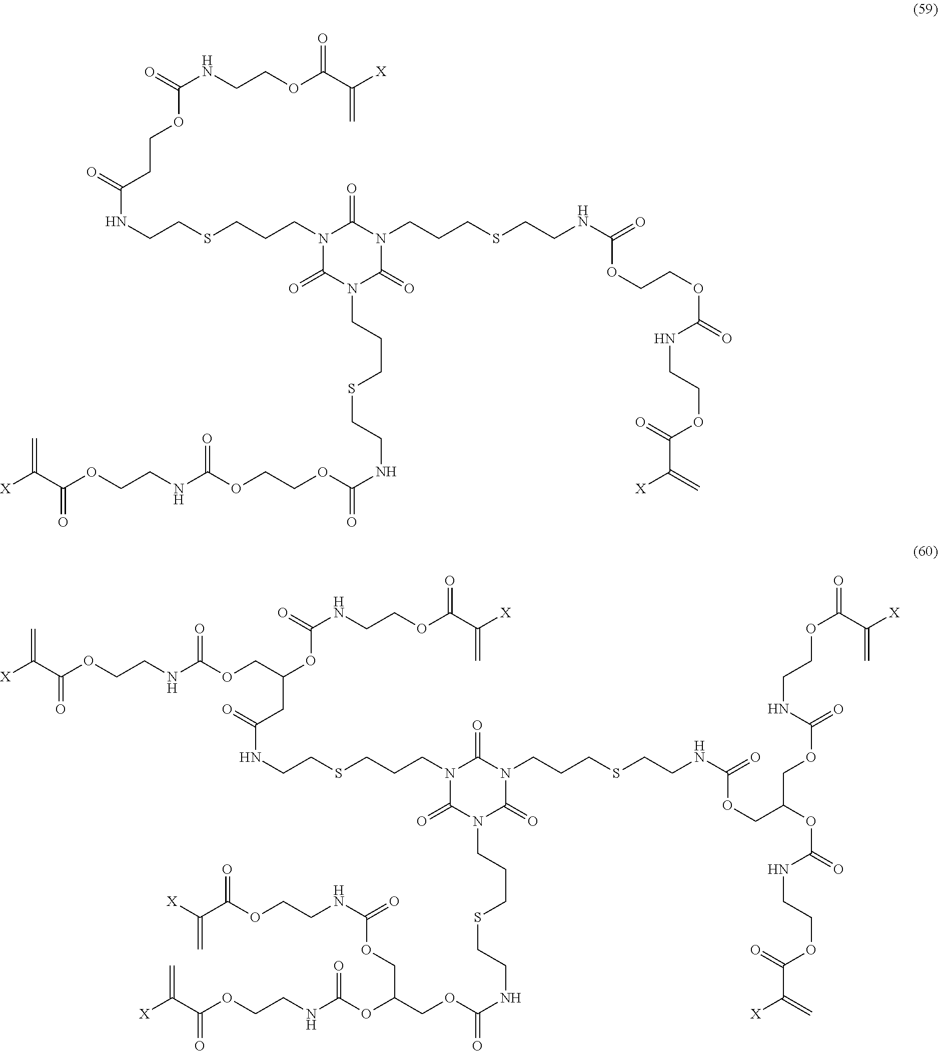 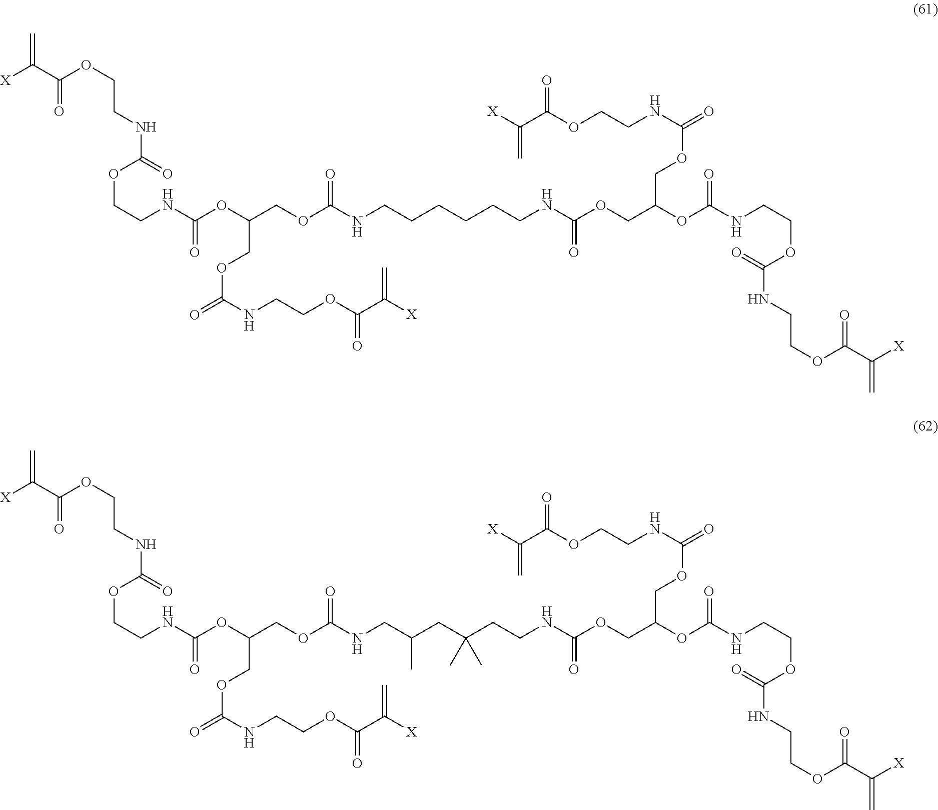 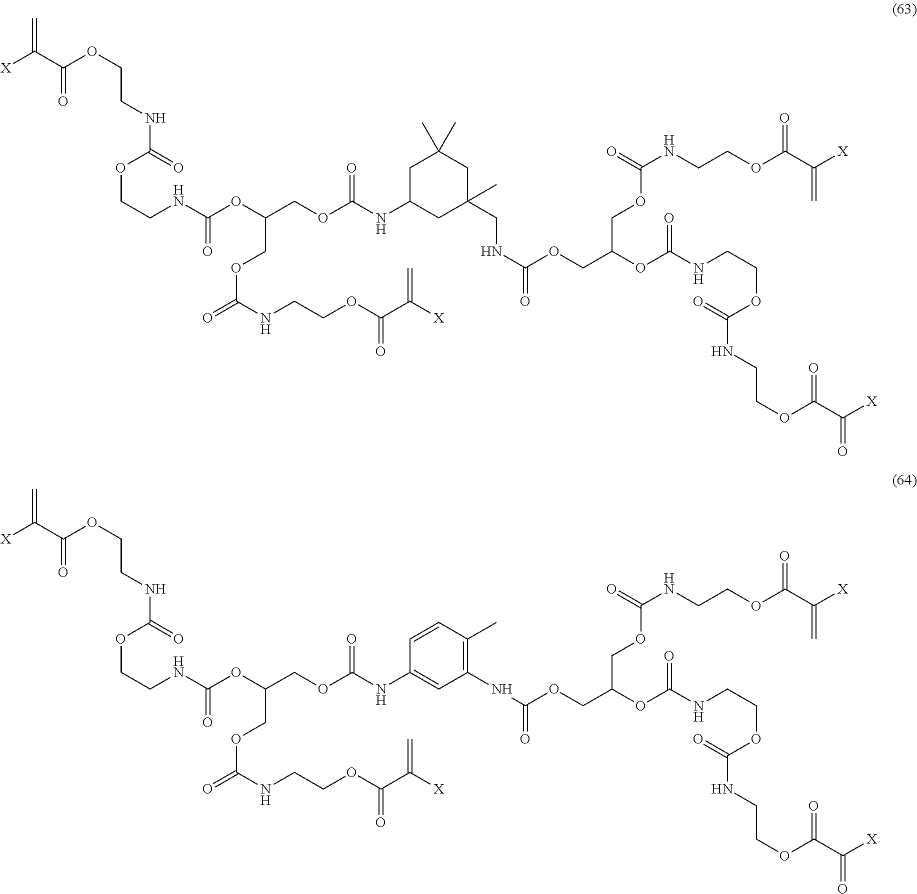 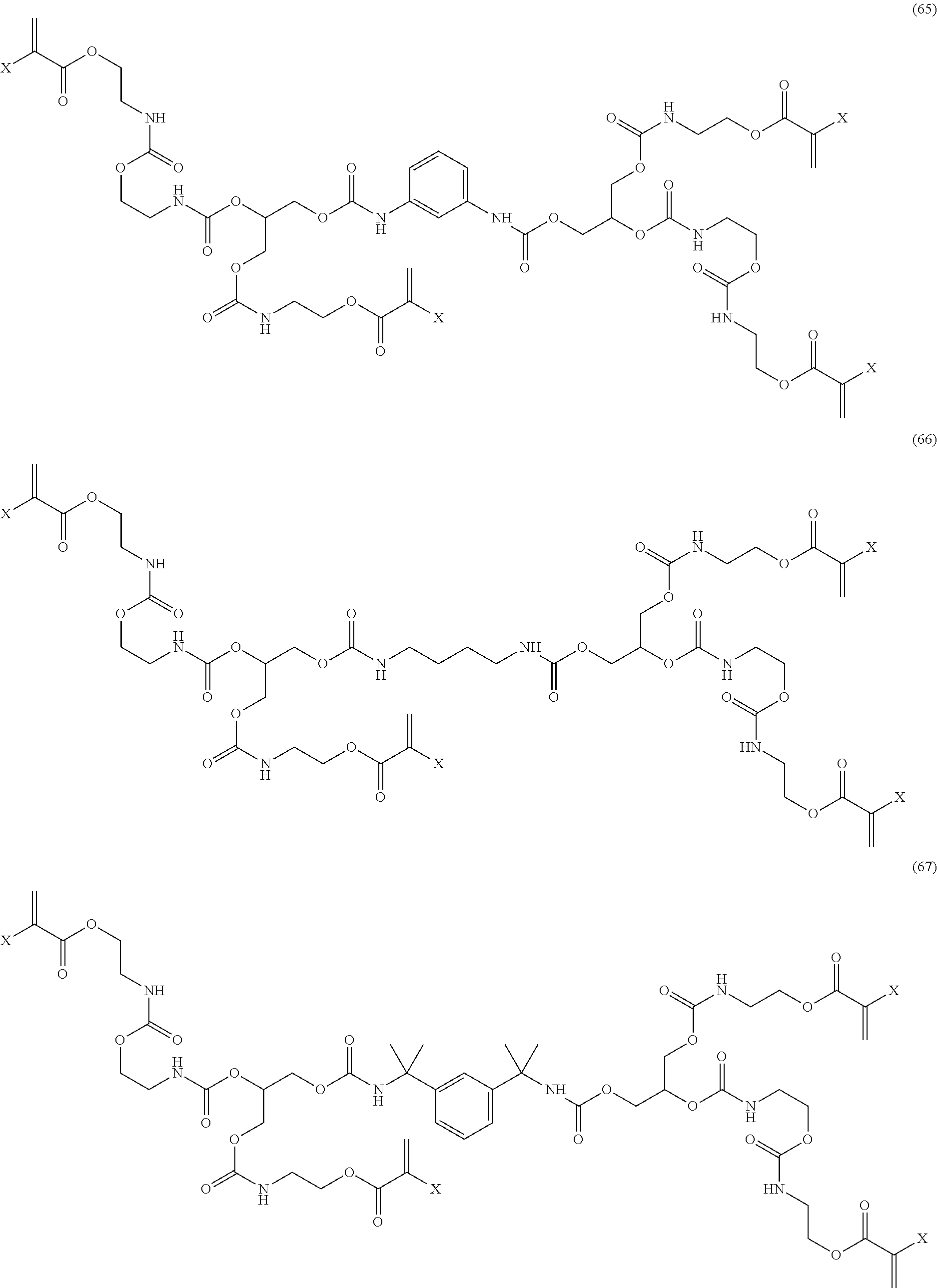 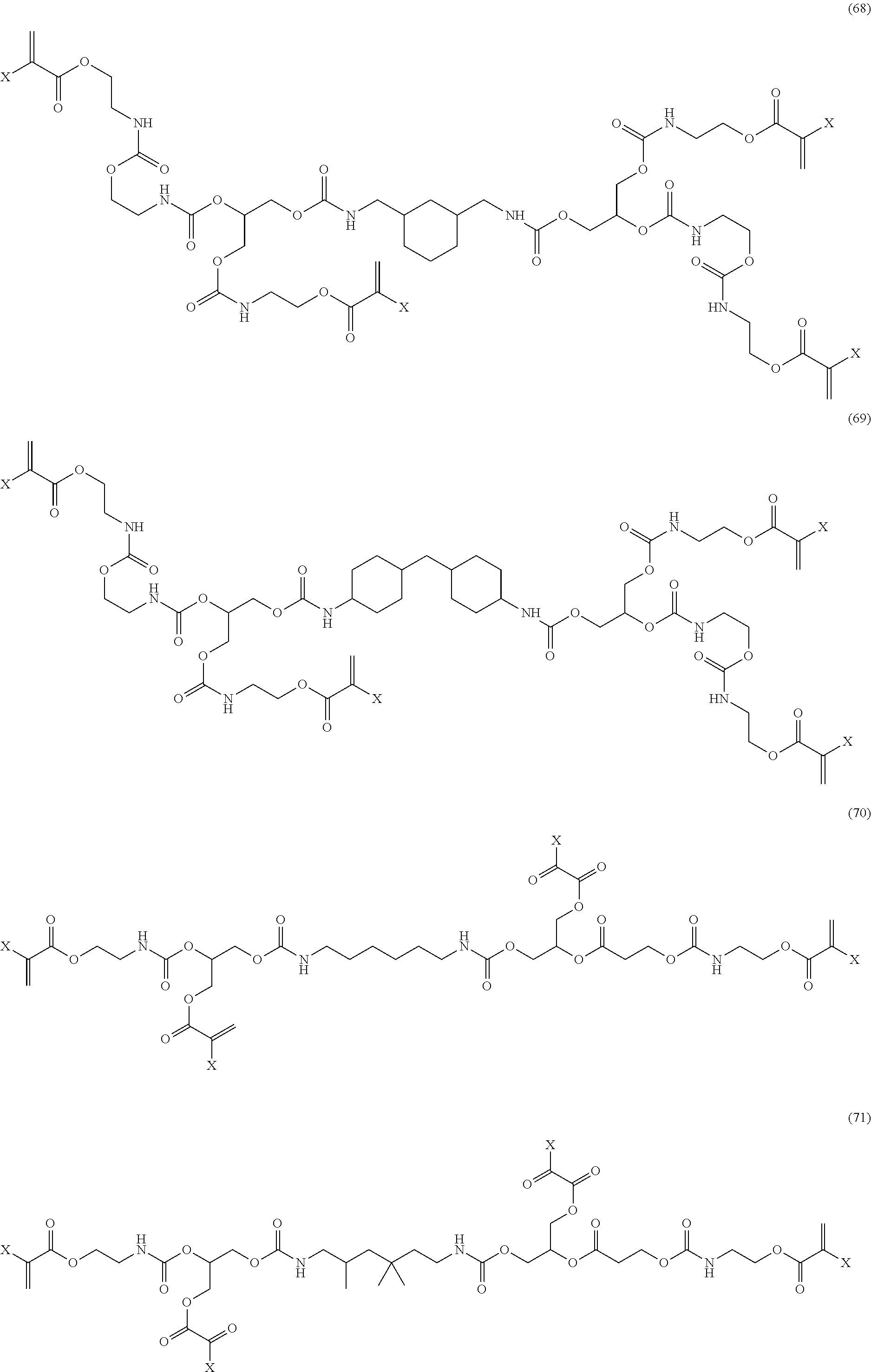 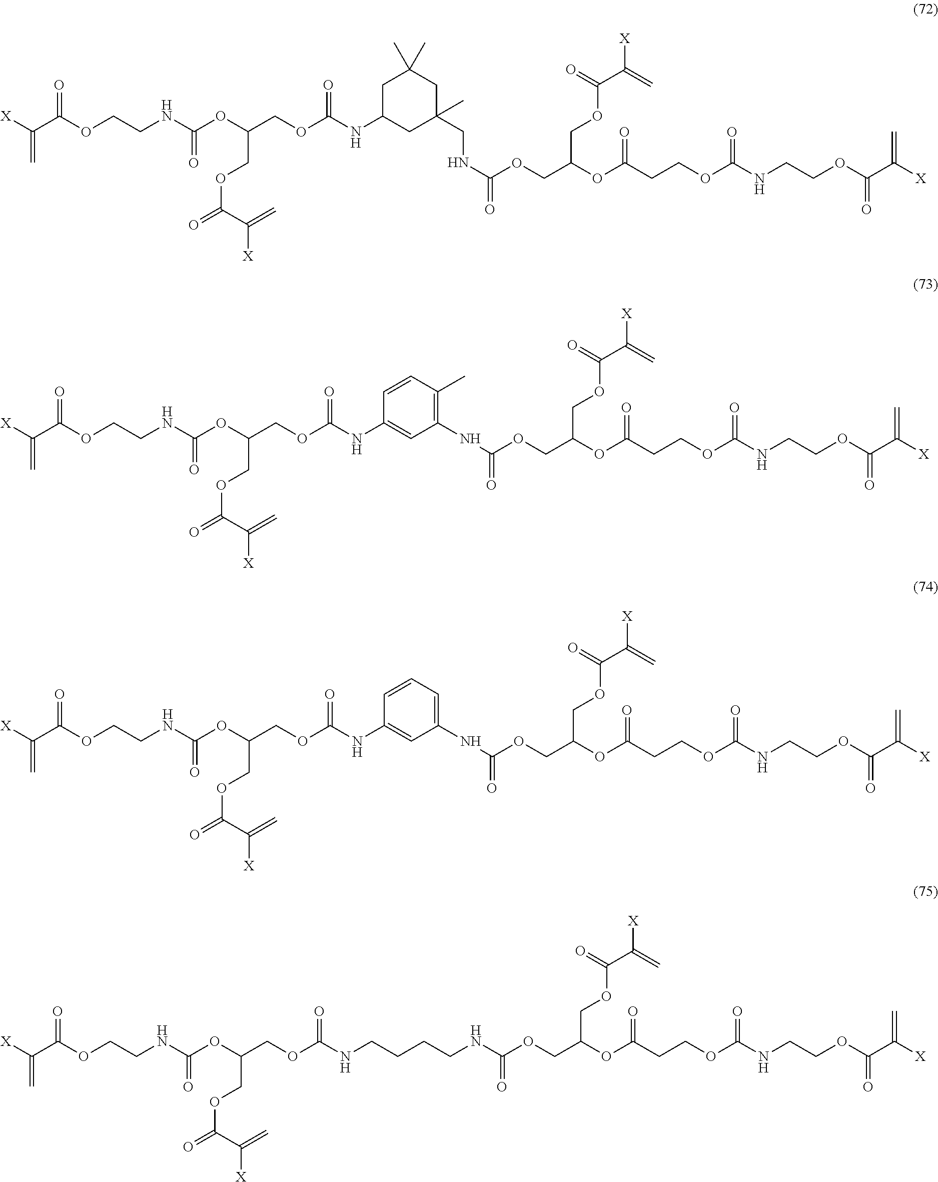 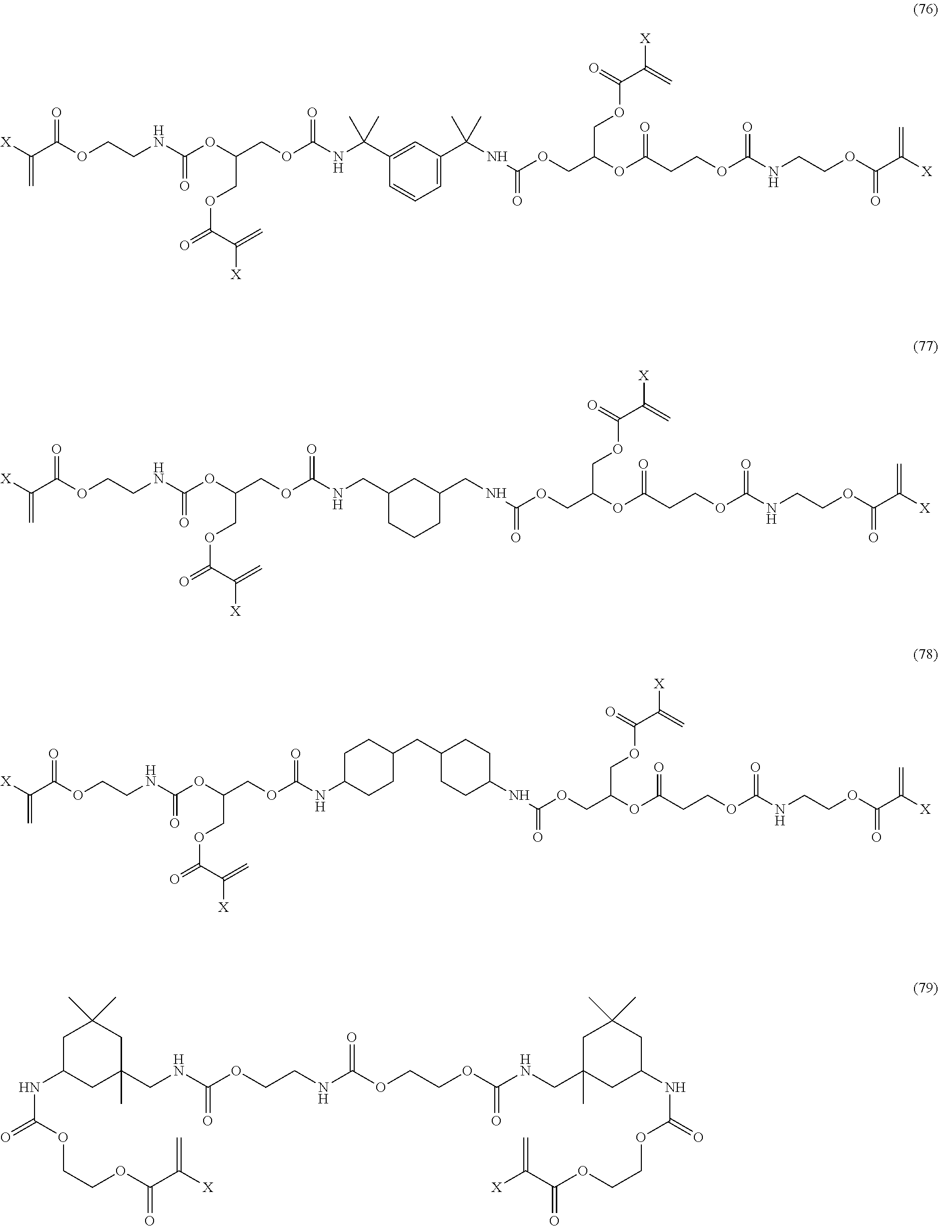 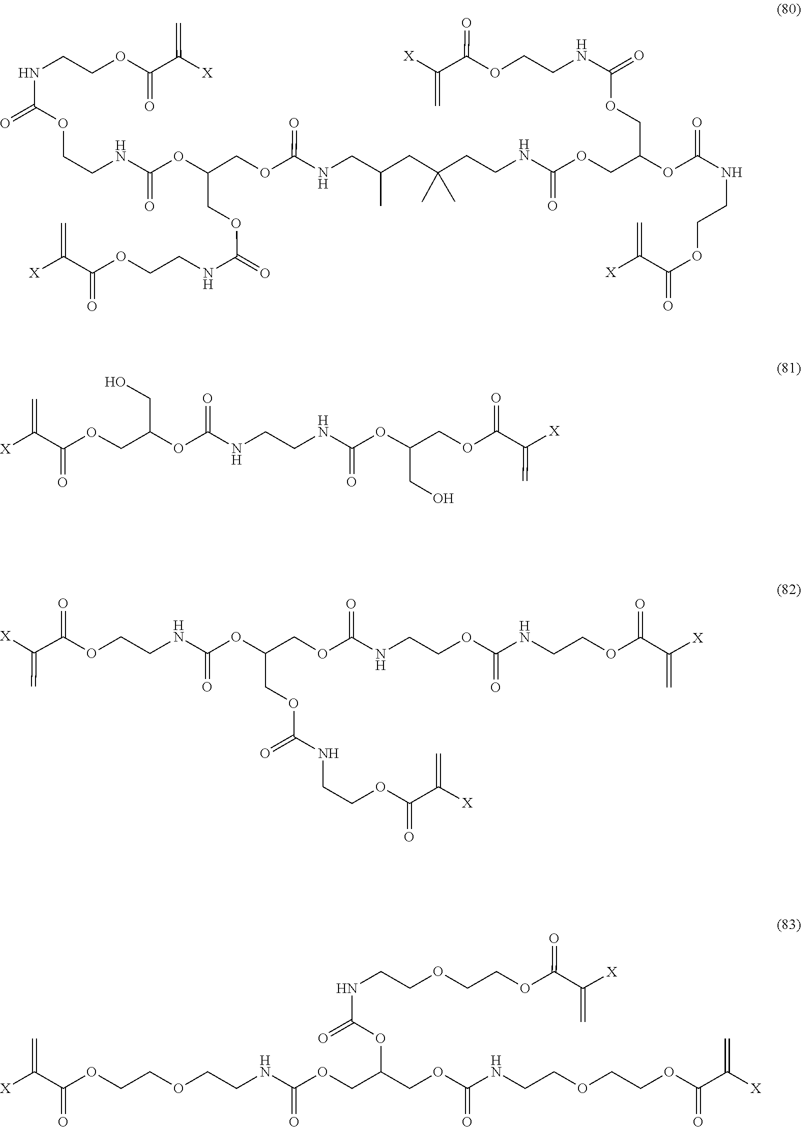
and combinations thereof; wherein each occurrence of X is independently hydrogen or methyl; each occurrence of R¹ and R² and R³ is independently hydrogen or C₁-C₆ alkyl, or R¹ and R² and the carbon atoms to which they are attached collectively form a C₅-C₈ cycloalkylene group, or R² and R³ and the carbon atoms to which they are attached collectively form a C₅-C₈ cycloalkylene group, or R¹ and R³ and the three carbon atoms that separate them collectively form a C₅-C₈ cycloalkylene group; and n is 1, 2, 3, 4, 5, 6, 7, 8, 9, 10, 11, or 12.

14. The curable composition of claim 1, wherein the urethane (meth)acrylate monomer is 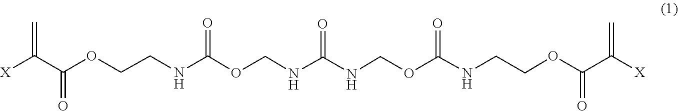
wherein each occurrence of X is independently hydrogen or methyl.

15.-16. (canceled)

17. The curable composition of claim 1, wherein the urethane (meth)acrylate monomer is 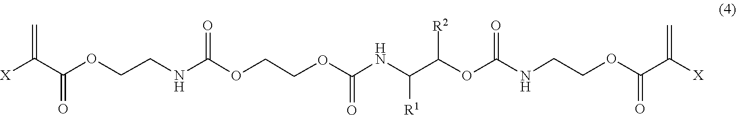
wherein each occurrence of X is independently hydrogen or methyl; each occurrence of R¹ and R² is independently hydrogen or C₁-C₆ alkyl, or R¹ and R² and the carbon atoms to which they are attached collectively form a C₅-C₈ cycloalkylene group.

18.-23. (canceled)

24. The curable composition of claim 1, wherein the urethane (meth)acrylate monomer is 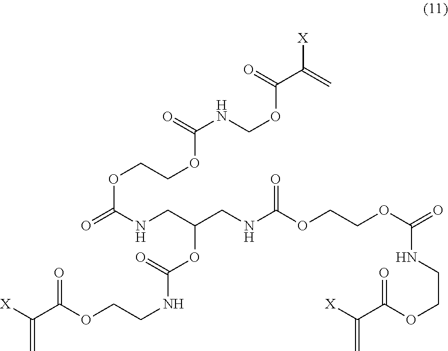
wherein each occurrence of X is independently hydrogen or methyl.

25.-91. (canceled)

92. The curable composition of claim 1, wherein the urethane (meth)acrylate monomer is 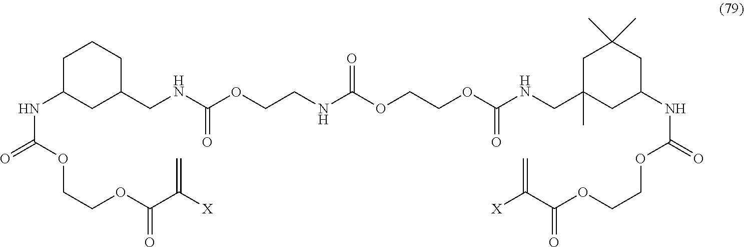
wherein each occurrence of X is independently hydrogen or methyl.

93. The curable composition of claim 1, wherein the urethane (meth)acrylate monomer is 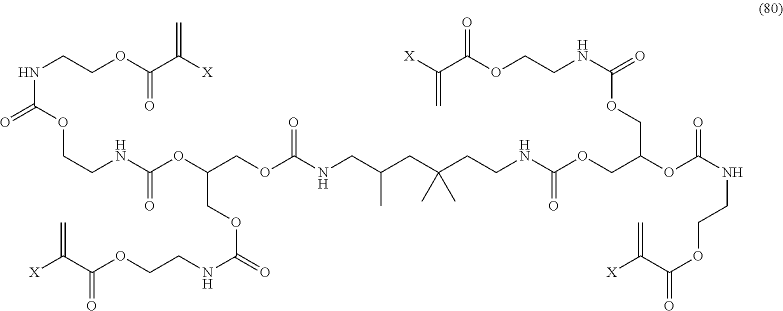
wherein each occurrence of X is independently hydrogen or methyl.

94. (canceled)

95. The curable composition of claim 1, wherein the urethane (meth)acrylate monomer is 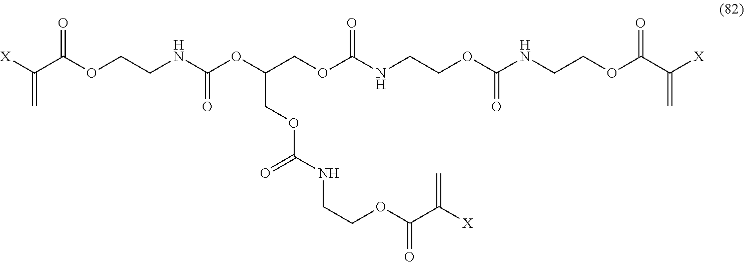
wherein each occurrence of X is independently hydrogen or methyl.

96. (canceled)

97. A cured composition comprising the product of curing the curable composition of claim 1.

98. An article comprising the cured composition of claim 97.

99. The urethane (meth)acrylate monomer of claim 12, wherein the urethane (meth)acrylate monomer is 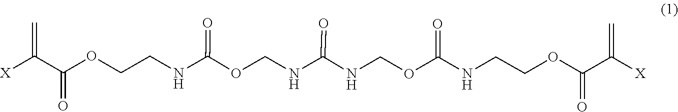
wherein each occurrence of X is independently hydrogen or methyl.
